(19) United States
(12) Patent Application Publication
(10) Pub. No.: US 2002/0007335 A1
(43) Pub. Date: Jan. 17, 2002

(54) Method and system for a network-based securities marketplace

(76) Inventors: Jeffrey Robert Millard, Laguna Niguel, CA (US); William M. Owens, Encinitas, CA (US)

Correspondence Address: PENNIE AND EDMONDS, 1155 AVENUE OF THE AMERICAS, NEW YORK, NY, 100362711

(21) Appl. No.: 09/814,987

(22) Filed: Mar. 22, 2001

Related U.S. Application Data
(60) Provisional application No. 60/191,222, filed on Mar. 22, 2000.

(51) Int. Cl. G06F 17/60

(52) U.S. Cl. 705/37; 705/10; 705/39

(57) ABSTRACT

A preferred embodiment of the present invention comprises a method and system for enabling exchange of financial information and negotiation and settlement of securities transactions over an electronic network, comprising the steps of and means for: (a) receiving from a first member posting data, the posting data comprising one or more indicated offers to acquire or transfer ownership interests in selected securities; (b) transmitting the posting data over the network to other members; (c) receiving a counteroffer to one or more of the first member's offers over the network from a second member; (d) transmitting the counteroffer over the network to the first member; (e) transmitting to the first member and to the second member information sufficient to enable the two members to contact each other; (f) transmitting to the first and second members data sufficient to identify transaction settlement facilities; and related steps and means.

### CROSS REFERENCE TO RELATED APPLICATIONS

This application claims the benefit of U.S. Provisional Application No. 60/191,222, filed Mar. 22, 2000.

### FIELD OF THE INVENTION

The present invention is generally related to securities transactions over an electronic network and, more particularly, to a method for a securities trading system that enables principal-to-principal communication of financial information, including postings of offers to transfer securities.

### BACKGROUND

A number of exchanges and similar institutions exist that enable participants (people, institutions and other entities) to buy, sell, and otherwise transfer securities. Such trading activities are generally conducted through intermediaries.

Call Through System

The call through system was used as early as the 18th century in New York, and was used on the Honolulu and Salt Lake City Stock Exchanges. It is a seriatim auction market for each of the stocks on a given exchange.

The caller announces the stock to be traded and solicits bids and offers. If he receives bids but no offers at a given price, he solicits offers by raising the call price. Trading continues so long as orders continue to be executed. When no further trading is possible, the caller then moves to the next stock. The caller, like the auctioneer, is not a party to the trade. This system was introduced in the United States after the Civil War. Simultaneous trading in stocks is made possible by a plurality of trading posts at the exchange.

The Member brokers send their orders for trades on all stocks to their agent on the exchange, and the floor broker takes these orders to the trading post for that stock. At the post a trader or specialist in one or more stocks accepts orders. The specialist may match the new order with a prior order and act as an agent for buyer and seller, receiving a commission from both. Alternatively, the specialist may enter the trade as a principal, negotiating to buy or sell the stock. In some cases, two parties at a post may consummate a trade independently of the trader or specialist.

The open board exchange as it has developed on the major exchanges has accepted as a feature the specialist who fills several roles. In some instances the specialist acts only as the agent of both parties. In all instances, the specialist is the agent of the exchange, with the obligation of maintaining an orderly market in the stock, controlling the price rise and fall of the trading. The specialist also acts as a trader for his own account seeking to earn a trading profit while fulfilling his other obligations.

The orders placed with the trader are termed “the book.” The book is closed in that only the specialist knows of his pending order. A floor broker negotiating a trade does not know if the specialist is trading for his account or another's. This preferred position of the specialist is the quid pro quo for his obligation as a market maker.

Exchanges

Stocks and options are traded on exchanges such as the New York Stock Exchange (NYSE), Chicago Board of Options Exchange (CBOE), and the American Stock Exchange (AMEX). These exchanges trade in “listed” securities. The operations of exchanges located in the United States are regulated by the Securities and Exchange Commission (SEC). Securities listed on an exchange have generally been offered and sold by their issuer in a public offering registered with the SEC. Such issuers are obliged to file periodic reports containing financial statements with the SEC and otherwise comply with federal securities laws. For a security to be listed on an exchange, its issuer must meet exchange-prescribed minimum standards regarding the issuer's financial status, aggregate market capitalization, security trading volume, and other criteria. In addition, the listing and maintenance fees charged to issuers are substantial. For example, the initial fee for a domestic (U.S.) issuer with 5 million shares to list on NYSE is $84,600. “NYSE Listing Standards: U.S. Fees”, NYSE, at http://www.nyse.com/listed/domesticfees.html. The costs of listing and criteria prescribed by the exchanges preclude many smaller companies from having their securities listed for trading.

Therefore, there is a need for a securities trading system that will accept postings of any security of any type, from any issuer, issued by an entity located anywhere in the world, for offer and sale in transactions between principals.

Not all securities from a single issuer will trade on the same exchange. Stocks, options, and bonds may all trade on different exchanges. A market participant wishing to monitor or to trade in multiple types of securities for a given issuer must generally do so on several exchanges. Also, unlisted securities from the same issuer would not be traded on any exchange. The marketplace is currently fragmented into a number of trading systems based on the types of securities, not the issuer of the securities, making trading more inefficient and costly.

Therefore, there is a need for a securities trading system that could accommodate and display, in a single, unified marketplace, all bids and offers for all types of securities of a given issuer.

Trading on exchanges is conducted through intermediaries, where negotiated trading between two or more participants occurs through a third party, one of the “specialists” on the floor of these exchanges. The specialists generally have positions as buyers and/or sellers in the securities they intermediate and therefore act as dealers. For this reason, the specialist is actually a party to the transaction, not a neutral intermediary. Thus, buyers and sellers do not negotiate or trade directly; they place trades through brokers, dealers and specialists, at increased cost to the buyer and seller. Buyers and sellers cannot conduct direct, principal-to-principal transactions through a regulated exchange. Private parties are permitted by law to trade directly with each other, but generally do not have the means available to do so without an intermediary, broker-dealer, market maker or exchange.

Therefore, there is a need for a direct, principal-to-principal securities trading system for secondary transactions in securities, including unlisted, unregistered and restricted securities.

Broker Networks

Over-the-counter (OTC) securities can be traded on the National Association of Securities Dealers (NASD) Automated Quotation (NASDAQ) system, a computer network of securities dealers.

The NASDAQ system was introduced in 1971 and is used by the National Association of Securities Dealers for trading in over-the-counter stocks. For every stock, there are several association Members who are market makers. Each of them communicates with the system, transmitting their bids and offers. The system re-sequences all of these quotes to display the lowest five offers and highest five bids. Any Member broker may obtain this display on his terminal and communicate with any of the market makers to negotiate a sale. The NASDAQ system therefore serves as a communication system for geographically dispersed multiple market makers and brokers. The system as described does not include order execution and the clearing of orders.

The NASDAQ Stock Market has two tiers, the NASDAQ National Market and the NASDAQ Small Cap Market. Each tier has its own set of minimum financial requirements that a company must meet in order to list its securities. In addition, all listed companies are required to meet certain standards of corporate governance. Finally, each market tier has a set of minimum financial requirements that a company must meet for continued listing. Unlisted securities cannot be traded on NASDAQ; all securities must be pre-approved by the system operator.

NASDAQ dealers typically maintain a position in certain OTC securities and act as “market makers.” These market makers continually make available their best offers (bid and ask) on NASDAQ and act as intermediaries or parties to the transaction, matching buy and sell offers, in a similar role to the specialists on exchange floors. Unlike exchange specialists, however, several market makers may simultaneously make a market in a given security.

The National Quotation Bureau (NQB) provides a quotation service similar to NASDAQ, but does not impose listing requirements on the issuer. However, a market maker must sponsor a security for it to be traded through NQB. NQB market maker quotation listing privileges are only available to broker-dealers, which are regulated by the SEC and the NASD. Issuers must have an NQB market maker initiate quotations. Thus, buyers, sellers, and issuers of securities cannot post offers directly, and can only trade in securities approved by NQB market makers. In effect, no securities may be listed without pre-approval of the system operators.

Security brokerage firms for years have used automated transaction systems for matching buy and sell orders for securities. For example, the New York Stock Exchange's DOTS (Direct Order Transmission System) and the NASDAQ's SOES (Small Order Execution System) systems offer complete electronic matching of buyers and sellers. These systems do not allow for principal-to-principal interaction while maintaining anonymity. They merely pair buy orders with sell orders when the pricing criteria of both sides of the trade are met.

Portal System

For many years the institutional holdings of securities have been increasing. Institutions now hold in excess of forty percent of the market value of U.S. equity securities. Investment managers of large portfolios generally believe that it is prudent either to invest assets in core or index portfolios which remain relatively stable or, if actively investing, to do so in a small enough number of securities that they can properly monitor the progress of the companies whose securities they own. If they pursue the second alternative, they may, in many instances, take positions exceeding five percent or more of a corporation's capitalization. Since there are few corporations that have a total turnover of their capitalization greater than two hundred and fifty percent on an annual basis, or an average of one percent per trading day, investment managers find themselves holding positions representing five or more days of trading volume. These are large and unwieldy positions relative to the capital available to those responsible for making markets in these securities. Hence, any order to trade such large positions may either remain unexecuted due to the absence of buyers or sellers large enough to be the contra party or, if execution is forced, may cause large, temporary swings in market prices through the effect of supply and demand forces. Large swings in prices reflect unrealistic market values to the general public and may cause inappropriate or even harmful reactions thereto. Strains are placed on the liquidity and depth of securities markets, and instability may result. The absence of just this type of liquidity and depth was identified in the Report of the Presidential Task Force on Market Mechanisms (January 1988), also known as the “Brady Report,” as a fundamental cause of the financial market free-fall which occurred on Oct. 19, 1987. No automated trader system has specifically addressed these problems in institutionally dominated markets, and some automated trader systems, such as portfolio insurance, may even have contributed to the problems. A distinction is drawn here between automated trader systems that are used for making trading decisions, and automated trading systems that are message switching systems that allow traders to execute orders.

Further, broker-dealers act in the capacity of intermediaries and may not resell unregistered securities or restricted securities except under certain conditions. SEC Rule 144A provides a safe harbor exemption from the registration requirements of the Securities Act of 1933 (as amended) for resales of restricted securities to qualified institutional buyers, as defined in the rule. In general, a qualified institutional buyer is an institutional investor that in the aggregate owns and invests on a discretionary basis at least $100 million in securities of issuers that are not affiliated with the buyer. Registered broker-dealers need only own and invest on a discretionary basis at least $10 million of securities in order to purchase as principal under the rule. Section 4(2) of the Securities Act of 1933 (as amended) provides an exemption from the registration requirements for “transactions by an issuer not involving any public offering: ” Securities acquired in a transaction under Section 4(2) cannot be resold without registration under the Act or an exemption therefrom. Rule 144A provides a safe harbor exemption for resales of such securities. Accordingly, broker-dealers that previously acted only as agents in intermediating between issuers and purchasers of privately-placed securities, due to the lack of such a safe harbor, now may purchase privately-placed securities from issuers as principals and resell such securities to “qualified institutional buyers” under Rule 144A. This process is defined for these firms as the Portal System. This Portal System is not available to investors with less than $100 million invested in non-affiliated securities assets, nor for securities dealers with less than $10 million in such assets.

Therefore, there is a need for a direct, principal-to-principal securities trading system for secondary transactions in securities, including unlisted, unregistered and restricted securities—where investors are not required to own $100 million in assets to be able to purchase said securities. There is also a need for institutional investors with less than $100 million in securitized assets to have comparable opportunities for liquidity as do firms with over $100 million, and for securities dealers with less than $10 million in such assets to have comparable opportunities for liquidity as do firms with over $10 million in such assets.

Other potential difficulties also accompany major securities position changes by institutional holders. For example, it is in the interest of the large institutions to maintain their anonymity and not to disclose information concerning the total size and price limit on an order when engaging in substantial transactions, both to retain privacy and to prevent other traders from front-running the order, thus adversely affecting prices received or paid. Identification of trader interest can result simply by allowing an order to remain open and unexecuted for periods of time as may occur during periods when individual specialists and traders try to assemble bids or offers for large orders or even with preexisting automated trading systems where orders remain in the system until actively canceled. In addition, knowledge of the identity and activity of other participants in a market can actually decrease liquidity and broad investor interest. For example, in a government auction of wireless licenses, the known presence of GTE in the auction decreased bidding and resulted in lower sale prices. See “Going, Going, Gone . . . Sucker!: How ‘winner's curse’ could undermine online auctions,” Business Week, Mar. 20, 1999.

Therefore, there is a need for a system that can permit institutions to retain privacy and reduce the risk of other traders front-running the order.

Another problem is the inability to quickly enter, cancel, or alter the desired terms of securities orders in a real-time environment, whether using a computer-directed trading system or not. This difficulty has further exacerbated liquidity problems in the securities markets and has, consequently, made many users reluctant to use automated trading systems. It has also meant that large institutional investors have not had the opportunity to increase the return on their investments through short term trading. Most of their portfolio remains static and/or idle over substantial periods of time, especially when compared to the equivalent value of securities held by individuals of which a portion is continually coming to the marketplace due to the fact that there are many individual decision makers. Institutions, because of their size, reflect an aggregation of the holdings of many individuals subject to the authority of relatively few decision makers. The flow of any particular security to the marketplace from the “institutional market/sector” tends to vary widely when compared with the flow of that same security from the “individual market/sector,” especially since institutions often react to similar kinds of stimuli, such as research, newsletters, and other information services, in making market decisions and, consequently, place disproportionately sized orders at any given time.

The existence of problems such as those discussed above has hindered the development of effective automated trading systems and has caused trading volume by users of such systems to remain relatively low. As a result, such systems often remain under-utilized and, in some cases, have had to cease operations altogether. Although a number of patents, such as U.S. Pat. No. 3,573,747 to Adams et al., U.S. Pat. No. 4,334,270 to Towers, U.S. Pat. No. 4,412,287 to Braddock III, U.S. Pat. No. 4,554,418 to Toy, U.S. Pat. No. 4,556,066 to Towers, U.S. Pat. No. 4,674,044 to Kalmus et al., and U.S. Pat. No. 4,751,640 to Lucas et al., disclose automated systems useful in trading and valuing securities portfolios, none of the inventions disclosed in these patents recognize or solve all of the problems outlined above. What is needed is an automatic system for trading securities held by institutions that constantly and anonymously provides depth and liquidity to the market by presenting a flow of buy and sell orders in a wide variety of securities in a real-time environment without significant changes in the pattern of returns generated by the securities utilized in the original portfolio in a manner that seeks to provide an incremental profit in return.

Electronic Commerce Networks (ECNs)

Closely related to exchanges and NASDAQ are electronic commerce networks (ECNs) such as Instinet, Island, POSIT, and several others, and automated exchanges such as the Arizona Stock Exchange.

The Instinet system is described in U.S. Pat. No. 3,573,747, issued on Apr. 6, 1971. The system includes a series of terminals, each accessible to a Member and a central computer. Each Member may submit for display a firm offer to buy or sell a given number of shares of a certain security at a stated price. The Member may also submit bids or offers of a security without price. This information, minus the submitter's identity, is displayed to all Members, in a price sequence. Any Member may respond to an offer through the negotiating option of a counteroffer and the system will allow private communications between the two Members until and if an agreed-upon price is reached. Alternatively, a Member may submit an acceptance of any offer displayed to all Members. In either option, the system executes orders when a buyer and seller have agreed upon a price. The parties to an executed trade deliver the shares of stock and purchase price to a designated bank for a conventional clearing operation. If a bid and an ask are submitted at the same price, the system will consummate the trade. Each order execution is triggered by an immediately previously submitted offer to buy or sell. Expressed otherwise, each order is immediately executed against a booked order or is itself booked.

In general, ECNs are centralized, computer-based order matching systems that display bids and offers of subscribers to the ECN and automatically match subscriber orders if bids match offers. Otherwise, the best prices are posted on NASDAQ to compete with market makers. ECNs therefore trade only in stocks for which there are significant numbers of closely matched bids and offers on a given security posted on the ECN. Such securities are termed “liquid”—they trade frequently (trade “flows” easily). ECNs can apply to be regulated as an exchange, or may be regulated as a broker-dealer operated alternative trading system (“ATS”). The only securities traded on ECNs are liquid, registered securities which trade in significant volumes and are listed on traditional exchanges or broker networks such as NASDAQ.

Therefore, there is a need for a system that provides an efficient, electronic marketplace for all securities, especially for unlisted, unregistered, restricted, and illiquid listed securities.

A system for a computer based stock exchange is disclosed in U.S. Pat. No. 3,581,072 issued on May 25, 1971, to Frederick Nymeyer. The system exchange accepts orders to both buy and sell stock at given prices (limit orders), and orders to buy and sell stock at the market price (market orders). The system executes all orders where a purchaser can be found willing to pay a price at or greater than the price offered by any seller. Such a system does not permit principal-to-principal negotiations of price, volume, and settlement details.

Therefore, there is a need for a securities trading system that enables principal-to-principal negotiation of price, volume, and settlement details.

Bulletin Boards and Private Trading Systems

The “fourth market” consists of systems, including automated computer and communications systems, where the intermediaries do not maintain positions or act as market makers in securities. Listed, OTC, and other unlisted securities can be exchanged in this market. A simple version of this market is a group of traders communicating by telephone. A telephone network for trading securities compromises the anonymity of the buyers and sellers, and the identity of participants can be used against them to move the market. For example, a party wishing to sell a large block of sovereign bonds may call several potential buyers. These buyers, now aware of the seller's position (quantity and asking price), may use this information to sell short or otherwise attempt to move the market price for their own gain. In addition, such a network is operationally inefficient in that there is no centralized location for quotations of bids and offers and no aggregation of historical trade records. In addition, the network does not reach any further than the parties contacted. No new party may readily enter this marketplace.

Bulletin-board securities trading systems are known. However, such systems also compromise market integrity, since each trader's anonymity is placed at risk. Many potential traders would prefer to have their identities not disclosed to third parties unless and until they actually trade a security, and then revealed only on a need-to-know basis.

There is thus a need for a securities trading system that preserves trader anonymity while also meeting the above-mentioned needs.

Bulletin-board systems have the further disadvantage of operational inefficiency. These systems do not provide access to standardized transaction settlement systems (other than brokers or clearing firms) to maximize the ability of traders to trade efficiently while still remaining exempt from the regulatory framework of exchanges. For example, U.S. Pat. No. 6,014,643, to Minton, describes an interactive securities trading system that enables direct negotiation between buyer and seller. The system described in Minton allows buyers and sellers to negotiate, but any transaction must subsequently be settled through a registered securities broker. Thus, while the system described by Minton removes the broker from the negotiation, only securities that can be traded through brokers can be traded on such a system.

Systems for exchanging unlisted and unregistered securities in privately held companies are also known. However, these systems either do not provide for efficient and safe transaction settlement except through registered brokers, or the buyer and seller must structure their own method of transferring securities. If a broker is not used, the only safe way of structuring a securities transaction is through the use of an independent, trusted settlement facility such as an escrow agent. In such systems, access to such a settlement facility is not provided. The parties must agree on terms of the securities transaction, agree on an escrow agent, and individually reach agreements with the escrow agent. This process requires a substantial investment of time to acquire information and negotiate terms, and thus these systems are operationally inefficient.

There is thus a need for an operationally-efficient securities trading system, not dependent upon participation by brokers or dealers, for posting information about and settling securities transactions, and providing access to independent, qualified settlement facilities selected by the transaction principals.

Current markets and their information systems do not provide the buyer or seller with alternatives for displaying their order. Examples of flexibility for buyers and sellers in display and/or posting include the following: (a) a “blind ask” that is not displayed but is privately sent to other members who have posted a comparable bid on the same security; (b) an offer only, where all counteroffers must be private and not displayed to market participants (cf. silent auctions); (c) offers without a specified price or quantity; and (d) full displays of asks and bids. Also, current trading systems do not provide participants the discretion to determine with whom they are willing to trade and to exclude others from viewing or responding to their offers. Operators of current systems may limit participation or exclude participants, but the participants themselves cannot select or exclude other participants as their personal trading counterparties.

National Securities Offering Listing Services

National securities offering listing services provide a meeting place to start extensive offline negotiations between accredited investors and issuers for the placement of new issues. Representative is the Access to Capital Electronic Network (ACE-Net)—a non-profit national securities offering listing service managed by a university business school.

ACE-Net is operated for the purpose of facilitating primary securities transactions, i.e., offerings and sales of securities between issuers and accredited investors. The ACE-Net system does not enable direct, principal-to-principal dialogue and negotiation and settlement of secondary transactions in securities.

There is thus a need for a securities trading system that enables more rapid negotiation, includes holders of shares seeking to dispose of them in secondary transactions, and that provides more easily accessible and structured sources of settlement services to complete transactions.

Accordingly, one skilled in the art will recognize that known securities trading systems are deficient in one or more of the following respects:

(A) Strict limits on securities and issuers: Securities trading on conventional exchanges, ECNs, broker networks and other known securities trading systems are limited through registration requirements, issuer requirements, and listing requirements. These systems do not accept postings for all securities.

(B) Required pre-approval of securities: Operators of known trading systems must pre-approve securities for listing.

(C) No alternative types of transfer: Known trading systems generally do not provide for alternative methods for the transfer of securities, such as swaps, hypothecation, or creation of structured products such as financial derivatives.

(D) No central marketplace for all types of securities: Known trading systems place limits on the particular types of securities that may be traded on the system. For example, the NYSE trading system includes stocks and certain derivative instruments based on stocks, but does not include bonds. Therefore, the stocks and bonds of an issuer trade in separate, unconnected marketplaces.

(E) No flexibility in display of offer: Known systems do not generally allow the participant to select which market participants may view the posted offer. In addition, known systems do not provide the flexibility of allowing hidden offers (not visible), or the offer only (no display of bids from other participants).

(F) No facility to select or limit participants: Operators of known trading systems can select or exclude participants from the system, but the participants may not choose to select or exclude other participants as trading counterparties.

(G) Additional cost of intermediated transactions: Known trading systems generally involve intermediaries and thus do not enable direct communication and negotiation between participants. Frequently, the system operator is also an intermediary in the transaction and derives revenues from fees, such as commissions, differences between bid and ask prices, and settlement fees. Such costs can be substantial and make intermediated transactions more costly for the buyers and sellers of securities.

(H) Inefficiencies and higher costs for non-standard transactions: Exchanges and broker networks are efficient only for standardized transactions. For example, on order matching systems, it is more resource intensive from a system standpoint to allow offers to be priced in smaller increments. See “NASD Calls On The SEC To Delay Decimalization,” NASD, Mar. 7, 2000. Press release from NASD, http://www.nasdaqnews.com/news/pr2000/ne_section00_{—}053.html; “SIA Decimalization Steering Committee Supports NASD/NASDAQ Announcement, Mar. 7, 2000, Press release from Securities Industry Association, http://www.sia.com/html/pr884.html; and Taub, Larry, “SIA/Tower Group Decimalization Analysis,” Securities Industry Association, http://www.sia.com/decimalization/pdf/towergroup.pdf. Thus, all orders on matching and distributed quotation systems are priced in standard increments—all bids and offers (whether expressed as decimals or fractions) must be in predetermined increments (e.g., dollars, eighths of a dollar, or cents). Similarly, “odd-lot” (a quantity of shares that is not an integer multiple of 100) stock transactions are subject to higher broker and exchange fees.

(I) Operational inefficiencies in trade settlement: Certain trading systems, such as electronic bulletin boards, are operationally inefficient. For example, they do not provide access to settlement methods for private trading or standardized methods of settling complex or non-routine transactions.

(J) Lack of anonymity: Known trading systems, particularly in thinly-traded, illiquid securities traded through broker networks, generally do not adequately protect the anonymity of the participants or intermediaries. Disclosure of a security offeror's identity to the system or to an intermediary can result in brokers or market makers engaging in “front-running”—trading on this “inside” market information ahead of the participant.

(K) Restricted trading periods: Systems that rely on specialists or brokers (such as the exchanges and broker networks) must have a broker or specialist available to act as the intermediary. These systems have limited trading periods imposed by the exchanges or broker networks, not the participants.

Consequently, there is a need for a securities trading system that does not operate as a conventional securities exchange or as a broker, dealer or investment advisor.

### SUMMARY

The system of a preferred embodiment of the subject invention (“the System”) operates in a way that distinguishes it from a conventional securities exchange. The System allows but does not require the posting of firm offers or require use of established, non-discretionary methods of offer interaction or transaction settlement. The System uniquely enables principal-to-principal exchange of financial information and securities and does not perform the functions of a broker-dealer or an investment advisor.

A preferred embodiment of the subject invention comprises a system and method that enables the exchange of financial information and securities, including postings of offers to buy and sell securities and negotiation of securities transactions.

The preferred system enables the trading of any securities between any number of potential buyers and sellers. The preferred method does not exclude participation by conventional exchanges or their operators, or by brokers, dealers or investment advisors. The preferred method provides an interface definition to allow integration with existing exchange, ECN, settlement, and broker-dealer systems.

A preferred embodiment requires users to satisfy Membership qualification requirements imposed by the System manager in order to access restricted access areas within the Trading System. Users of the System electronically transmit their Membership qualification data to the System's computer network and the data are analyzed to determine appropriate Member access privileges. Member information is stored in a database.

The preferred embodiment implements a communications protocol for posting offers to buy, sell, swap, hypothecate or otherwise transfer an ownership interest in a security. These offers are displayed to multiple potential Member buyers and sellers. The preferred embodiment further provides a method of communicating private offers between potential buyers and sellers. The communication of private offers is entirely discretionary to the buyer and seller and may be made by either using the communication network provided by the System or by any other communications means outside of the System selected by the communicating Members, including email, telephone and facsimile transfer. Private offers do not change the posted offers on the System.

The preferred system provides links for Members that enable the Members, at their option, to identify, select and contact independent settlement facilities and to contact a wide variety of independent professional advisors. Transaction settlement facilities that are linked to the System automatically generate either standardized or non-standardized transaction settlement documentation from the material transaction information provided by the Members to settlement facilities by direct links from the System server. The settlement facilities transmit settlement agreement documentation electronically to the buyer and seller without the use of the System's communications network.

A preferred embodiment also allows Members to settle securities trades directly, between themselves, without using a third-party settlement facility. A preferred embodiment also allows Members to use their own back office facilities, or other financial intermediaries for settlement including securities dealers, banks, and attorneys that may or may not be linked to the System.

Conventional securities exchanges are limited systems designed to: (a) operate under a specific set of securities regulations; (b) list only standardized securities; (c) apply standardized methods for the interaction of orders; and, (d) achieve regulatory compliance and investor protection by limiting access to the system. In contrast, a System of a preferred embodiment of the present invention accommodates the posting of any security by treating each type of security as a self-contained “object” that encapsulates its description, rather than forcing the security to fit a standardized description framework. This enables posting of unique, non-standardized financial instruments. A preferred System organizes these objects into categories that allow members to quickly locate a posted security.

Additionally, the object structure of the preferred System architecture is designed to enable the objects to be distributed, thereby separating the data and functionality from the format and display. This allows the System to provide an accessible programming interface so that the System operators or third parties can integrate the System's data system with global, standards-based financial information delivery protocols such as FIX and SWIFT, proprietary data formats such as TIB, and customizable formats such as XML. Additionally, the object structure also allows outside parties to provide public or private distributed objects and functionality to extend or customize the capabilities of the System.

Objects and advantages of the present invention are as follows:

First, the method of the subject invention enables individuals, institutions and other participants to register as Members and access private Member trading areas to exchange financial information and negotiate private transactions. Members are further able to pre-qualify themselves as “Qualified Members,” “Institutional Members,” and other levels of Membership status and consequent System access privileges. The System provides System trading area access Membership privileges based on (a) financial and residency/domicile standards for exemption of securities transactions under applicable securities laws, and (b) individual Member-imposed access restrictions. The System automatically prevents Members from accessing restricted trading areas within the System, or accessing certain other Members of the System, for which they have not been pre-qualified by the System.

Second, the System provides its Members with the ability to directly post buy and sell offers for securities that can be responded to by all, or by Member-selected, qualified Members. The System permits Members to, at any time, negotiate direct, confidential, principal-to-principal transactions, either with or without the involvement of intermediary agents or representatives.

Third, the operations of the System and its services to its Members are specifically designed not to constitute the operations or other activities of a conventional securities exchange, brokerage, broker/dealer, or investment advisor.

Fourth, the System will accept Member's postings of any securities issued by any entity, located anywhere in the world, without requiring pre-approval of the System operators.

Fifth, the System accepts Member's postings of offers to buy, sell, swap, hypothecate or otherwise transfer interests in both listed and unlisted securities.

Sixth, the System will accept and display in a single location all Member postings regarding all securities of a given issuer.

Seventh, the System is not a party to or intermediary in any transaction. The System does not hold securities or funds on account, or make a market in any security.

Eighth, the System protects the Member's anonymity during negotiation. Members may withhold their name, address and other personal information on an optional basis from all other Members, except those Members with whom they engage in transactions using the System.

Ninth, the System provides Members with the option of utilizing highly efficient, interactive communication links to Escrow Agents and other settlement facilities that provide standardized transaction documentation that includes forms of settlement agreements between the buyers and sellers of securities. The decision to use these services is discretionary with the Members. If Members agree after privately negotiating the terms of a transaction, the transaction information that has been provided to the System by the buying and selling Members is automatically transferred to the settlement facility specified by the Members, and the transaction information is incorporated into the settlement facility's standardized documentation.

Tenth, the System provides methods of settling transactions that are inherently discretionary to the Members. Members are not required to utilize the linked settlement facilities or any settlement facility's standardized transaction documentation, and can instead directly consummate the transaction with agents or intermediaries outside of the System, or without agents or intermediaries of any kind.

Eleventh, the System provides further operational efficiency by enabling a Member to select a settlement facility and to have prepackaged transaction documentation available to present to prospective Members who respond to the Member's posted offers.

Twelfth, the System is operationally efficient for both standard and non-standard transactions, without regard to lot size, fractional price quotations, or other provisions of the transaction.

Thirteenth, the System provides for posting of indications of interest from multiple buyers and sellers, and a method of exchanging private offers between Members. All publicly visible Member offers on the System are indicated offers only and cannot be automatically accepted as a binding contract. Members may respond privately to posted indicated offers with communications or offers that are visible only to the contacting parties. No automated matching occurs and there is no imposition of non-discretionary methods under which offers interact with each other. The Members directly engage in trades through private offers.

Fourteenth, the System compiles and displays records of closed securities transactions. This transaction data does not identify the Members involved in the transaction.

Fifteenth, the System enables Members to elect to make postings by several methods, including postings: (a) displayed to all other Members; (b) privately displayed only to Members selected by the posting Member; or (c) privately displayed and visible only to other Members who have posted a private offer as a potential counterparty in a transaction in the same security. In each case, the terms of any transactions are privately negotiated by the parties.

Sixteenth, the System permits Members to exclude selected other Members or categories of Members from viewing or responding to their publicly and privately posted offers, or may exclude all other Members except those specified by the posting Member from viewing their offers. The Member may specify different exclusion rules for each posting, if desired.

Seventeenth, the System is self-regulating and maintains a feedback bureau for Members to post notifications to other Members about alleged violations of the Rules of the System, including alleged failure of performance under negotiated agreements and negative and positive information about particular Members, Issuers of securities, securities postings by Members, linked Escrow Agents and linked financial services providers. Complaints will not disclose the personal identity of the Members.

Eighteenth, the System enables trading at any time.

Further objects and advantages will become apparent from a consideration of the ensuing description and drawings.

### BRIEF DESCRIPTION OF THE DRAWINGS

FIG. 1 is an illustration of a system of a preferred embodiment of the subject invention.

FIG. 2 illustrates the steps of a sign-up process of a preferred embodiment.

FIG. 3 illustrates the steps of collection of payment information utilized in a preferred embodiment.

FIG. 4 illustrates the steps of a process for Investor Qualification utilized in a preferred embodiment.

FIG. 5 illustrates the steps of a process for validation of input data format utilized in a preferred embodiment.

FIG. 6 illustrates a graphic user interface of a preferred embodiment displaying market listings.

FIG. 7 illustrates a graphic user interface of a preferred embodiment showing a Trading Floor page.

FIG. 8 illustrates a graphic user interface of a preferred embodiment showing an Issuer page.

FIG. 9 illustrates the steps of a process for posting an offer on a system of a preferred embodiment.

FIG. 10 illustrates web browser page rendering of a php file.

FIG. 11 illustrates a web browser page similar to FIG. 10, but with editable text fields.

FIG. 12 illustrates an HTML form used in a preferred embodiment to collect Issuer information.

FIG. 13 illustrates a graphic user interface display of a form used in a preferred embodiment to list a restricted common stock.

FIG. 14 illustrates a parent-subsidiary configuration of a preferred embodiment.

FIG. 15 depicts an Activity Board display.

FIG. 16 depicts a Trading Floor display.

FIG. 17 depicts an Advanced Search display.

FIG. 18 depicts a Search Results display.

FIG. 19 illustrates an Issue Details display.

FIG. 20 depicts an Activity Control Center display.

FIG. 21 depicts a Settlement display.

### DETAILED DESCRIPTION OF PREFERRED EMBODIMENTS

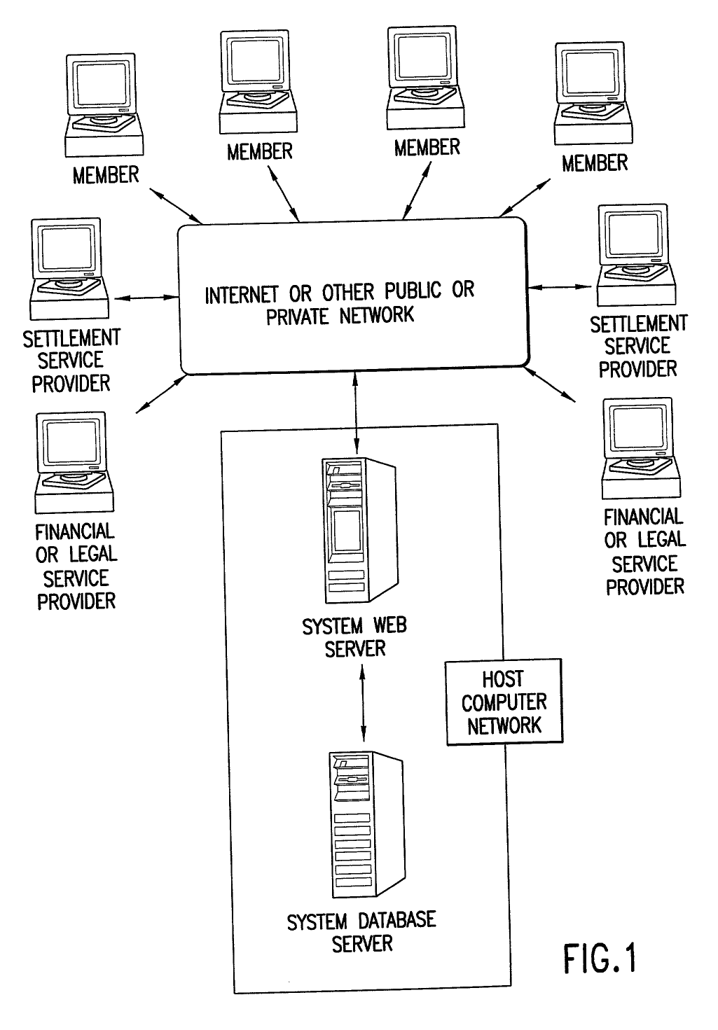

FIG. 1 generally illustrates a host computer System, a plurality of Member workstations, a plurality of transaction settlement service provider workstations, and a plurality of financial and legal service providers. As illustrated in FIG. 1, each Member and settlement facility has access to the host computer System and may access other Members and settlement facilities either through the host computer System or directly.

In a first preferred embodiment, the system of the subject invention comprises an Internet application operated by a System Operator. A preferred embodiment further comprises a Membership-based trading system for exchange of tangible and intangible assets, for exchange of financial information, for posting of indicated offers to buy and sell securities, and for conducting negotiations for transactions in any type of security worldwide. In a preferred embodiment, Members access the System using widely available web browser software or, in a further preferred embodiment, by using a middleware or a client software application provided by the System operators or by the Member. The system of a preferred embodiment derives revenues from charging Members non-contingent service and access fees. No brokerage or transaction fees are charged by the System. In addition to secondary (principal-to-principal) transactions, the System accommodates and encourages primary (Issuer) offerings of securities to Members by private placement and public offering. A preferred embodiment further comprises interactive links through the System's web site to transaction settlement providers, legal advisors, and financial and investment advisors.

The system of a preferred embodiment internally distinguishes between two fundamental classifications of securities: U.S. Listed Securities (issued by U.S. companies and listed on regulated U.S. exchanges) and Global Securities (all other securities).

With respect to U.S. Listed Securities, the system of a preferred embodiment permits any Member to use the host computer network to contact all other Members to exchange information regarding their financial assets, including postings of offers to buy or to sell their U.S. Listed Securities. With respect to Global Securities, Members must be pre-qualified to have full privileges to post offers and to view and respond to other Members indicated offers.

Membership

The system of a preferred embodiment comprises a Trading System that enables all individuals and legal entities to register as Members of the System and access private Member trading areas to exchange financial information and negotiate private transactions. The type of information and access privileges available to a Member, the ability to act upon that information through the Trading System, and access to restricted trading areas of the System, are determined by Membership classifications in the Trading System, based upon residency, domicile, financial status, and other qualifying factors. In a further preferred embodiment, the Trading System provides for Qualified Members, Institutional Members, and Associate Members. The System further provides for special Membership designations of Pre-Approved Counter-party, Agent, and Market Maker. The Trading System automatically prevents Members from accessing portions of the System for which they have not been pre-qualified.

In a preferred embodiment, “Qualified Members” of the Trading System are defined in the Trading System as either (a) a U.S. entity, citizen, or permanent resident who represents that they satisfy the standards of an “Accredited Investor,” as set forth in SEC Regulation D under the 1933 Act; or (b) an entity that is not a “U.S. Person” as defined in Regulation S under the 1933 Act. The Trading System will incorporate the regulatory requirements, if any, for other nations and sovereign bodies, as the Trading System Membership is expanded to the citizens and entities of those countries. In addition, the Trading System can change its Member criteria as needed to accommodate changes in regulatory governance.

Certain Members who are Qualified Members may satisfy the criteria to become “Institutional Members,” defined by the Trading System as satisfying the “(Qualified) Institutional Buyer” conditions set forth in SEC Rule 144A (17 CFR § 230.144A). To become an Institutional Member, a Member must represent that it satisfies the Institutional Buyer criteria, regardless of citizenship.

In a preferred embodiment, participants who do not represent that they meet the criteria to be a Qualified Member or an Institutional Member may participate in the Trading System as “Associate Members,” subject to significant restrictions on viewing offers or conducting transactions in Global Securities. In a preferred embodiment, an Associate Member has access to view all posted financial information and can post and trade U.S. Listed Securities. They may be allowed to post a Global Security for sale, and view other offers to sell the same Global Security, but cannot use the Trading System to act upon these or any other offers to sell, swap, hypothecate, or otherwise acquire an ownership interest in this or any other Global Security.

Any Member may participate directly in the Trading System, or through a licensed financial Agent (e.g., a licensed securities broker or dealer, certified financial planner, lawyer, or certified public accountant). The same access restrictions and privileges apply to the Agent acting on the Member's behalf.

Changes in Member Status

In a preferred embodiment, any Member may upgrade his status on the Trading System by providing the required Member qualification representations, but no Member may downgrade his status at any time; a Member wishing to downgrade his status must cancel his existing account and create a new Membership at the lower status. This is necessary to prohibit Members from using the Trading System to conduct trades in Global Securities, and subsequently downgrading their Member status to a level where they would not be eligible (under Trading System rules and/or government regulations) to conduct such a trade.

The System operators may, at their discretion or subject to regulatory requirements, require written confirmation of Member status or changes in Member status.

Special Membership Designations

In a preferred embodiment, Qualified or Institutional Members may apply for additional privileges through one or more Special Membership Designations. For example, a Qualified or Institutional Member may apply to the System to become a “Pre-Approved Counter-party.”

Qualified or Institutional Members desiring to have the special designation of a “Pre-Approved Counter-party” (PAC) must apply directly to the System operators in order to access a specialized portion of the Trading System for the exclusive use of PACs. The Trading System operators establish the criteria for becoming a PAC, such as the Member's access to or existing accounts and trading relationships with System-specified settlement facilities. These settlement facilities could include, for example, clearing brokerages and banks, Depository Trust Corporation, and Euroclear. PAC applicants may also be required to satisfy financial requirements, such as funds on deposit with an independent third party, as verified by the System Operator. The System Operators may designate or contract an independent third party to process and verify PAC applications.

Agent:

An Agent represents one or more Members by acting in a fiduciary capacity for the Member(s) on the System. Any Member may revocably designate an Agent to act in a fiduciary capacity on the Member's behalf in using the System, and may limit the Agent's fiduciary responsibilities to a subset of the Member's privileges and rights on the System. For example, the Member may designate that the Agent has the right only to sell a security specified by the Member. Another example would be for the Member to enable the Agent to have all trading rights on the Member's behalf, but not the rights to change any Member account information (such as password, e-mail address, billing information, etc.).

At any time, a Member may cancel or change their designation of an Agent. Any open (current) posting or negotiating activity by the Agent will be canceled unless the Member makes a positive election within a System-specified period (e.g., 7 days) on the System to transfer the open activities to a new Agent or to their own direction in their Member account.

An Agent may cancel his representation of a Member. Open transactions will be designated on the System as “Temporarily suspended” until the Member makes a positive election within a System-specified period (e.g., 7 days) on the System to transfer the open activities to a new Agent or to their own direction in their Member account.

At any time, a Member may cancel its PAC status. Any postings, transactions, or open activity in the PAC trading area of the System will be inactivated and noted on the System as canceled for a System-specified period (e.g., 7 days). Cancellation of PAC status does not affect any completed negotiations with other PAC Members, nor does it affect listings or open activities outside of the PAC trading area of the System.

The System operators may, at their discretion, require written confirmation of changes in PAC status or election of or changes to Agent status.

To sign up as a Member of the System, a visitor clicks on a hyperlink and a secure, encrypted connection is established with a server in the System host computer network. The server sends the first sign-up form to the browser on the visitor's workstation. For each entry in the form, a short informative description is provided, as well as a hyperlink to a more extensive description in a help window or page. The Membership sign-up process has three parts.

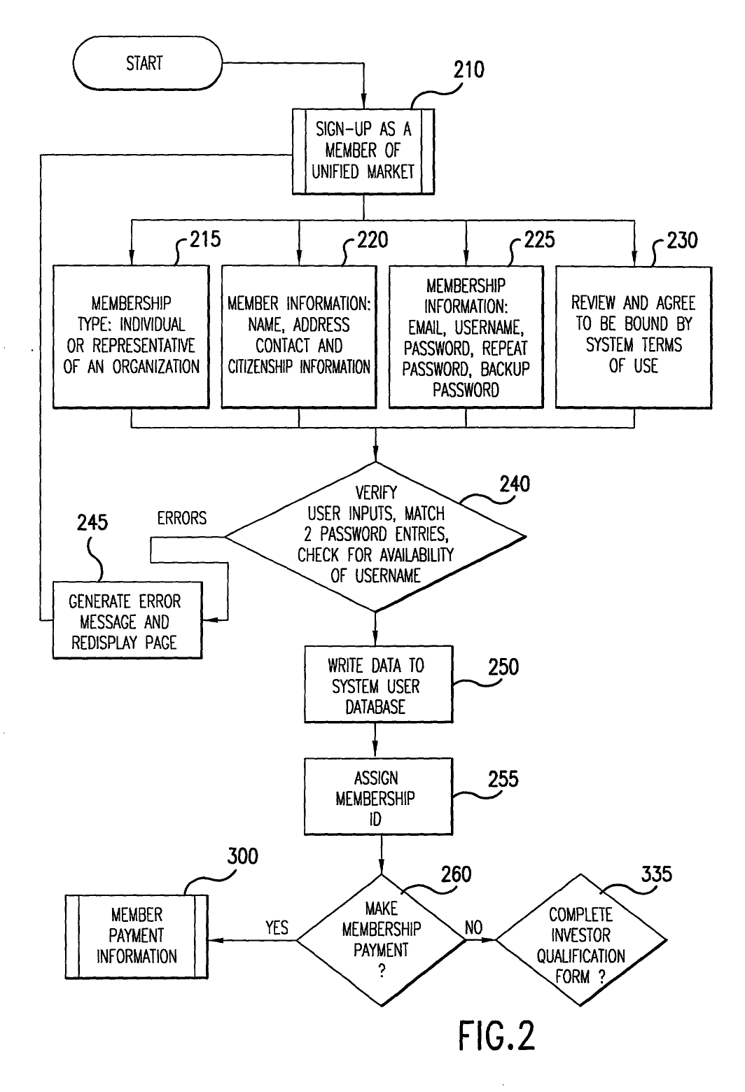

The first part, which is the only required part of the sign-up process, involves collection of the minimum set of information needed for a Member to log in to the restricted access portions of the web site. Table 1 specifies the information collected. The process diagram for this part of the sign-up process is shown in FIG. 2.

TABLE 1
Required Information Collected for Membership Sign-Up.

| | HTML form | |
|---|---|---|
| Information Collected | element | Notes |
| Specify individual or representative of an | Radio buttons | One button must be selected, default is |
| organization or other entity | | individual. |
| Member country of citizenship or | Select list of | Countries and 2-letter codes from ISO |
| permanent residence | countries. | 3166-1.¹ |
| E-Mail address | Text | Must be the proper form for an e-mail |
| | | address.^{2,3} |
| Username | Text | Validate input is not blank, 6 to 15 |
| | | characters. |
| Password | Password | Validate input is not blank, 6 to 15 |
| | | characters. |
| Password, re-entered to confirm | Password | Validate input is not blank, 6 to 15 |
| | | characters. |
| Backup password or reminder phrase | Text | Validate input is not blank, 6 to 15 |
| | | characters. |
| Review and agree to be bound by “Rules | Checkbox | Must be checked (indicating agreement) |
| of the System” | | to successfully complete Member |
| | | application. |
| Review and agree to be bound by “Terms | Checkbox | Must be checked (indicating agreement) |
| of Use” | | to successfully complete Member |
| | | application. |

¹ISO 3166-1 approved country 2-letter codes can be found on the ISO 3166 maintenance agency web site, at http://www.din.de/gremien/nas/nabd/iso3166ma/codlstp1.html.
²The specification for Internet e-mail address formats is Internet RFC 822, available at ftp://ftp.rfc-editor.org./in-notes/rfc822.txt.
³A detailed PERL REGEX program to validate the format of an e-mail address can be found in: Freidl, Jeffrey E. F., Mastering Regular Expressions, Appendix B. Oreilly: Sebastapol, CA, 1997; it can also be found online at http://www.wg.omron.co.jp/˜jfriedl/perl/index.html.

At step 225, the user types in his name, address and residence information, e-mail address, username, password (entered twice for confirmation), and a backup password or reminder phrase. At step 230, the user checks the checkbox to indicate that he has reviewed and agrees to be bound by the System Terms of Use.

When submitted, information in the HTML form is verified at step 240 according to the client and server-side procedures described below. In addition, a search of a Member database is performed to see if the chosen username is already in use. If so, an error message is generated and the Member is prompted to select a different username.

If all of the Member's inputs are verified to be of the proper form, and the chosen username is not in use, the data are recorded at step 250 in the Member database and the Member is issued an alphanumeric account ID. The account ID begins with a 2-letter country designator for the country of the Member's citizenship or permanent residence.

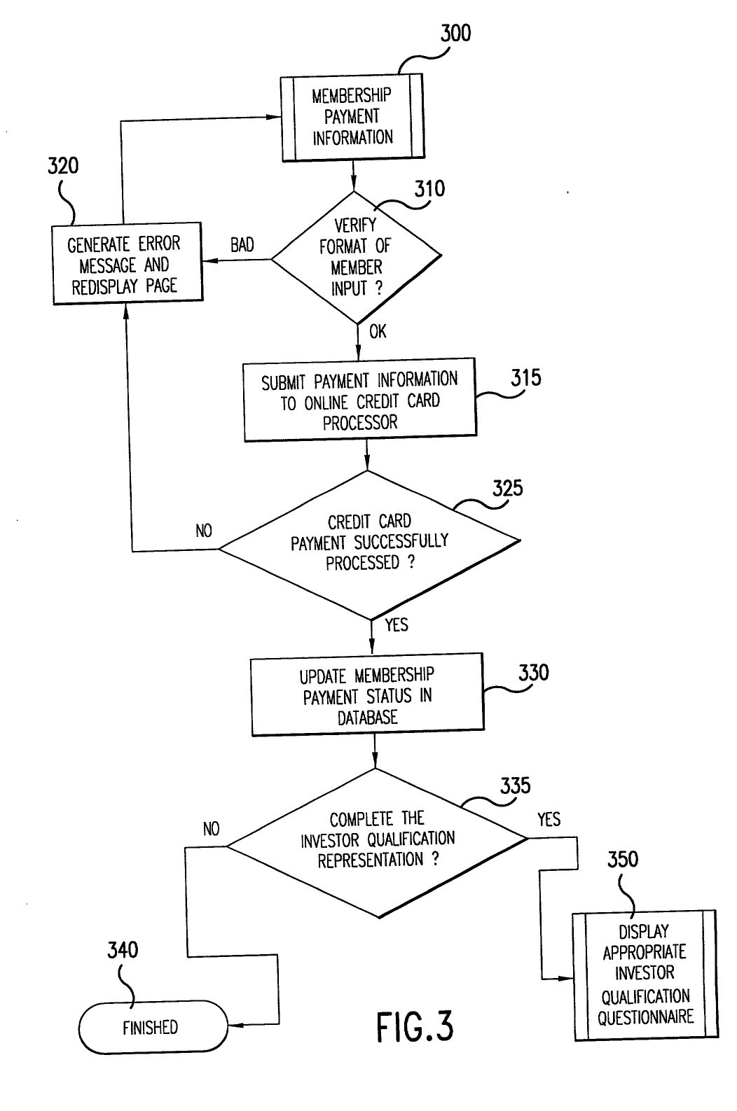

Membership must be renewed at least every 90 days. Upon successful registration a Member is presented at step 260 with the option of paying a Membership fee to activate Membership at this point in the sign-up process. FIG. 3 describes the collection of payment information.

Information is collected at step 300 from the Member for purposes of collecting funds by credit card, electronic check, or other online payment system. For a credit card payment, the Member provides the credit card number and card expiration date. At step 310, this information is checked by a client-side verification script for proper formatting. For example, the credit card number is checked using the well-known Luhn check sum algorithm. If the format of the credit card number is incorrect, at step 320 an error message is generated, and the form of step 300 is redisplayed. If the submitted information is properly formatted, the payment information is encrypted and transmitted to a payment processing vendor over a secure connection at step 315 by standard methods in wide use for Internet-based commerce. At step 325, the payment processing system reports whether the payment was successfully processed, appropriate credits are added to the Member's account in the Member database in step 330, and the Member is presented with the option of completing the Investor Qualification Representation at step 335. If an error occurs in payment processing, an error message is generated at step 320 and the payment form is redisplayed at step 300.

If at step 335 the user chooses to complete the Investor Qualification Questionnaire, he proceeds to the third part of the sign-up process. Thus, upon successful registration, and optionally after payment for Membership, a page with an HTML form to gather investor qualification information is sent to the Member's screen or browser client. This form data is used to determine the user's Membership level (“Associate”, “Qualified”, or “Institutional”, as defined above).

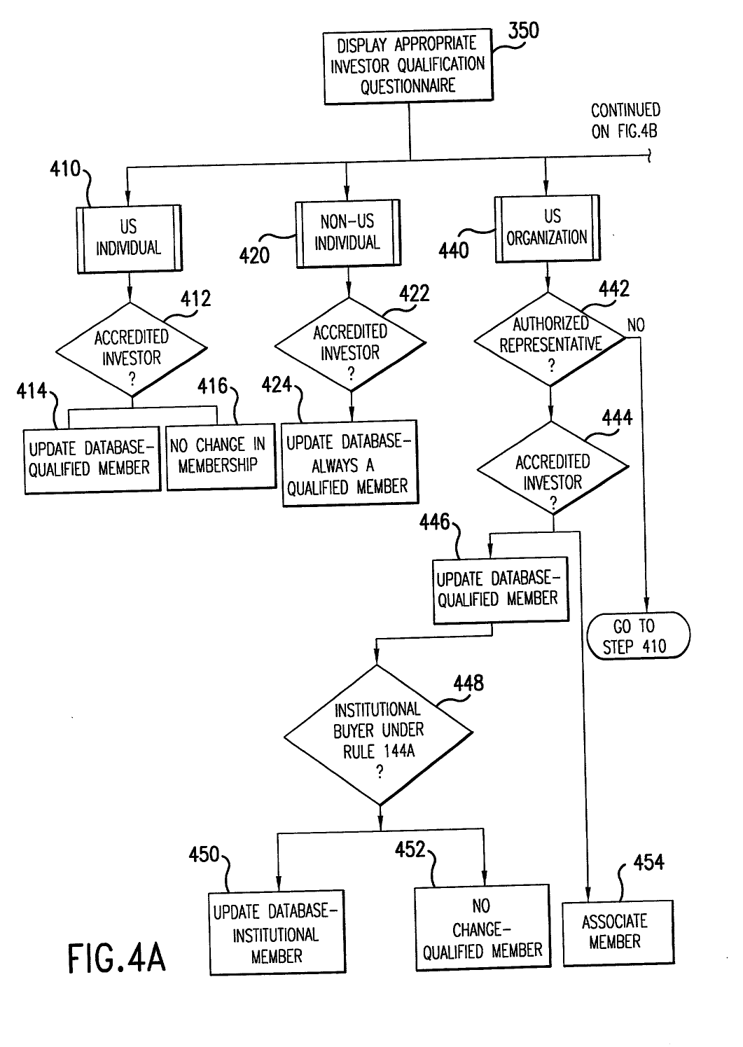

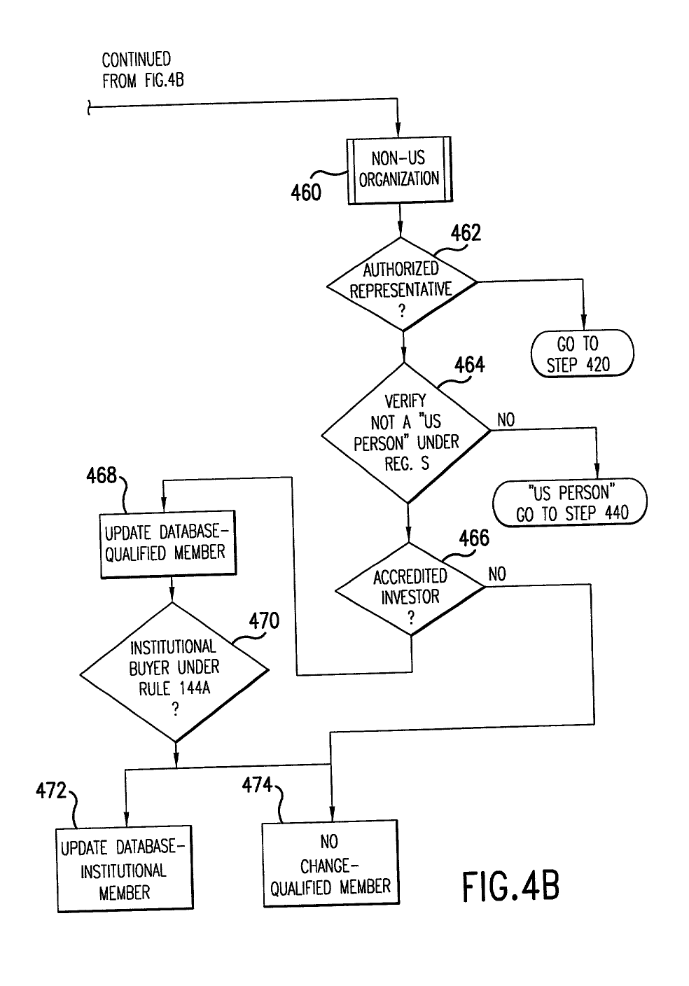

The process for Investor Qualification is illustrated in FIG. 4. At step 350, the System selects and transmits to the Member the appropriate form, based on whether the Member is a U.S. or non-U.S. citizen and whether the Member is applying as an individual or as a representative of an organization. For a U.S. individual, the form of step 410 is displayed. The Member is presented with an HTML form with descriptions of the income and net worth criteria and checkboxes to represent whether the Member meets these individual accredited investor income and/or net worth levels. The Member submits the form to the host computer at step 412 and if one of the checkboxes is checked, the Member has represented that the Member meets the SEC criteria to be an accredited investor, and this information is recorded in the System database at step 414. If no appropriate boxes are checked, the Member status is not updated (step 416). The default status for all U.S. Members is Associate Member. In this manner, the Member may use this form on initial Member sign up, or use the form at a later time to upgrade their status, but cannot use the form to downgrade their status. A Member must either create a new Membership, or petition directly in writing to the System manager to have their Membership status lowered. This is necessary to prevent Members from representing themselves as Qualified and accessing restricted area of the System, and subsequently downgrading their status to non-Qualified.

For a non-U.S. individual, the form of step 420 is displayed. The default Membership level for non-U.S. persons is “Qualified”, since they are not subject to U.S. SEC jurisdiction. The Member is presented with an HTML form with descriptions of the income and net worth criteria and checkboxes to represent whether the Member meets these individual accredited investor income and/or net worth levels. The Member submits the form to the host computer at step 422 and if one of the checkboxes is checked, the Member has represented that the Member meets the SEC criteria to be an accredited investor, and these representations are recorded in the System database at step 424.

A person applying as a representative of an organization domiciled in the U.S., or controlled by U.S. individuals or organizations, is presented with the HTML form of step 440. The Member must represent that he is authorized to represent the organization, and select by checking a checkbox from several standard SEC descriptions of entities that qualify as accredited investors. The System verifies that the representation authority checkbox is not checked at step 442. If not, the System proceeds to step 410 and prompts the user to edit the information, for example, to sign up as an individual. At step 444, the System verifies that at least one of the accredited investor description checkboxes has been checked. If so, at step 446 the System database is updated with the representation information and the Membership level is changed to “Qualified Member.” The Member is then presented the option of qualifying as an “Institutional Member” at step 448. The Member checks the checkboxes of the descriptions, if any, that describe the Member's organization and would qualify the organization as an “Institutional Buyer” as set forth in SEC Rule 144A. If at least one checkbox has been checked, at step 450 the System updates the Member information in the database to record the representations and change the Member status to “Institutional Member.” If no checkboxes are checked, the Member is informed at step 452 that there has been no change in his status.

Non-US organizations are presented the form of step 460. Organizations not domiciled in the U.S. must answer a series of questions to ensure that the organization does not qualify as a U.S. entity under conditions other than country of domicile, as set forth by U.S. SEC Regulations, defining a “U.S. person.” The member is presented with standard descriptions that they must check to represent that do not meet any of the definitions of a “US person”. The system verifies that the representation authority checkbox is not checked at step 462. If not, the system proceeds to step 420 and prompts the user to edit the information, for example, to sign up as a non-US individual. The System verifies at step 464 that all of the checkboxes have been checked so that the member is not a “U.S. person”. If not, the system proceeds to step 440 and prompts the member to sign up as a U.S. Organization. At step 466, the system verifies that at least one of the accredited investor description checkboxes has been checked. If not, the System proceeds to step 474. If so, at step 468 the system database is updated with the representation information. In either case, since the entity is not a U.S. person, the minimum membership level is automatically “Qualified Member” is thus is unchanged. The member is then presented the option of qualifying as an “Institutional Member” at step 470. The member checks the checkboxes of the descriptions, if any, that describe the member's organization and would qualify the organization as an “Institutional Buyer” as set forth in SEC Rule 144A. If at least one checkbox has been checked, at step 472 the system updates the member information in the database to record the representations and change the member status to “Institutional Member”. If no checkboxes are checked, the member is informed at step 474 that there has been no change in their status.

After registration a confirmation e-mail is sent to the Member's specified e-mail address, and a notification e-mail is sent to the System Manager.

Members representing organizations have the option of applying for the special designation of Pre-Approved Counter-parties (“PAC”), in order to access the System's Institutional Market. Members click on a hyperlink and the criteria for PAC designation, and an application are displayed. In a preferred embodiment, a Member prints the application and submits the completed, written application to the System operators or their designated agent for verification of the information. The Member is notified by telephone, email, or message in his System Membership account regarding the account application

Data Validation

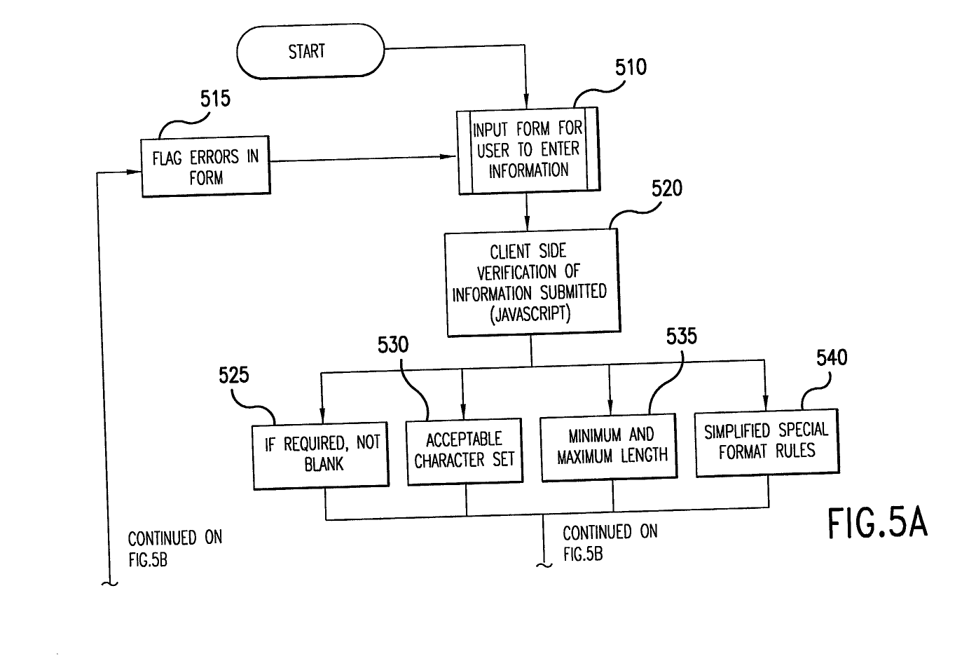

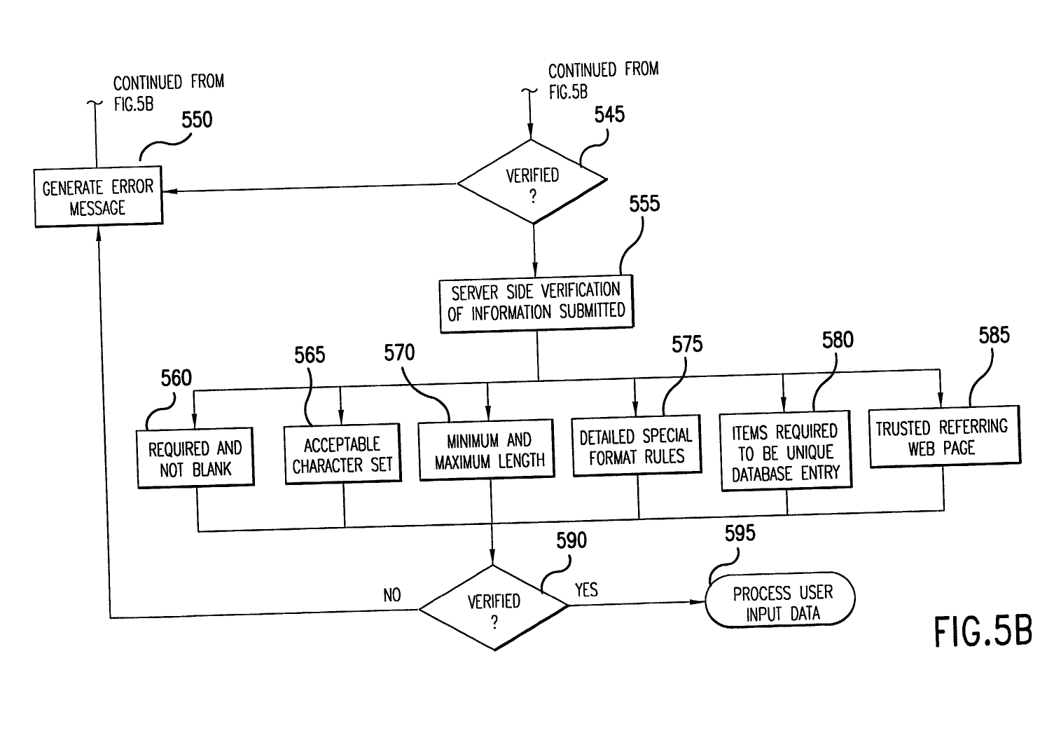

In all forms utilized for gathering data on the System web site, critical data supplied by users is validated for proper format. For example, an e-mail address is tested to determine if the entry has the correct format for an e-mail address, but is not tested to determine if it actually represents a valid, active e-mail address. This testing is conducted on the client side (before the data are submitted to the server) and on the server side. FIG. 5 shows the flow process for general validation of the format of input data. If this is the first time that the page has been displayed, at step 510 the System presents a page with blank data. If not, at either step 545 or step 590 an error message is displayed and the page is redisplayed with previous form data and with erroneous or improper inputs highlighted.

At step 520, when the form is submitted with entered data, a client-side script (CSS) (such as a Javascript program) is executed to screen the input, item by item, for obvious input errors. This reduces the amount of erroneous data supplied to the server for processing. This client side validation includes the following steps:

At step 525, if data for a particular field must be entered, the CSS verifies that the input string is not empty and does not consist of only blank characters. At step 530, the CSS verifies that the input string does not contain any unacceptable characters, or only contains characters in a specified character set. At step 535, the CSS verifies that the length of the input (the number of characters in the data string) is not less than a specified minimum number or greater than a specified maximum number of characters.

At step 540, the CSS checks the input string against any special format rules. For example, the CSS verifies that an e-mail address contains one and only one “@” symbol, and at least one period (“.”), with not less than 2 characters after the final period. The CSS optionally also checks data using any other appropriate input rules.

At step 545 if the input data are verified by the CSS, the data are transmitted to the System server for server-side verification at step 555. If the data are not verified at step 545, a descriptive error message is generated at step 550, the errors are flagged at step 515, and the form is redisplayed, with flagged errors, at step 510.

At step 555 the System uses software to perform server side verification and validation of the data (for ease of reference, we shall refer to the server-side verification software as “SVS”). This is necessary, for example, (a) to prevent falsified input from being processed that was submitted using a form not on the System, (b) to perform more extensive checking of the data, (c) to determine whether inputs that will be written to a database as key/index entries are unique, (d) to determine, if necessary, whether the submitted data match a current entry in the database, and (e) enable client software that does not support CSS to access the System. At step 555 SVS checks the data for input errors. Step 555 includes the following substeps:

At step 560 if data for a particular field must be entered, SVS verifies that the input string is not empty and does not consist of only blank characters. At step 565 SVS verifies that the input string does not contain any unacceptable characters, or only contains characters in a specified character set. At step 570 SVS verifies that the length of the input (the number of characters in the data string) is not less than a specified minimum number or greater than a specified maximum number of characters.

At step 575 SVS checks the input string against any special format rules. For example, SVS verifies that an e-mail address conforms to the Internet RFC 822 specifications for e-mail address formats. The specification for Internet e-mail address formats is Internet RFC 822, available at ftp://ftp.rfc-editor.org/in-notes/rfc822.txt.

At step 580 SVS verifies that any inputs that must be unique in the database are not duplicated in existing entries.

At step 585 SVS checks the Hypertext Transfer Protocol (HTTP) header to obtain the identity of the referring web page, and rejects submissions that are not from trusted web sites such as the System pages, linked settlement facilities, and other linked systems. If at step 590 the input data are verified, the data is submitted to the server, which at step 595 continues processing the data. If at step 590 there are errors, a descriptive error message is generated at step 550, the errors are flagged at step 515, and the form is redisplayed, with flagged errors, at step 510.

Member Log In

Members log in to the System using a process well-known to those skilled in the art. The username and password are entered, and the information is transmitted over a secure connection to the host computer System database for verification that the username is a valid entry in the database, the password matches the password in the data record containing the username, and the Membership is currently active (not canceled or expired).

If the log-in is successful, the System tracks the user session using common Internet methods, said methods comprising using cookies and/or session variables passed in the HTTP request headers from the client to the server. If the log-in is unsuccessful, the user is prompted to re-enter the information. Alternatively, the user may provide their username and backup password (or reminder phrase), and the System transmits a page with their password over a secure connection.

Upon successful log-in, the Member is able to access the Trading System through a page displayed on the Member's workstation, with hyperlinks to the various market displays and functions of the System site. This is referred to as the “main page”. Members have access to several interrelated areas on the System through the main page, including: (a) Markets, (b) Trading Floors, (c) Issuer Pages, (d) Access Manager, (e) Add Listings, (f) Negotiation, (g) Settlement, and (h) Trade Records. Each of these areas is discussed in detail below.

Markets

The markets and securities that are visible on the main page are determined by Membership level and Member preferences. In a preferred embodiment, there are 4 main categories of markets: (a) My Market: U.S. Listed Securities only, (b) Member Market: all securities (U.S. Listed and Global Securities), (c) Institutional Market: Pre-Approved Counterparty (PAC) Market for all securities, and (d) the Member's individual Portfolio Markets.

Associate Members have not represented themselves as accredited investors and only have access to MyMarket. Qualified and Institutional Members are accredited investors and have access to Member Market, which includes all listings on MyMarket. Access to the Institutional Market is restricted to Members with the special PAC designation. All Members have the ability to create their own private, Portfolio Markets.

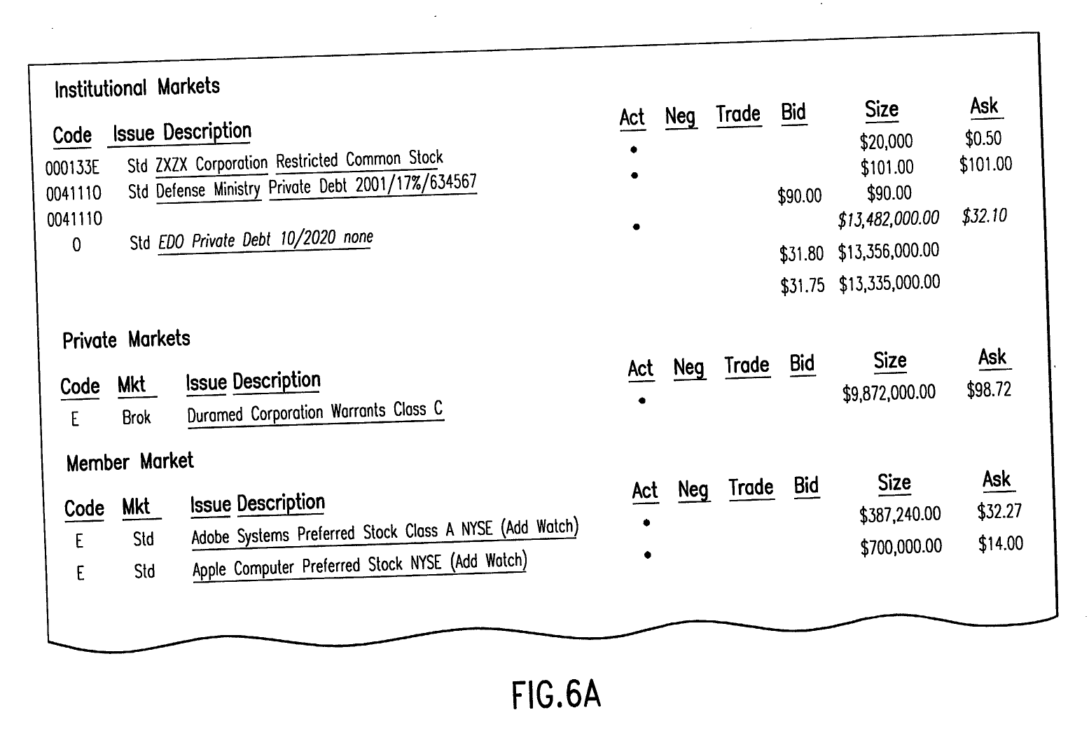

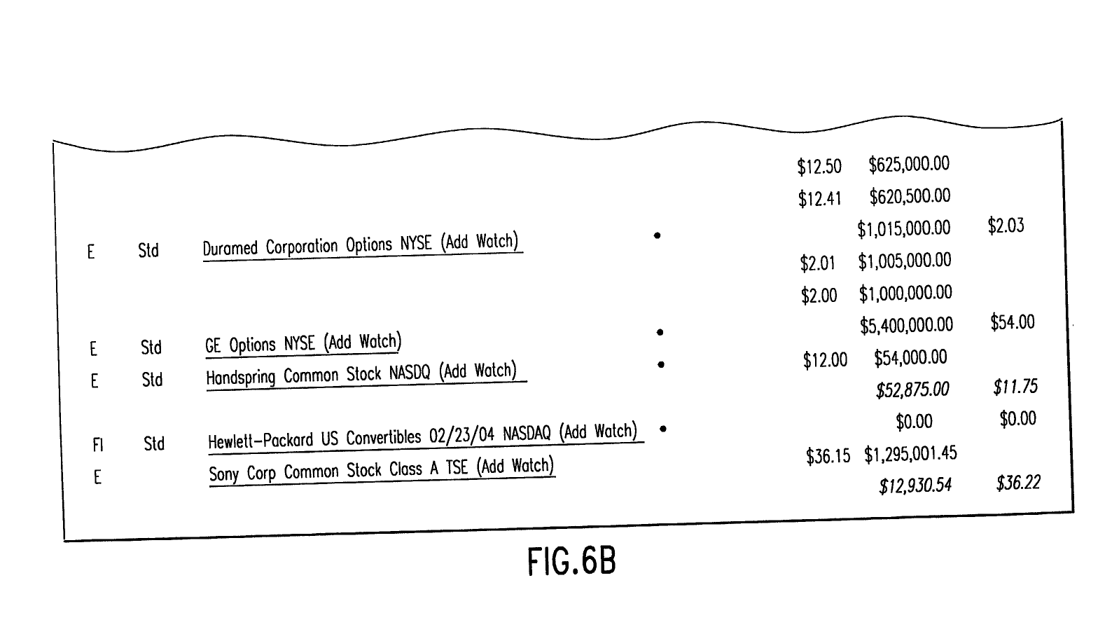

FIG. 6 is a screen shot example of the market listings on a main page visible to a PAC Member. There are 3 markets shown, the Institutional Market, Portfolio Markets, and Member Market. Listings within a market category of security are identified by an item code, comprised of a System-assigned database record number and a character indicating the general category of security, such as E=equity (common and preferred stock, stock options, warrants, etc.), F=fixed income (Treasury bills and bonds, corporate bonds, sovereign and municipal bonds, convertible bonds, other debt instruments, etc.), and O=other (e.g., limited partnership interests, letters of credit, oil and gas royalty interests). Postings listed on the market display do not include the full code, only the category designator. All headings on the market listing screen (“Code,” “Mkt,” “Act,” and so forth) are hyperlinked to help pages or windows explaining the Terms in greater detail.

The “Mkt” listing indicates whether this is the standard Institutional Market, indicated by the entry “Std,” or a private marketplace created by another Member. In FIG. 6, an example of a private market within the Institutional Market is indicated by “Brk6.” These private markets are established by Members using the System Access Manager, described below.

“″Issue Description” provides a very brief description of the security and Issuer. The listings are hyperlinks to more detailed displays: the Issuer name (for example, ZXZX Corporation) is linked to the Issuer page listing all securities for that Issuer, the security description (for example, Restricted Common Stock) is hyperlinked to the details for that posting.

The status of the posting is indicated, noting whether the posting is active (“Act”), in negotiation (“Neg”), or Members have used the System to send proposed transaction information to a settlement facility or, alternatively, reported that a proposed transaction has been negotiated (“Trade”). Listings at the “Trade” stage are displayed for information purposes only and not hyperlinked, and thus are not open to negotiations with other Members. Once a listing changes to “Trade” status, it is displayed only for an additional set period, such as 24 hours.

Offers to acquire the security are listed under “Bid,” offers to sell are listed under “Ask.” Both of these are the price per unit (e.g., price per share). Bid and Ask are hyperlinked to a Trading Floor and the details of the particular Bid or Ask. If a Member clicks on their own Bid or Ask offer, indicated on the display in a distinctive typeface such as italics, the offer is displayed in an “Add Listing” page and can be edited.

“Size” indicates the total notional value of the transaction. For equities, such as a common stock, this is price multiplied by number of shares. For fixed income, such as bonds, this is the price multiplied by the number of bonds, multiplied by 1000.

Trading Floors

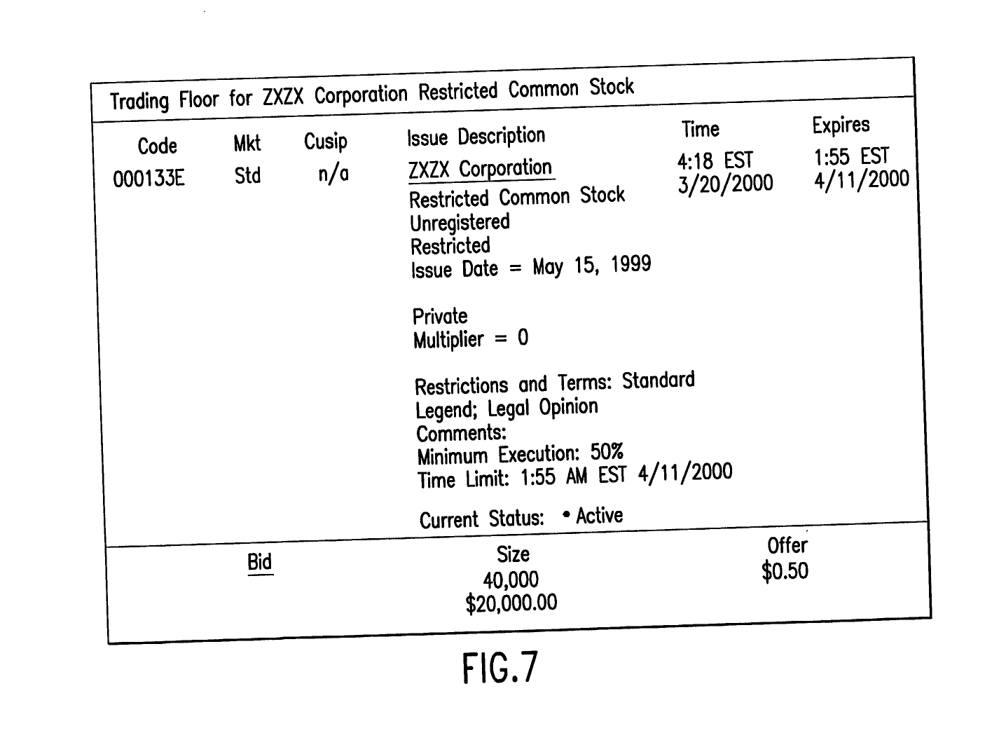

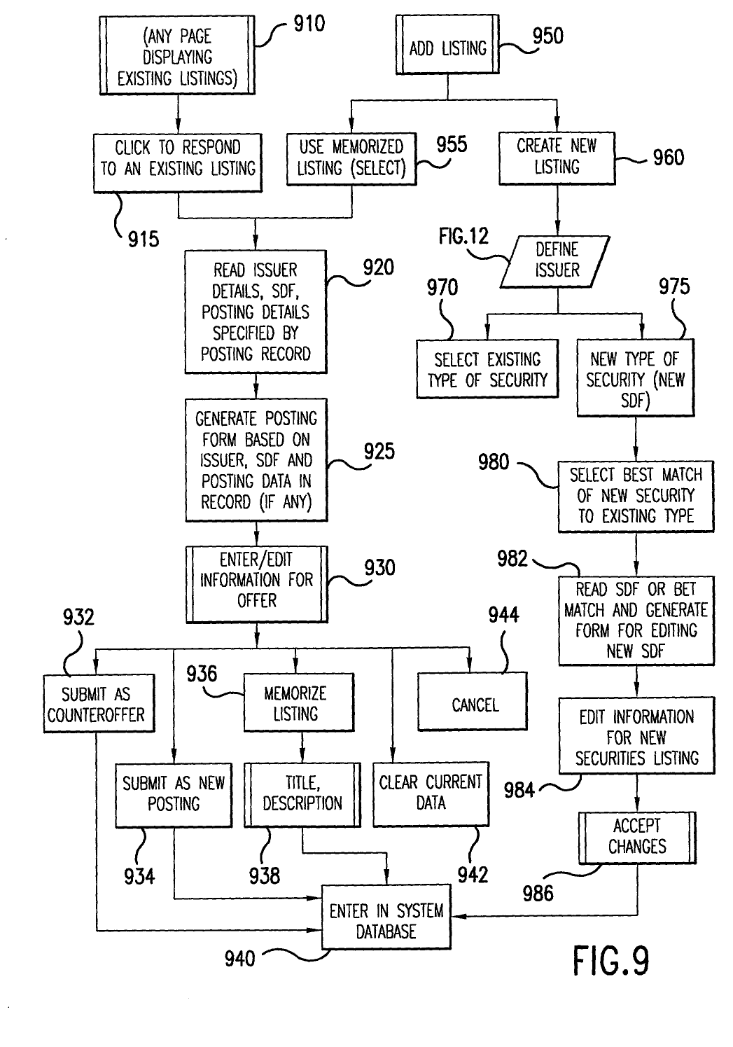

FIG. 7 presents a screen shot of the “Trading Floor” page. The item code and market are displayed. A standard securities identification code such as CUSIP or ISIN is displayed, if available. The Issue description now contains the complete information from the listing that was provided using the “Add Listing” function, described in FIG. 9 and associated text. Expiration time and date for the offer are also given. Clicking on hyperlinked “Ask” and “Bid” icons allows the Member to post new Ask or Bid offers for this security, as described below in FIG. 9, step 910 and the accompanying description.

Issuer Pages

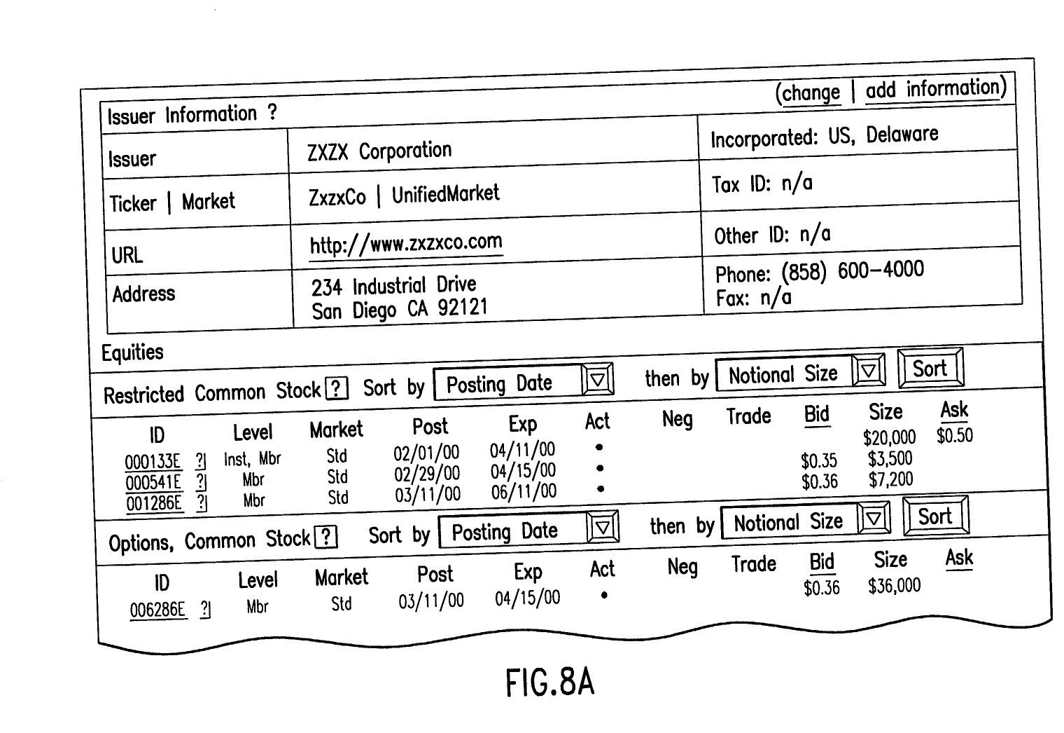

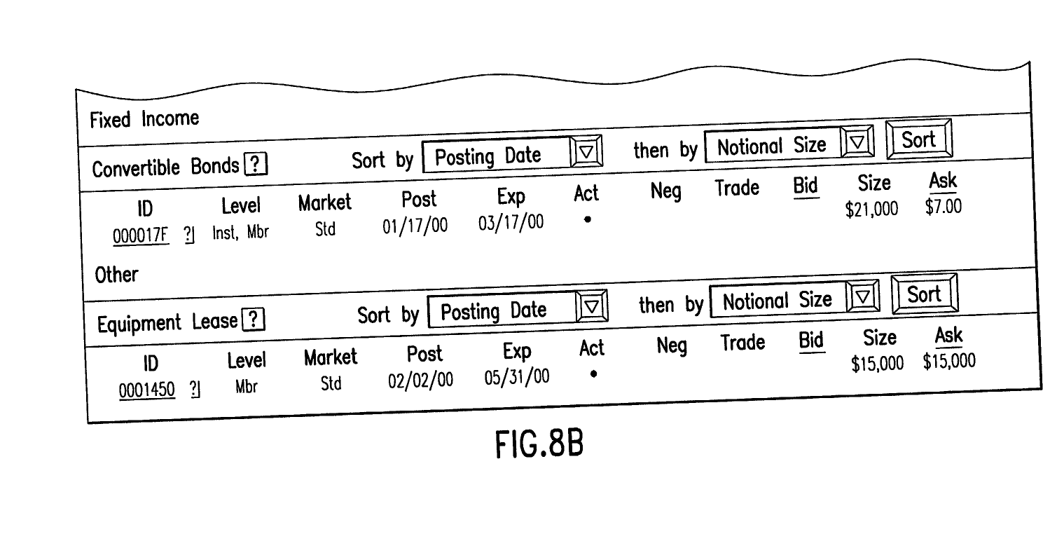

FIG. 8 presents an example of an Issuer page. Complete address details are provided, and each active posting for that Issuer's securities are listed, arranged by security type. The listings are identical in format and function to the listings in the various marketplaces, described in FIG. 6 and the accompanying description.

Access Manager

Members can create private marketplaces by specifying on the Add Listing page the choice of “Private Market” as the marketplace to post the listing. The server saves the details of the listing and transmits the Access Manager page to a Member's workstation. In a private marketplace, the Member can specify individuals or groups that are invited to join the private marketplace, and can set the trading rules for that marketplace.

To specify the invited Members, the posting Member enters in a form text box a comma-separated list of other Members' external email addresses to invite them to the marketplace. Next the Member selects the type of sale. The default is a “silent” auction format, where other bidders are not informed of the current best price, or what other Members have been invited to or are participating in the auction. This auction is implemented using common methods well-known to those skilled in the art. The Member specifies the start date and time, end date and time, and minimum bid. The Member specifies a short, unique name for this Private Market.

The data are submitted to a System server and written to a System database, and an email is sent to each Member on the list notifying them of their invitation to participate in the Private Market. The Private Market is then immediately available to be viewed by invited Members.

The ability to create a private marketplace and specify the interaction of orders and method of settlement enables users to use combinations of firm/non-firm offers and discretionary/non-discretionary methods of settlement.

Add Listing

A Member desiring to post an indication of interest to acquire or transfer an ownership interest in a security completes standardized posting forms on the System to specify the Issuer, security, restrictions, and desired terms of the transaction. In the following description of the posting process, we assume that the Member has logged into the System and provided his username and password, the user session has started, and the Member credentials have been established.

To post an offer to buy, sell, swap, hypothecate, or otherwise transfer a security, a Member can access the Listing function in several ways. First, the Member can click on a hyperlink for an existing posting in one of the System markets, or a hyperlink for a security type on an Issuer page. As a second alternative, the Member can access the “Add Listing” database of the System, and recall one of their previously saved and “memorized” listings, or add a new offer. A new offer can be created based on standard forms for securities transaction types already entered in the System, or the user has the option of defining a custom security and/or transaction posting and the form to submit it.

A posting on a preferred embodiment of the subject system is comprised of a security definition format (“SDF”) for each type of posting on the System, and the individual details of each posting. The SDF defines how a posting form is displayed and accepts data entry. The SDF comprises (1) a list of a number of HTML form objects and a subset of the allowed properties and methods for the object, (2) a short text description that serves as a label for the object, and (3) a longer text description that can be accessed to provide help and explanation. The SDF is described in detail below. Each type of security has an SDF. Example types of securities include but are not limited to common stock, restricted common stock, preferred stock, restricted preferred stock, bonds, convertible bonds or debentures, options, warrants, rights, royalty interests, debt and other financial instruments.

The general process for posting on the preferred system is illustrated in FIG. 9. If the Member workstation currently displays a screen with a hyperlink to any existing listing, the Member is starting at step 910. By clicking on this hyperlink (step 915), a request with the unique record identifier contained in the URL is sent to the System database, which at step 920 reads the database record corresponding to that listing. The database record includes details identifying the Issuer and the SDF necessary to format the form to be sent to the user. At step 925, the server software parses the SDF and uses the information to generate the data input form. If the Member is accessing an existing listing, the System automatically includes the data from the posting (price, quantity, etc.) as the default values in the form. At step 930, the Member edits or enters information in the form. At step 932 the Member submits the information to the server to be entered in the database as a new offer for posting. Alternatively, at step 934 the Member submits the information to the server to be entered in the database as a counteroffer to the original posting, visible only to the Member posting the original offer. A third alternative is that at step 936, the Member submits a request to the server to memorize the transaction for later use, at which point the Member is prompted at step 938 to enter a title and description to identify the memorized posting which is at step 940 written to the database along with the posting data. A fourth alternative is for the Member to clear the form at step 942. This clears any offer data but does not clear the Issuer or security type. A Member can also cancel the process in step 944 and return to the original page (steps 910 or 950).

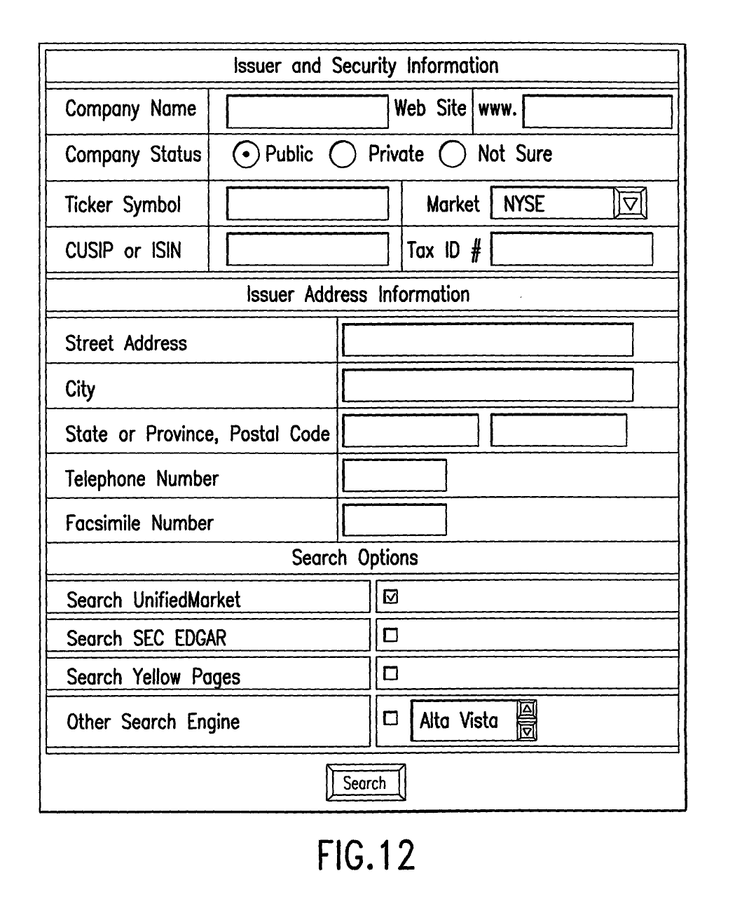

If the Member accesses the “Add Listing” page on the System site, she has the option of selecting from a list of her previously memorized transactions at step 955, and subsequently following the process of modifying the listing described above (steps 920 through 944). If the Member chooses to create an entirely new listing (step 960), they first must complete the process of identifying or defining an Issuer, which is described below in FIG. 12 and accompanying text. Upon completing the process described in FIG. 12, the Member has the option of selecting an existing type of security at step 970, at which point the System executes step 925 and generates the screen of step 930 on the Member workstation, enabling the Member to complete the posting process through steps 930 through 944.

If the Member chooses at step 975 to define a new type of security, the Member is must select at step 980 as a template an existing SDF that closely matches the new definition or a generic template. At step 982, the System generates the form to edit the specified template and transmits this form to the Member's workstation. At step 984, the Member can edit the form by adding or deleting elements, changing labels, changing descriptions, and selecting or omitting the data validation rules. When the Member has completed changes to the form for the new security type, he clicks on the “Accept” button (step 986), and the System translates the information from the online form into a new SDF, saves at step 940 the current SDF, executes step 925, and generates the screen of step 930 on the Member workstation, enabling the Member to complete the posting process through steps 930 through 944.

Security Definition Format (SDF)

The SDF describes the HTML form elements that the server must render to generate the form to list a type of security. This SDF can be a code fragment that is read and automatically included in the HTML page being rendered, using well-known methods such as server side includes (SSI) or server side parsed HTML such as the INCLUDE(“file”) function of php3. Alternatively, the SDF can be stored as a simple text file or database record, the information parsed as needed, and the form elements rendered dynamically, for example, by using a simple PERL script.

LISTING 1 below provides a simple illustration of one embodiment of an SDF for trading a stock certificate, where the form collects information on offering price, quantity, offer expiration date and certificate issue date. The form also automatically generates a posting date for the offer that cannot be edited. In this example, the SDF is written as a simple text file that is later parsed to generate the form elements. Formatting on the listing is for clarity only. The properties and methods for form element conform to HTML standards and are well-known to those skilled in the art. HTML standards and recommended standards are published by the World Wide Web Consortium and can be found at http://www.w3 .org/TR/.

```
------------------------------------------------------------------------------------------
LISTING 1 - SDF EXAMPLE
------------------------------------------------------------------------------------------
START {
define QUANTITY {
  label=“Qty (shares)”;
  text_description=“Enter the quantity of shares offered”);
  object=“text”;
  properties {
    name=“quantity”;
    size=“5”;
    maxlength=“15”;
    value=“”;
  }
  methods {
    onSubmit=not_blank(true),verify(postive_number);
  }
}
define PRICE {
  label=“Price ($U.S.)”;
  text_description=“Enter the price per share.”);
  object=“text”;
  properties {
    name=“price”;
    size=“10”;
    maxlength=“15”;
    value=“”;
  }
  methods {
    onSubmit=not_blank(true),verify(positive_number);
  }
}
define EXPIRATION_DATE {
  label=“Offer Expires”;
  text_description==“Date the offer will automatically expire.”;
  object=“text”;
  properties {
    name=“expiration_date”;
    size=“10”;
    maxlength=“15”;
  }
  methods {
    onLoad=value->(date(today+1));
    onSubmit=not_blank(false),verify(date_today_or_after);
  }
}
define CERTIFICATE_ISSUE_DATE {
  label=“Certificate Issue Date”;
  text_description=“Enter the date that the certificate was
acquired. This is generally the date when payment was made or other
consideration tendered for the certificate.”);
  object=“text”;
  properties {
    name=“certificate_issue_date”;
    size=“10”;
    maxlength=“15”;
    value=“”;
  }
  methods {
    onSubmit=not_blank(true),verify(date_before_today);
  }
}
define SPECIAL_TERMS {
  label=“Special Terms and Restrictions”;
  text_description=“Enter any special terms for the transaction or
any restrictions on transfer.”);
  object=“textarea”;
  properties {
    name=“special_terms”;
    cols=“30”;
    rows=“5”;
    value=“”;
  }
  methods {
    onSubmit=not_blank(false),
  }
}
}
END
------------------------------------------------------------------------------------------
```

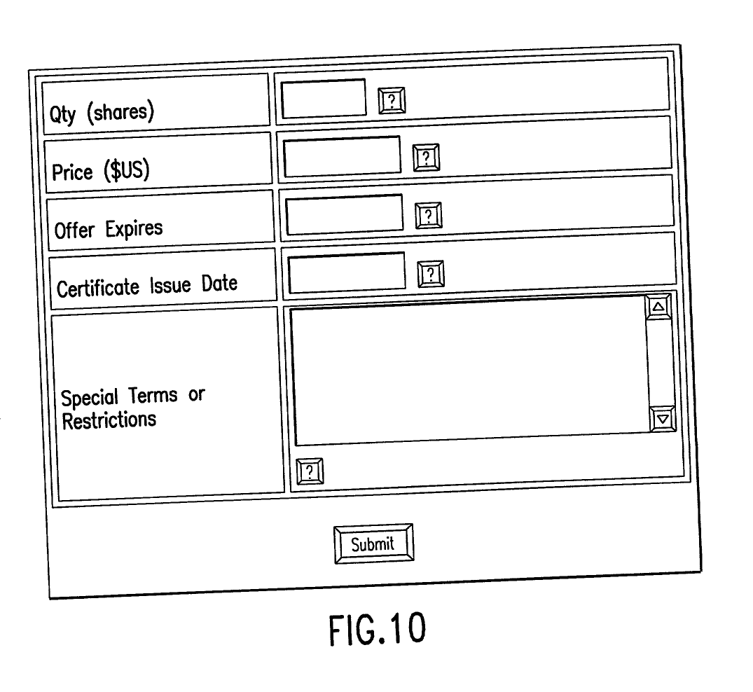

The code of LISTING 1 can be read and parsed using methods well-known to those skilled in the art to generate the HTML code with embedded server-script scripts. LISTING 2 (shown below) presents an example with embedded php script (contained within the start tag “<php?” and the end tag “?>”). Variables read from the database record begin with “$”. The code of LISTING 2 is included in a server-side script php file using the INCLUDE(“filename”) statement. The php file is rendered by a web browser as shown in FIG. 10.

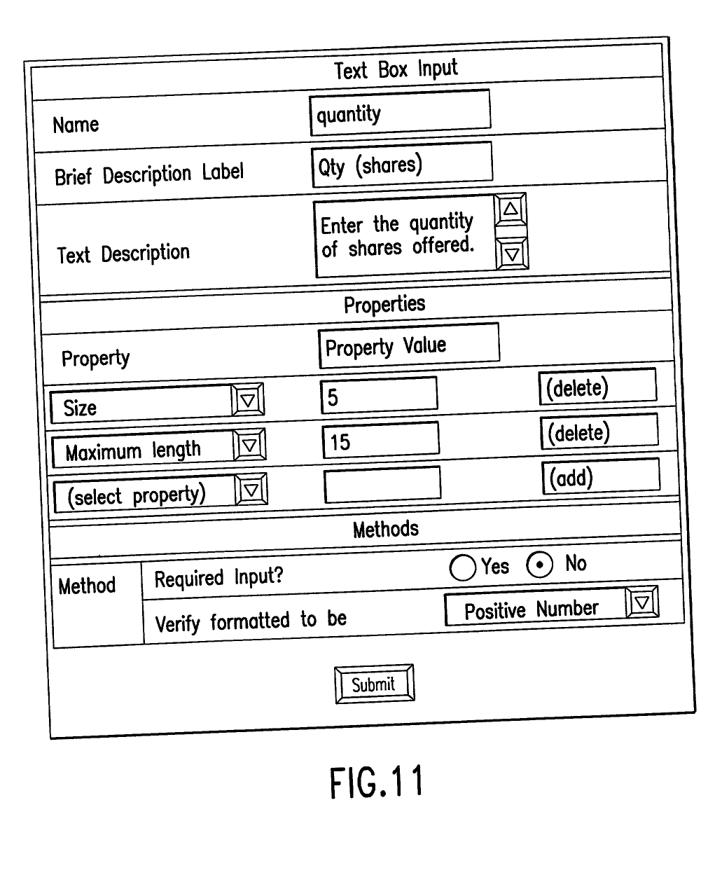

The code of LISTING 1 can additionally be read and parsed whereby the labels and names of the variables are editable text fields in the HTML form. An example of this as rendered by a web browser is shown in FIG. 11. For the example of FIG. 11, only the form element QUANTITY has been shown. This illustrates how a Member can edit or create an SDF for any security.

```
------------------------------------------------------------------------------------------
LISTING 2 - PHP3/HTML CODE FRAGMENT
------------------------------------------------------------------------------------------
<FORM>
  <TABLE WIDTH=“400” BORDER=“1”>
  <TR>
    <TD WIDTH=“133”>Qty (shares) </TD>
    <TD WIDTH=“20l”><INPUT TYPE=“TEXT” NAME=“quantity”
    <?php ECHO value=“$quantity” ?>
    SIZE=“5” MAXLENGTH=“15”>
    &nbsp;<IMG SRC=“question.gif”
    ALT=“Enter the quantity of shares offered.”
    WIDTH=“9” HEIGHT=“10”>
    </TD>
  </TR>
  <TR>
    <TD WIDTH=“133”>Price ($U.S.)</TD>
    <TD WIDTH=“201”><INPUT TYPE=“TEXT” NAME=“price”
    <?php ECHO value=“$price” ?>
    SIZE=“10” MAXLENGTH=“15”>
    &nbsp;<IMG SRC=“question.gif”
    ALT=“Enter the price per share.”
    WIDTH=“9” HEIGHT=“10”>
    </TD>
  </TR>
  <TR>
    <TD WIDTH=“133”>Offers Expires</TD>
    <TD WIDTH=“201”><INPUT TYPE=“TEXT”
    NAME=“expiration_date”
    <?php ECHO value=“$expiration_date” ?>
    SIZE=“10” MAXLENGTH=“15”>
    &nbsp;<IMG SRC=“question.gif”
    ALT=“Date the offer will automatically expire.”
    WIDTH=“9” HEIGHT=“10”>
    </TD>
  </TR>
  <TR>
    <TD WIDTH=“133”>Certificate Issue Date</TD>
    <TD WIDTH=“201”><INPUT TYPE=“TEXT
    NAME=“certificate_issue_date”
    <?php ECHO value=“$certificate_issue_date” ?>
    SIZE=“10” MAXLENGTH=“15”>
    &nbsp;<IMG SRC=“question.gif”
    ALT=“Enter the date that the certificate was acquired.
    This is generally the date when payment was made or other
    consideration tendered for the certificate.”
    WIDTH=“9” HEIGHT=“10”>
    </TD>
  </TR>
  <TR>
    <TD WIDTH=“133”>Special Terms or Restrictions</TD>
    <TD WIDTH=“201”><TEXTAREA NAME=“special_terms”
    <?php ECHO value=“$special_terms” ?>
    COLS=“30” ROWS=“5”></TEXTAREA>
    <IMG SRC=“question.gif”
    ALT=“Enter any special terms for the transaction
    or any restrictions on transfer.”
    WIDTH=“9” HEIGHT=“10”>
    </TD>
  </TR>
  </TABLE>
  <P><INPUT TYPE=“SUBMIT” NAME=“Submit”
  VALUE=“Submit”></P>
</FORM>
------------------------------------------------------------------------------------------
```

Thus, the SDF enables any Member, subject to eligibility and access restrictions, to post any security, or any tangible or intangible asset, in an organized manner on a preferred embodiment of the system.

Identifying the Issuer

The Member first provides information to help uniquely identify the Issuer. An example of an HTML form to collect Issuer information is shown in FIG. 12. The information collected can include one or more items such as Issuer name, Internet domain name, taxpayer ID, physical address, telephone number, country of domicile, whether the Issuer is private or a public reporting company, and so on. The Member may also identify the Issuer by providing details about one of the Issuer's securities, if available, such as ticker symbol, exchange or identifying code such as CUSIP or ISIN. This information is submitted to the System's host computer to search the Issuer database. Matches (if any) and near matches are presented in a list for the Member to select the correct Issuer. The list is in the form of hyperlinks to System pages (“Issuer pages”), where each page displays the complete Issuer information in the System database. The Member is also provided a form and hyperlinks to search other online company databases. Examples of online company databases include the SEC EDGAR securities filing database, online “yellow pages” directories, and online business databases such as those maintained by Hoover's, Dun and Bradstreet, and Internet search engines.

If the Member successfully identifies the Issuer in the System database using the above tools, the Member can proceed to the step of providing a description of the security and the indicated offer. If not, the Member has the opportunity to electronically submit the data to the host computer network add a new Issuer to the System database. When a new Issuer is added to the System database, the System will automatically generate a base “ticker symbol” for the Issuer, derived from the name of the Issuer. The ticker symbols for new Issuers are 6 characters long, and are created by taking the first two characters of the first 3 words in the Company name, or the first four characters of the first word and 2 characters of the second (for an Issuer with a two word name), or first six characters (for an Issuer with a one word name). The word “The” is ignored in the Issuer name for the purposes of generating a ticker symbol. The first letter of each word is capitalized in the ticker; others are lower case. If this process does not result in a unique name, the final character of the proposed ticker is sequentially replaced with a digit (1-9) until a unique ticker is obtained. If this still does not result in a unique ticker symbol, the next to last character is replaced with a digit, and so on, until a unique ticker is derived for the Issuer. The new ticker is added to the Issuer information in the System database.

Providing Details about the Security and Offer

For this discussion of posting a new listing, the example will be used for posting a restricted common stock from “ZXZX Corporation,” a private company that has not previously been listed. The Member logs in to the System web site, and after searching the System database and any external databases, finds that ZXZX Corporation is not yet in the System database. The Member provides the information regarding ZXZX and submits this to the host computer System. The System will only accept new Issuer listings from Qualified and Institutional Members, since Associate Members do not have access to the Member Market area for trading private Issuer securities. The unique ticker ZxzxCo is generated. The data ZXZX Corporation are written to the System database, and the Member can provide details of the restricted common stock to trade.

The next step, after the Issuer has been identified, is for the Member to provide the details about the security and the desired terms of the trade. First he enters information on the type of offer the Member is making (e.g., Buy, Sell, Swap, Hypothecate). For clarity and not by way of limitation, indicated offers from holders of a security to transfer an ownership interest will be called “Ask” (or “Indicated Ask”) offers herein, with the conventional meaning that the Member has posted an asking price for sale of the security. Indicated offers to exchange funds to acquire an interest in a security (purchase, loan finds with security as collateral, etc) will for clarity and not by way of limitation, be referred to as “Bid” (or “Indicated Bid”) offers. Selection of the type of security determines the SDF used to generate the input form.

This information is submitted to the server and the server generates the form from the SDF and transmits it for display and data entry on the Member's workstation.

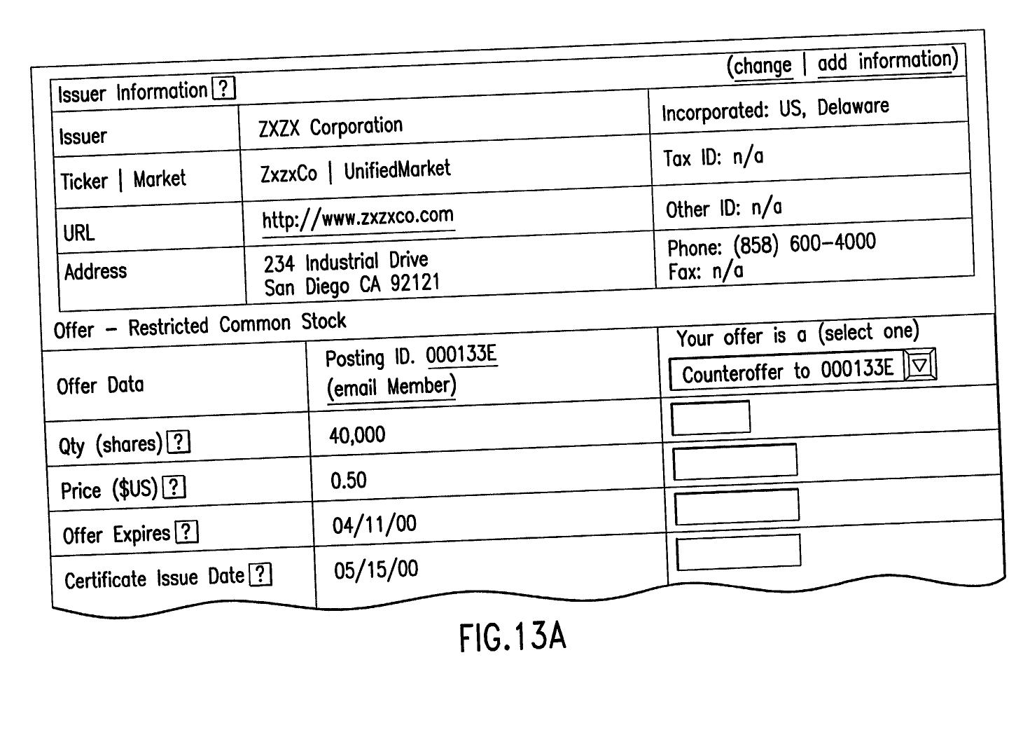

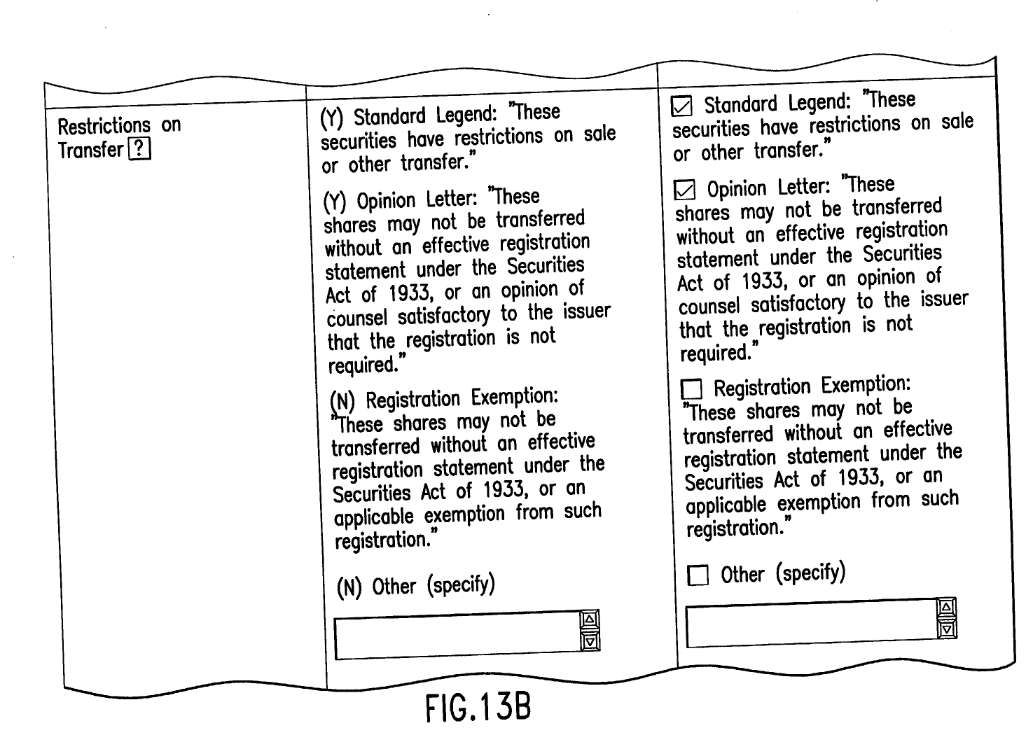

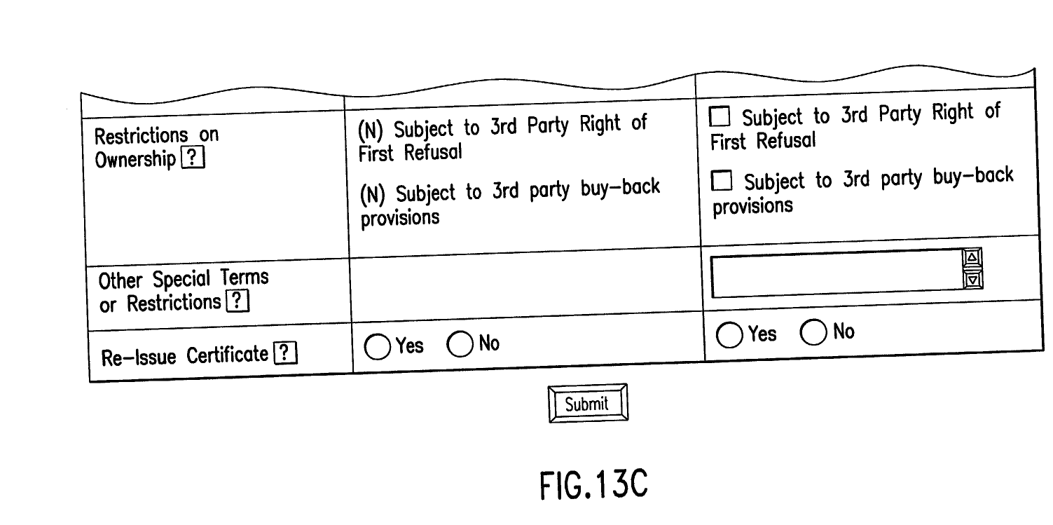

FIG. 13 presents a screen shot of the form to list a restricted common stock. For most on-line securities-trading systems, the minimum data to provide would be price per unit of the security, maximum quantity offered, minimum (smallest acceptable) quantity to sell, and offer expiration date. On the system of a preferred embodiment of the subject invention, these inputs are requested but none are required for listing.

As shown in FIG. 13, the Member posting an “Ask” offer for his restricted stock must provide information related to the restrictions on transfer and ownership. One important item of information is the certificate issue date, which is relevant in determining (a) the subsequent holding period, if any, required of the Buyer, and (b) whether the Seller might be construed to be engaging in a securities distribution and thus acting as an underwriter. For a restricted security, this information is required; for a freely traded security this information is not necessary.

Continuing with the example for the restricted common stock, the Member must indicate restrictions on transfer of the certificate. The Member may select the type of restrictions indicated on the legend on the certificate or on separate documentation to the certificate:

Standard Legend: “These securities have restrictions on sale or other transfer.”

Opinion Letter: “These shares may not be transferred without an effective registration statement under the Securities Act of 1933, or an opinion of counsel satisfactory to the Issuer that the registration is not required.”

Registration Exemption: “These shares may not be transferred without an effective registration statement under the Securities Act of 1933, or an applicable exemption from such registration.”

Other (specify): The Member may enter the actual text or a summary of the legends on the back of the certificate.

If there are restrictions on ownership, the Member may indicate this by checkboxes indicating standard types of restrictions, including buy-back provisions, right of first refusal, and others, plus a text box to enter a description of the restrictions on ownership.

The Member has the option of specifying a preference for a specific escrow facility. Each linked escrow facility provides its schedule of fees and an example of its standardized escrow agreement via hyperlink for the Member to review. The Posting Member has the option of proceeding to open Escrow, depositing her certificates, and requesting verification by the transfer agent that the certificate represented by facsimile copy is “validly issued, outstanding and non-assessable on the books of the Issuer.”

Transfer of Record

The Posting Member may specify her preference, if any, for whether the security is transferred on the records of the Issuer. If no transfer of record is desired, the Member must specify her preference on directing Escrow to report any completed transaction to the System.

The Posting Member must affirm her eligibility to sell the security, and disclose whether she is an affiliate or control person for the Issuer.

If the Member is a PAC Institutional Member, the security detail form also allows the Member to specify whether the offer should be listed in the Member Market or the Institutional Market, or both. Alternatively, the Member may set up a Private Market for the offer, using the System Access Manager.

After the details of the offer have been entered, submitted to the System server, and validated for form and content, the Member is sent a page displaying the offer and input fields for her password to make a final positive confirmation of the offer. The offer is confirmed and written to the System database if the correct password is entered, and the data are again validated. Once confirmed, the offer is immediately visible to other Members who access the specified Market for the offer.

Trade Records

Records of previous postings that resulted in trading activity are recorded by the System and are available to Members. The records can be accessed by clicking on the “Records” hyperlink on the Issuer page.

Two types of records are available. The first type is a completed transaction that the transacting parties have authorized the settlement facility to confidentially report back to the System. These records disclose transaction date, security type, price, and quantity. No information identifying the transacting Members is provided.

The second type of record is comprised of “Bid” and “Ask” pairs that proceeded all the way to “Trade” status on the System. For these records, the actual settlement price either has not yet been or will not be reported back to the System. The “Bid-Ask” record provides the date that the posting converted to “Trade” status and security type. Bid price and quantity and Ask price and quantity are reported if these data were included in the listings.

Negotiation

A Member may submit an offer to conduct a securities transaction by contacting one or more potential trading partners through hyperlinks on the Markets, Trading Floors and Issuer Pages. Contact messages are transmitted using a secure, encrypted, internal messaging protocol implemented on the System. This communication from the Member invites the other, contacted party to engage in negotiations, either through the communications network provided by the System or offline by telephone, fax, or other means. (The remainder of this description assumes that the parties decide not to use offline communications, but instead utilize the communications and electronic transaction support services available through the System.)

In a preferred embodiment, the Buyer and Seller can use email or the structured counteroffer form of FIG. 13 to negotiate the terms of a transaction. When terms of a trade have been agreed upon, the Members each complete an online Deal Window. The Deal Window is an HTML form designed to capture the material terms and conditions of the transaction in digital format in order to facilitate the preparation and execution of other documents necessary or deemed desirable by the parties to consummate the trade. An example of the material terms of the transaction that must be entered in the Deal Window by the Seller for a Restricted Stock transaction are presented in LISTING 3. The material terms entered in the Deal Window by the Buyer are presented in LISTING 4.

Listing 3—Seller Data For Escrow Agreement

Seller Information:

1. Name:

Address:

Telephone:

Fax:

E-mail:

Wire transfer information:

Bank/Institution Name:

Routing No.:

Account No.:

Account Name:

Title and Number of Securities to be Sold:

Title: _______ Number of Securities: ______

Purchase Price of Securities to be Sold:

Currency: ______ Amount: ______

Transfer Agent Information:

1. Name:

Address:

Telephone:

Fax:

E-mail:

E. Other Instructions to Escrow Holder:

Listing 4—Buyer Data for Escrow Agreement

A. Buyer Information:

Name:

Address:

Telephone:

Fax:

E-mail:

Wire Transfer Information:

Bank/Institution Name:

Routing No.:

Account No.:

Account Name:

B. Title and Number of Securities to be Sold:

Title: ______ Number of Securities: ______

C. Purchase Price of Securities to be Purchased:

Currency: ______ Amount: ______

D. Registration Instructions:

The Securities are to be evidenced by a total ______ of New Certificate(s) registered as follows:

Certificates

No. of Shares

Registration

1. ______

2. ______

3. ______

4. ______

5. *______

E. Other Instructions to Escrow Holder:

* Use same format on additional page if more than 5 New Certificates required.

In a preferred embodiment, if Members choose to transact, they are provided with the ability, through a “mailto: ” hyperlink on their Confirmation Page, to directly deliver their transaction and confirmation information to each other, their back office, or other settlement personnel, if any, at their respective e-mail address, without using the servers of the System to route the message. The mailto: hyperlink is implemented using well-known CSS methods familiar to those skilled in the art, and can be configured to automatically include the recipient(s) email address(es), cc, subject, and body of the email message. The body preferably contains the transaction information and can be in any format that can be transmitted by email, including formatting such as plain text, HTML, RTF, XML and hyperlinks. The communications are processed like ordinary public server-type email originating at one Member's computer and transmitted by normal e-mail methods to the other Member's computer.

In a further preferred embodiment, the transacting parties may, at their sole discretion, select a settlement services provider and transmit information specifying the material terms of their transaction. The settlement services provider utilizes standard electronic form, word processor, and database application interfaces so that information contained in the Deal Window's fields can be seamlessly transmitted and integrated into escrow agreements and other third-party document forms supporting the same standards. In a further preferred embodiment, the escrow agreements and other documents are encrypted and secured with a digital signature and key-pair codes are assigned and used to confirm document authenticity and to prevent subsequent alteration.

Members trading in restricted securities have the option of conducting nearly all aspects of their transactions online using the secure communications and electronic document digital signature and authentication capabilities of the System or, alternatively, relying on the physical exchange of printed documents and other means. The System operators make the System's standard electronic document interface specifications and encryption and authentication available to third-party settlement service providers engaged by Members. These actions do not compromise the integrity and security of communications or documents transmitted over the System's network.

Execution of transactions between Members is facilitated by the System through the assistance of settlement facilities such as escrow holders. For the purposes of this discussion and not by way of limitation, the discussion below assumes that, in a preferred embodiment, Member Market transaction settlement is performed by escrow holders, and Institutional Market transaction by the PAC Members are cleared through accounts with securities clearing firms.

Escrow Settlement

In a preferred embodiment, transactions are not settled using the System. The following discussion describes a preferred method for the escrow settlement of a transaction in a restricted security.

After data contained in a Deal Window form completed by the trading Members is transmitted over a secure network connection in encrypted form to an escrow holder, the escrow holder integrates the received Deal Window data into two identical counterparts of its standard form Escrow Agreement. In a further preferred embodiment, the Escrow Agreements are written in read-only Adobe portable document format (PDF), providing a first level of protection against unauthorized alteration. In addition, a unique digital signature is affixed to each counterpart Escrow Agreement. One uniquely signed counterpart is returned by electronic transmission to each trading Member through the Trading Room network.

Trading Members then review the received Escrow Agreements and evidence their acceptance by affixing signatures to their documents and delivering them by facsimile transmission to the escrow holder. In a further preferred embodiment, the Trading Members sign the Escrow Agreement by affixing their digital signatures to their respective documents and returning them by electronic transmission to the escrow holder. Upon the escrow holder's receipt of the counterparts from both of the Trading Members, the escrow holder delivers fully executed, signed copies of the Escrow Agreement to the Trading Members by facsimile, courier, or electronic transmission.

Within a prescribed period after delivery of the signed counterpart by the Seller, the Seller delivers to the escrow holder:

(1) By overnight courier, the certificate(s) evidencing the subject securities (the “Certificate”) to the escrow holder, along with duly executed instruments of transfer or assignment in blank with signatures guaranteed by a bank or trust company in a form specified by the Escrow Agreement. For example, this may be a medallion signature guarantee if the Company exists under the laws of the United States or any State thereof, or an equivalent authentication as generally used for the transfer of securities in the jurisdiction under which the Company exists if other than the United States or any State thereof. If required by the terms of the Escrow Agreement, the selling Member causes the issuance and delivery to the escrow holder of a bond or insurance policy to guarantee the authenticity of the Certificate and the validity of the Seller's endorsement (“Guaranty”).

(2) By facsimile, overnight courier, or electronic mail, information about the Issuer including the name, address, telephone number and electronic mail address of (a) the Issuer, (b) the Company personnel responsible for registering the transfer of the Securities on the records of the Issuer (“Company Officer”), and (c) any agent appointed by the Issuer to administer or transfer the Securities (“Transfer Agent”).

(3) By facsimile, overnight courier, or electronic mail, information for any wire transfer of funds to the Seller, including (i) name of financial institution; (ii) routing number; (iii) account number; and (iv) account name.

(4) The escrow fee, by wire transfer or other method acceptable to the escrow holder. Within a prescribed period after delivery of the signed counterpart by the Buyer, the Buyer delivers to the escrow holder:

(a) The purchase price of the Securities, by wire transfer or other method acceptable to the escrow holder.

(b) By facsimile, overnight courier, or electronic mail, instructions for registration of the Securities to be purchased by the Buyer, including the number of new certificates and the number of shares and registrant for each certificate.

(c) By facsimile, overnight courier, or electronic mail, information for any wire transfer of funds to the Seller, including (i) name of financial institution; (ii) routing number; (iii) account number; and (iv) account name.

The escrow holder sends to the Seller confirmation of receipt of the Certificates, when received. The escrow holder sends to the Buyer confirmation of receipt of the purchase funds, when received.

Within a prescribed period, such as two business days after the completion of performances by the Buyer and Seller under the Escrow Agreement, the escrow holder notifies the Company Officer or Transfer Agent, as the case may be, by facsimile or electronic mail message (“Transfer Procedure Request”) of the impending transfer of securities under the Escrow Agreement. This Transfer Procedure Request will include:

(1) a request for information concerning requirements for transfer of the Securities on the transfer records of the Company in accordance with the Registration Instructions (the “Company Transfer Procedure”);

(2) a copy of the Escrow Agreement with the purchase price deleted;

(3) a copy of the Seller's Certificate(s) and instruments of transfer or assignment in the form received by Escrow Holder from Seller; and

(4) a copy of the Buyer's registration instructions.

Within a prescribed period, such as within one business day of its receipt of the Company Transfer Procedure, Escrow Holder shall provide a copy to Buyer and Seller via electronic mail or facsimile transmission. The Buyer and Seller then provide as soon as possible the additional information, materials, and documentation required by the Company Transfer Procedure.

Immediately upon its receipt of the materials, if any, required for compliance with the Company Transfer Procedure, Escrow Holder forwards the Seller's Certificate(s) and the instruments of transfer or assignment completed in accordance with the Buyers registration instructions and the other required materials, if any, to the Company or the Transfer Agent as prescribed in the Company Transfer Procedure. The Escrow Holder instructions direct the Company to deliver to the Escrow Holder by return courier: (i) certificate(s) evidencing the Securities registered in accordance with the Registration Instructions (the “New Certificates”); and (ii) a representation executed by the Company Officer (the “Company Officer Representation”), certifying that:

(1) the Company Officer is a duly qualified, elected officer of the Issuer;

(2) The Issuer is a corporation duly organized, validly existing and in good standing with full power and authority to conduct its business as it is now being conducted;

(3) the Securities are validly issued and outstanding and are fully paid and non-assessable; and

(4) the transfer of the Securities from Seller to Buyer has been recorded in the stock transfer records of the Company, the Seller's Certificate(s) has/have been canceled and the New Certificate(s) has/have been issued by the Company in accordance with the Buyers registration instructions.

The purchase and sale of the Securities (the “Closing”) then takes place via courier and by confirmed wire transfer of funds as soon as practicable following delivery by the Company to the Escrow Holder of the New Certificates and the Company Officer Certificate. At the Closing the Escrow Holder (i) delivers to Buyer the New Certificate(s) and the Company Officer Certificate by courier; and (ii) delivers the Purchase Price, less any amount withheld for outstanding fees pursuant to the Escrow Agreement, to Seller by confirmed wire transfer.

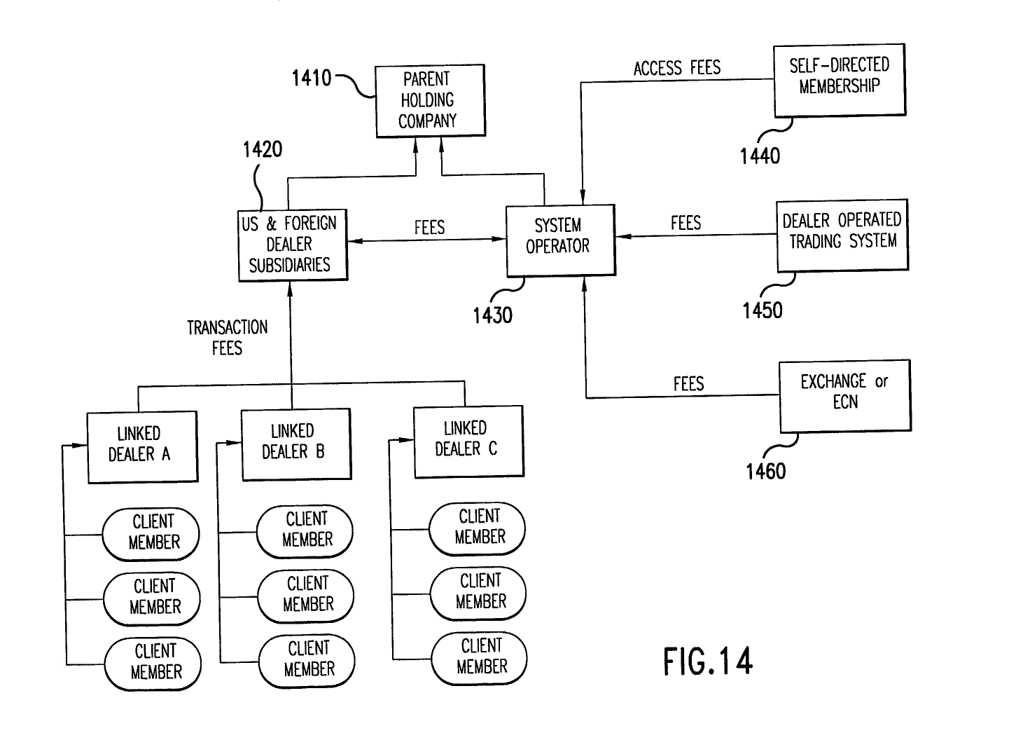

In a second preferred embodiment (see FIG. 14), the preferred System is operated as follows: A parent holding company 1410, through its operating subsidiaries and/or affiliates, receives revenues from a variety of sources, including flat-rate, time-based fees paid by Members for access to System services (“Membership Fees”) and from transaction referral fees paid by linked independent securities dealers to a subsidiary 1420.

Subsidiary 1420 is preferably an independently-operated NASD member firm, or other securities dealer wherever domiciled that is duly licensed by and operating under appropriate governmental authority. Subsidiary 1420 preferably does not have retail client accounts or handle client funds, and does not act as a principal broker in Member transactions; however, such operating parameters are subject from time to time to alteration based upon changing legal, market and industry standards. Subsidiary 1420 also contracts with the System Operator (subsidiary 1430) to control and supervise those areas of the System that appropriately require the control and supervision of a licensed securities dealer.

All of the various operations of the preferred System are preferably carried out by additional subsidiaries and affiliates of parent holding company 1410. The corporate structure depicted in FIG. 14 displays some of a preferred national and worldwide network of subsidiaries and affiliates that serve the Members.

Independent securities dealers that provide transaction representation and/or settlement services to Members are linked to subsidiary 1430 and to subsidiary 1420 and are the principal brokers in all Member transactions that involve a securities dealer. These linked dealers preferably each have a standardized contract with subsidiary 1420 that includes their agreement to pay referral fees to subsidiary 1420 for all Member transactions resulting from posting of securities on the System. The linked dealers may anonymously register their clients as Members with subsidiaries 1430 and 1420. The linked dealers are exclusively and continuously responsible for determining (and so representing to subsidiaries 1430 and 1420) that their registered clients meet all relevant System membership criteria established by subsidiary 1430, as well as for determining, as the principal broker in each transaction, all investor suitability issues.

The preferred System does not charge Membership Fees for dealer-registered Members and does not charge linkage or other access fees to securities dealers, banks, and other licensed professionals that provide transaction advice and/or representation and/or settlement services to Members for transactions involving securities posted on the System.

Each Member may elect not to access System services through registration by a securities dealer, and may alternatively elect to become a member of Self-Directed Membership 1440 and pay a flat-rate, time-based Membership Fee to the System Operator (subsidiary 1430), which fee allows full access to all System information, links and services. Institutional Members preferably pay significantly higher Membership Fees than non-institutional Members, due to the System Operator's correspondingly higher costs of providing a greater variety of transaction and other services to institutional members. Each Member elects from time to time to either pay a flat rate, time-based, non-contingent access fee to subsidiary 1430, or, if a Member is registered on the System by and through a linked securities dealer, that Member and the securities dealer agree to the securities dealer's direct payment of contingent, transaction-based fees to subsidiary 1420.

If a securities transaction results from a member posting on the System, and that transaction is subject to payment of transaction-based referral fees to subsidiary 1420 by a linked, independent securities dealer and/or other government-licensed entity that acts as the principal dealer and/or settlement services facility in that transaction, then subsidiary 1420 will be deemed to be an introducing dealer for that transaction and is subject to regulatory supervision as a securities dealer. However, if a member transaction does not involve participation by a linked dealer or government-licensed entity, then there are no transaction referral fees paid to subsidiary 1420 and therefore no dealer activities involved in the transaction.

The primary criteria involved in determining whether securities dealer activity is involved in any securities transaction that results from a posting on the system are related to whether an intermediary has (1) introduced the parties, (2) “effected” the transaction, or (3) received transaction-based fees. The preferred System does not introduce the Members to each other, but instead merely provides a communication medium and website that enables Members to make their own introductions, post their own choice of information about their securities on the website, conduct their own private negotiations, and to link, through the website, to relevant sources of financial information, professional advice, and transaction services, all on their own initiative and responsibility.

Although the preferred System passively facilitates confidential Member communications and the exchange of financial information, and provides optional tools for transaction negotiations and links to professional advice and transaction services providers, neither parent 1410 nor subsidiaries 1420 or 1430, or any other subsidiary or affiliate of parent 1410, solicits members to engage in any securities transaction, introduces the members to each other, or effects any Member transactions.

The status and role of subsidiary 1420 as a securities dealer subsidiary enables the System to provide increased operational flexibilities and efficiencies, resulting in a greater variety of securities that can be posted for purchase or sale on the System, greater offer distribution and transparency for those offers, and potentially lower Member transaction costs and enhanced liquidity.

The third preferred embodiment of the present invention comprises a System that includes primarily the same operating characteristics, parameters, and methodologies of the first and second preferred embodiments described above. However, in this third embodiment, one or more portions of the System are operated by an affiliate or subsidiary 1460 (see FIG. 14) that is a government licensed exchange, or by an affiliate or subsidiary 1450 that is a securities dealer registered to operate an Alternative Trading System (ATS) in the U.S., or registered to operate the equivalent or similar regulated trading entity in other countries. In this third embodiment, Members have the ability to post firm or non-firm public offers on the System, and the System Operator either imposes non-discretionary System rules for transaction settlements or provides for discretionary rules for transaction settlements, or any combination of these aforementioned System rules and operating characteristics, based upon type of posted security, type of membership, applicable laws and regulations, and other such criteria as selected by the System Operator.

A fourth preferred embodiment of the present invention comprises a system that includes primarily the same operating characteristics, parameters, and methodologies of the previous embodiments described above. However, in this fourth embodiment, the preferred system and method comprise software for displaying graphical interfaces that receive information from Members, transmit data comprising that information from the Member's computer to System servers, transmit data from the System servers to the Member's computer, and display information received from the System servers on the Member's monitor screen.

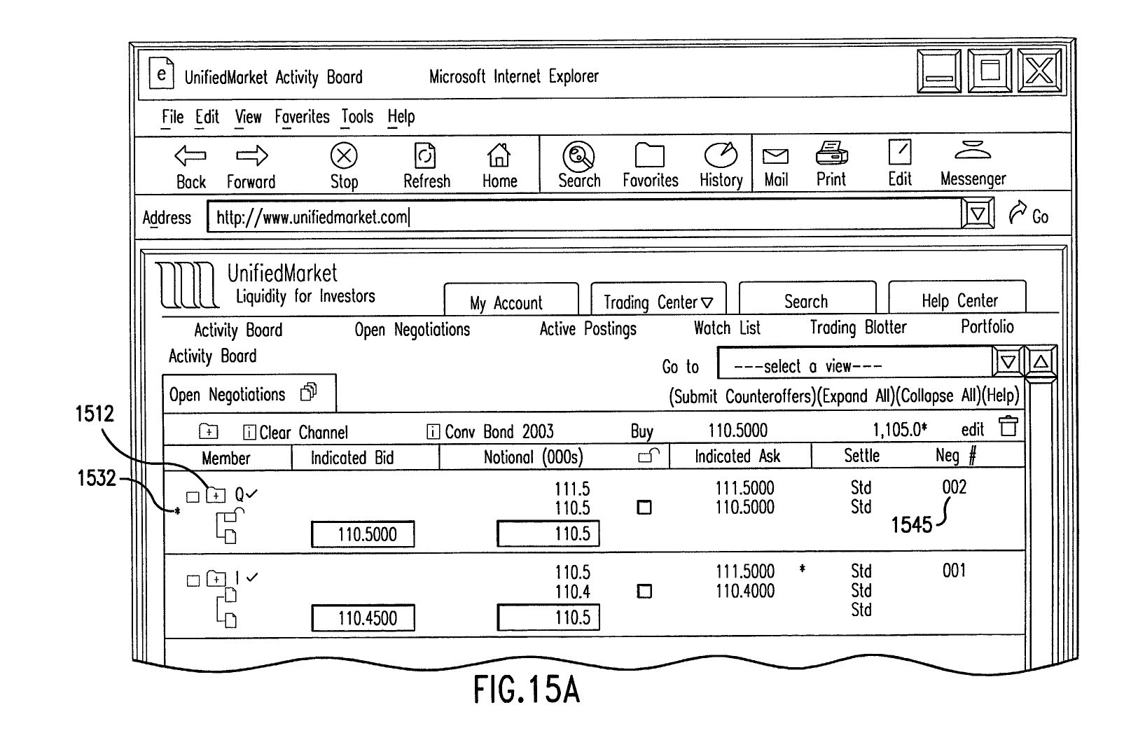

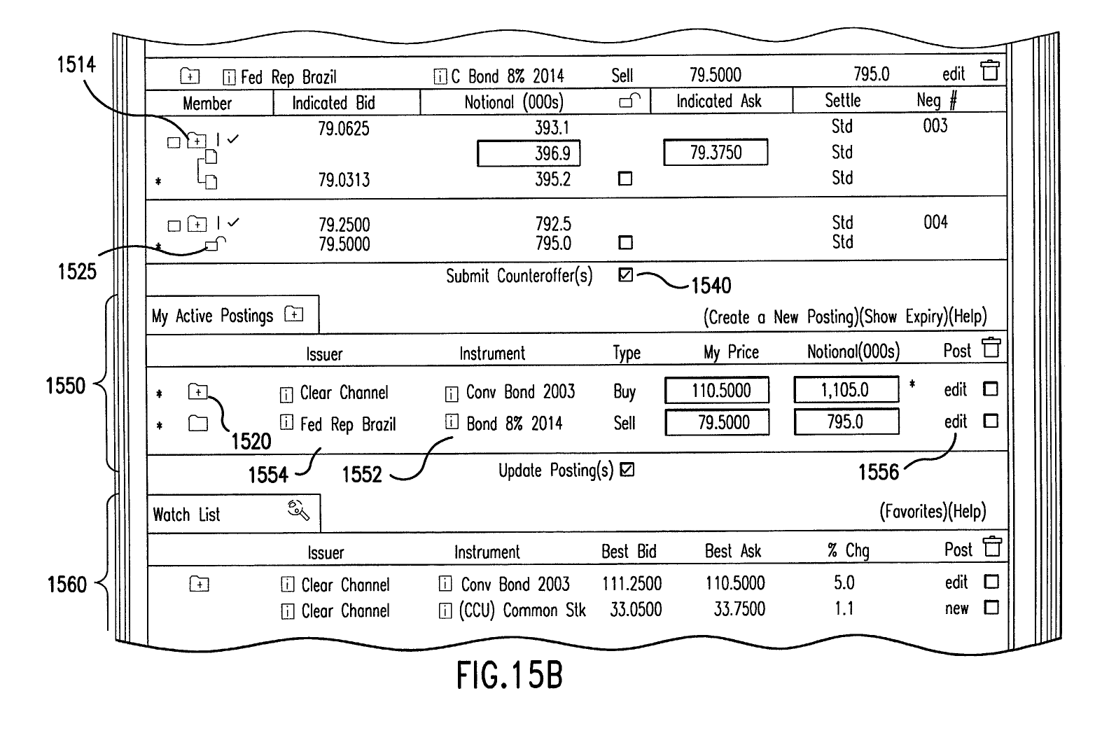

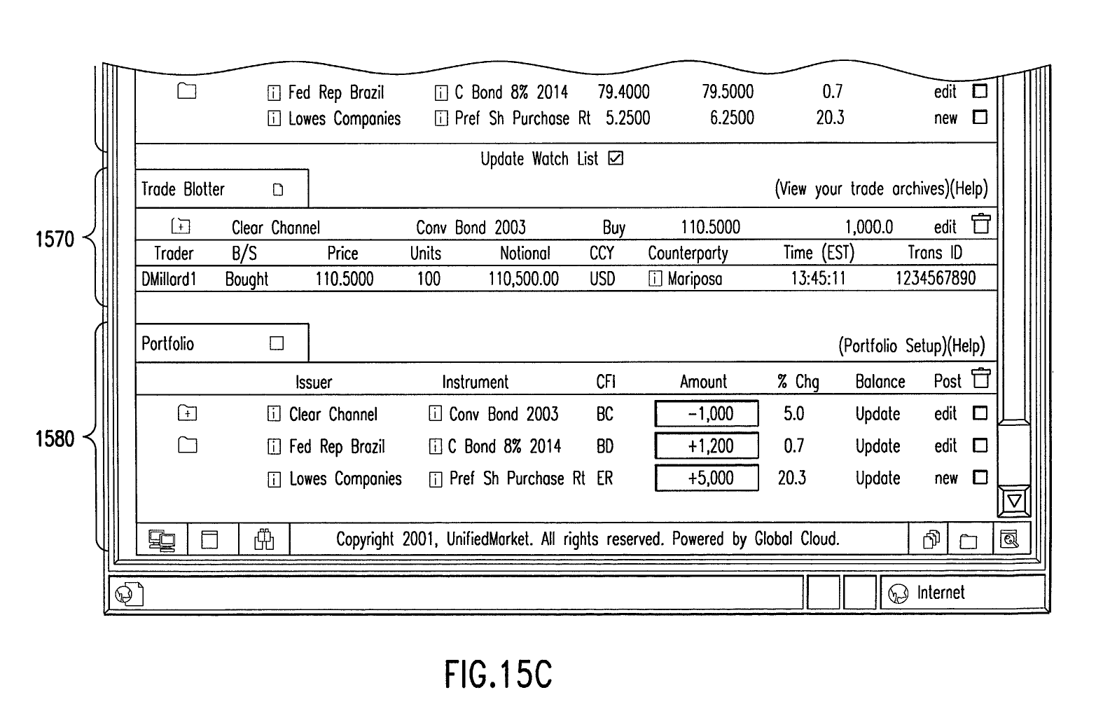

Preferred interfaces are depicted in FIGS. 15-21. FIG. 15 depicts an Activity Board, which acts as the nerve center of the System and as a personalized repository for each Member's trade activity information. This is also a jumping-off point to key areas of a preferred System Trading Platform, including initiation, modification, and cancellation of public postings and private Member-to-Member negotiations. The Activity Board preferably provides automatic updates of trade activity information and is seamlessly interfaced to all other areas of the website.

Each page of the Trading Platform preferably contains navigation hyperlinks at the top of the page and access to the major areas of the website through hyperlinked icons at the bottom of the page. The Member's trading status is displayed by way of standard “browser-pull” and “server-push” methods well-known to those skilled in the art.

The Activity Board preferably displays a Member's current, open negotiations. The methodology of organizing public offers and private negotiations is preferably implemented using a parent-child hierarchy. Public indicated bids and indicated asks are displayed as color-coded folder icons (e.g., 1512 and 1514), where red (as in icon 1512) signifies an indicated ask and green (as in icon 1514) signifies an indicated bid. A Member's own posting is identified by a diamond 1520 on the folder icon.

Private negotiations are indicated by color-coded document and/or an open lock icon 1525. A document represents a private negotiation. An open lock indicates that one Member has accepted the other Member's public or private offer, and is waiting on acceptance by the other Member. Private negotiations are displayed under the other Member's public offer.

Membership level, presence (whether the Member is currently logged in to the System), and availability for chat or instant messaging are displayed in a “Member” column. The Membership level is preferably hyperlinked to the Member's ranking in a System Feedback Bureau. Indicated Bid and Indicated Ask prices are displayed next to the corresponding folder, document or open lock. The amount of the Bid or Ask is indicated according to industry convention for the type of instrument—for example, “Quantity” for equities, Notional amount or Face Value for fixed income. Futures and Options may be displayed as number of contracts or options, or as the quantity of the underlying commodity or instrument, as would customary in trading markets for the instrument.

A Member can send and receive counteroffers from an Open Negotiations section 1530 of the Activity Board. The Member may click a document or open lock to display the Deal Window negotiation form (see FIG. 13 and LISTINGs 3 and 4 above) that displays the details of both Members' most recent offers, whether public or private.

A Member may directly edit his own counteroffers and/or may accept one or more Members' offers by checking a box and clicking on “Submit Counteroffer(s)” button 1540. The Member is prompted to confirm the acceptance. If the accepted amount exceeds the amount in the Member's public posting, the Member is prompted to either (a) increase their publicly posted amount or (b) revoke or suspend any acceptances that have not been acted on by other Members. In this way, Members can make firm private offers but retain the option of cancellation before the negotiation is completed.

A sequential negotiation (Neg #) number 1545 is assigned for each negotiation in progress, for example, 001, 002, and so on. This number does not identify the other Member, only the negotiation.

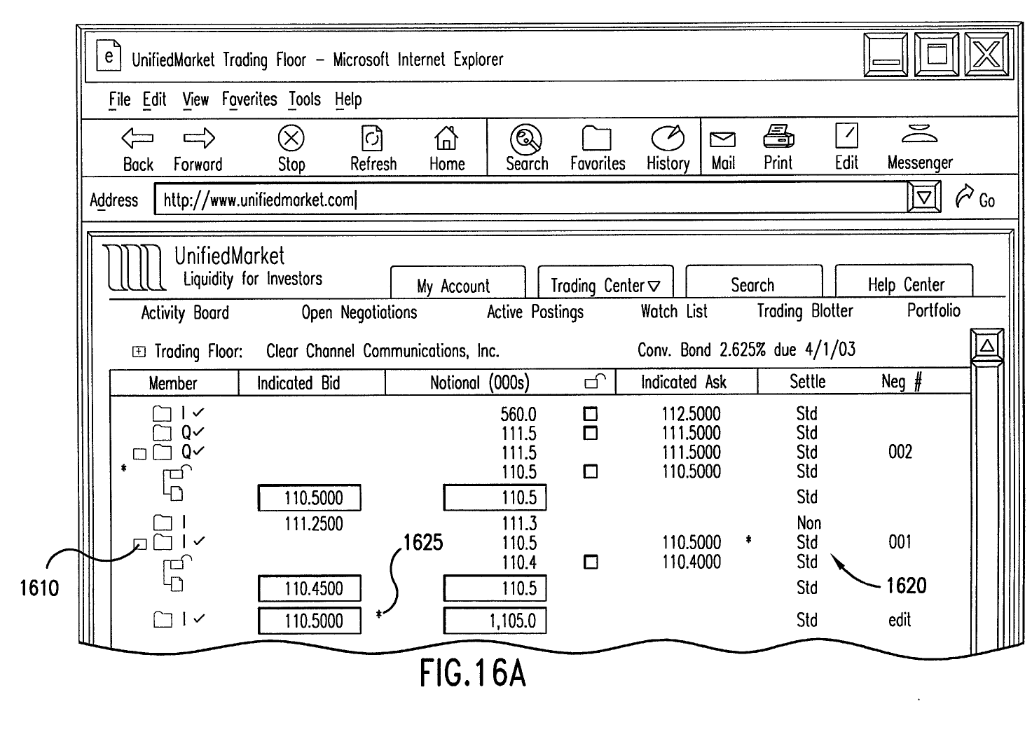

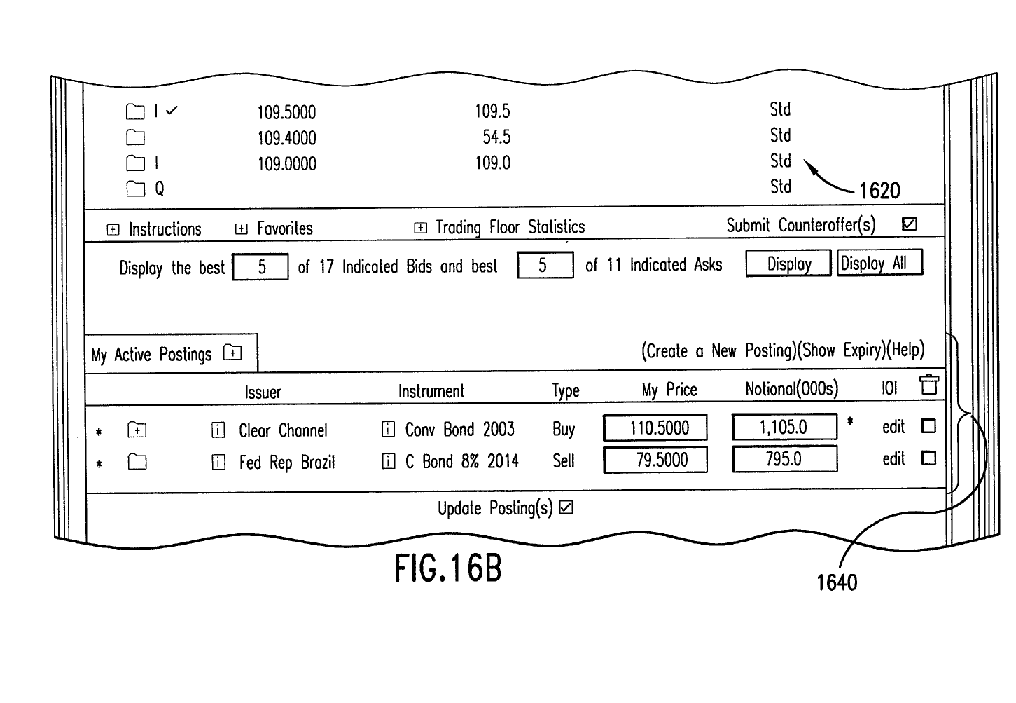

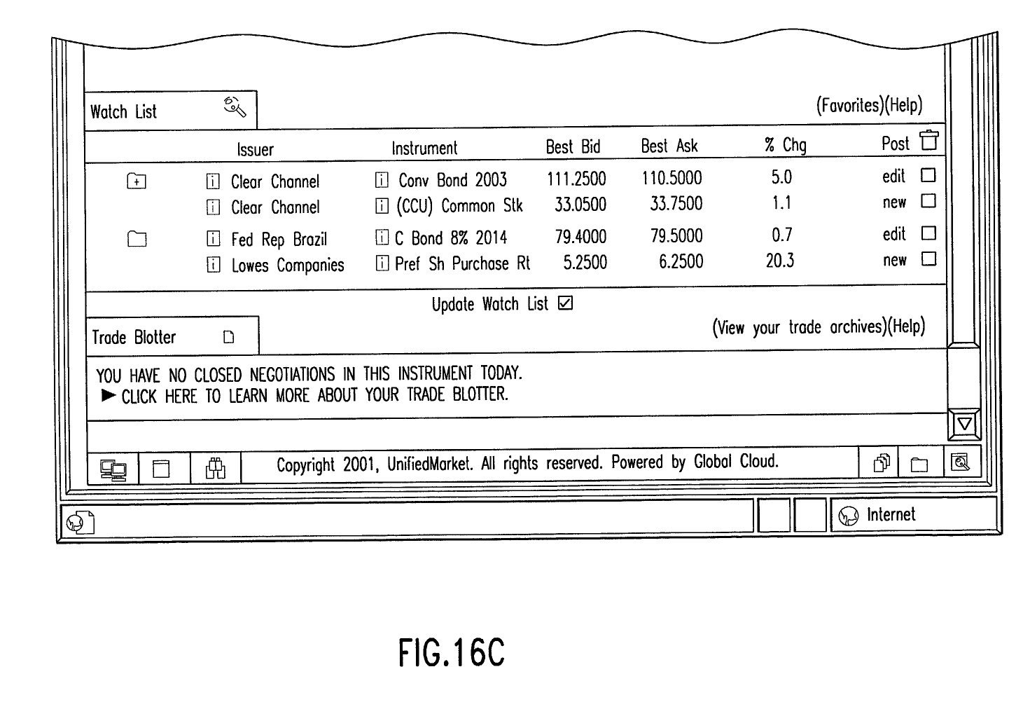

The Activity Board preferably displays a list 1550 of the Member's Active (public) Postings, and each Posting listed under Active Postings provides (1) a link 1552 to a Trading Floor display for the security (see FIG. 16), (2) a link 1554 to a detailed description of the security and issuer, and a link 1556 to a display to edit or delete that posting. A Member may edit prices and amounts directly on the display.

The Activity Board also preferably displays securities that are on the Member's Watch List. A Watch List display 1560 displays a list of the securities that the Member has selected to monitor price activity. If there is a change in the best publicly-posted indicated bid or ask, the Member is alerted by a star in the leftmost column of the Member's Watch List, in the same row as the description of the security. Preferably, for each security on a Watch List, the best indicated bid and best indicated ask are automatically periodically updated, as is the percent change in the average of the current best bid and ask compared to the most recent completed negotiation in that security on the System prior to 5:00 p.m. EST of the previous day. Securities can be readily added or deleted from a Member's Watch List from an Activity Board display. Each security description on a Watch List is hyperlinked to the Trading Floor for that security.

The Activity Board preferably displays the Member's trades on a Trade Blotter display 1570 that displays a summary of that Member's closed negotiations for that day. Each summary is hyperlinked to the full terms and to settlement documentation, if applicable. A Member's Trade Blotters for previous days are preferably accessible through the Member's account trade archives.

The Member's Portfolio positions are preferably displayed on the Activity Board in a Portfolio display 1580. The Member can specify their initial holdings and each position is automatically updated as negotiations are successfully completed through the System.

New activity is indicated by icons on the Activity Board. New private offers are indicated by a star 1532 next to the new offer on the Open Negotiations display 1530, and a star next to the Member's affected Posting under Active Postings. If a Member has a public or private offer that is nearing expiration, a yellow triangle with an exclamation point is displayed to indicate a warning. Offers sent to the Member that have subsequently been suspended or canceled are indicated by a red circle with a diagonal line. A preferred Activity Board updates as new activity occurs, ensuring immediate access to all of a Member's current transaction information. The alert icons call the Member's attention to the new information. The Member can act on that information, moving directly to the desired area of the website, such as the Trading Floor (discussed below) for Member postings of that security, or to obtain due diligence information about the security or its Issuer.

New activity is preferably also indicated by causing the corresponding icons at the lower right portion of the display to blink, and preferably to sound an audible tone. Open negotiation activity, including new or canceled private offers, is preferably indicated by icons showing three stacked documents. Changes in best public bid or ask or the imminent expiration of one or more of the Member's offers on a trading floor where a Member has an active posting, is indicated by a blinking icon of a folder with a diamond. A new Watch List alert, triggered by a change in the best public indicated bid or ask, is indicated by a blinking icon of a magnifying glass over a folder. This lower portion of the display is preferably visible on all pages, so a Member can be alerted to relevant new activity from any page in the System. Each page preferably contains links to help topics relevant to the content of that page.

A preferred Trading Floor display is depicted in FIG. 16. A Trading Floor display can be accessed for each security on the System. While the Activity Board shown in FIG. 15 is a nerve center for activity in a Member's account, the Trading Floor is where any single security of interest is posted and traded. Public and private postings are organized on the Trading Floor using the same parent child hierarchy as described above for the Activity Board. Public offers are indicated by folder icons. A Member's display only shows the private counteroffers directed to or sent by that Member. Each folder, document, or open lock is hyperlinked to a form with the fields and information for submitting a private counteroffer.

If a negotiation has been opened by the Member with another Member, this is indicated by a “plus” (+) icon next to a folder representing the other Member's public posting. Preferably, clicking on the plus shows the private counteroffers by using well-known methods for changing the visibility properties of an HTML layer, changing the display to a display of an open folder icon with a minus (−) icon 1610. Clicking on the minus icon hides the layer and displays a closed folder with a plus icon.

The Trading Floor display preferably provides a facility for submitting an acceptance of one or more public or private postings. The functionality of this is similar to that described for the Activity Board, except that a Member may also use this feature to make a non-binding, private acceptance of the terms of another Member's public posting. The other Member would need to accept that private acceptance to conclude the negotiation.

The Trading Floor preferably contains layers that may be displayed or hidden by clicking on a plus or minus icon, respectively. These layers contain details about the issuer and security, instructions on using the Trading Floor, the ability to add the security to the Member's Favorites (Watch List or Saved Trading Floors), or to access summary statistics about prior trading activity on that Trading Floor.

The Member can preferably customize the display of the Trading Floor by specifying the number of indicated bids or asks to display. The default is preferably 5 bids and 5 asks. Total numbers of active indicated bids and active indicated asks are displayed.

Postings that specify standard settlement terms are indicated by “Std” in a “Settle” column 1620; postings with non-standard settlement terms are indicated by “Non” in column 1620.

The displays of best indicated bid for a posting with standard terms and of best indicated ask for a posting with standard terms are each preferably appended with an asterisk 1625.

The Trading Floor preferably contains a list 1640 of the Member's Active Postings to facilitate rapid navigation between Trading Floors.

A preferred Trading Platform features strategic links to databases listing most recent Issues and Issuers, providing access to thousands of individual securities. This display is preferably combined with user-friendly search tools, as well as intuitive links to the Activity Board and Trading Floor displays, making transacting in diverse asset classes and Issuers fast and easy. Members can also customize their own securities, or combinations of securities, by defining their own terms, conditions, and restrictions.

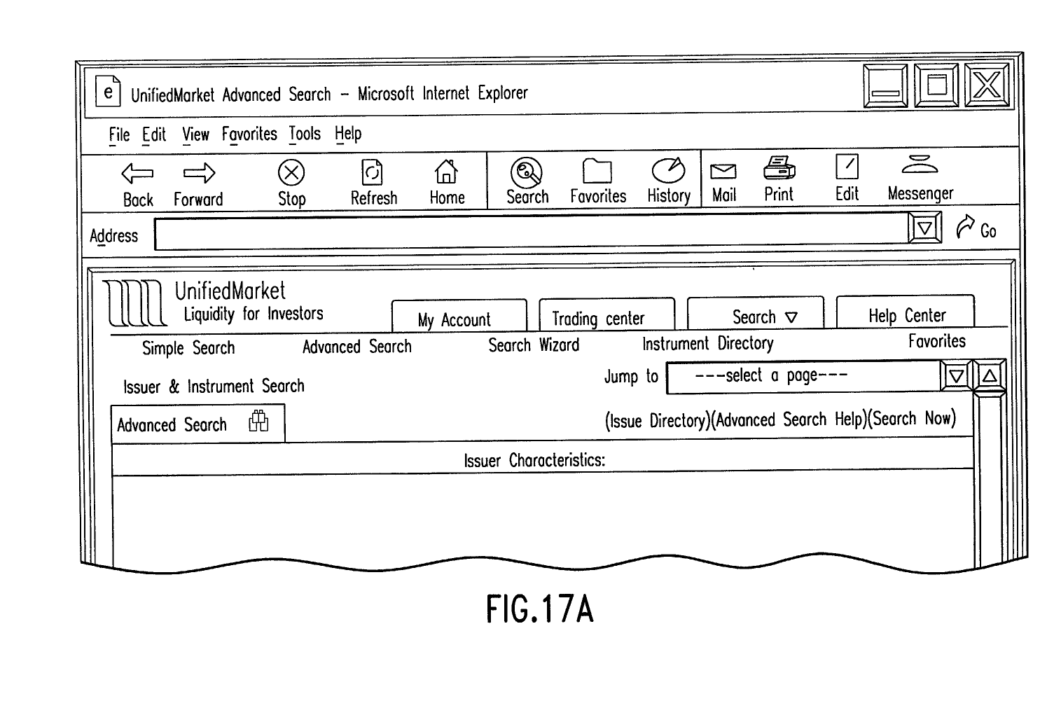

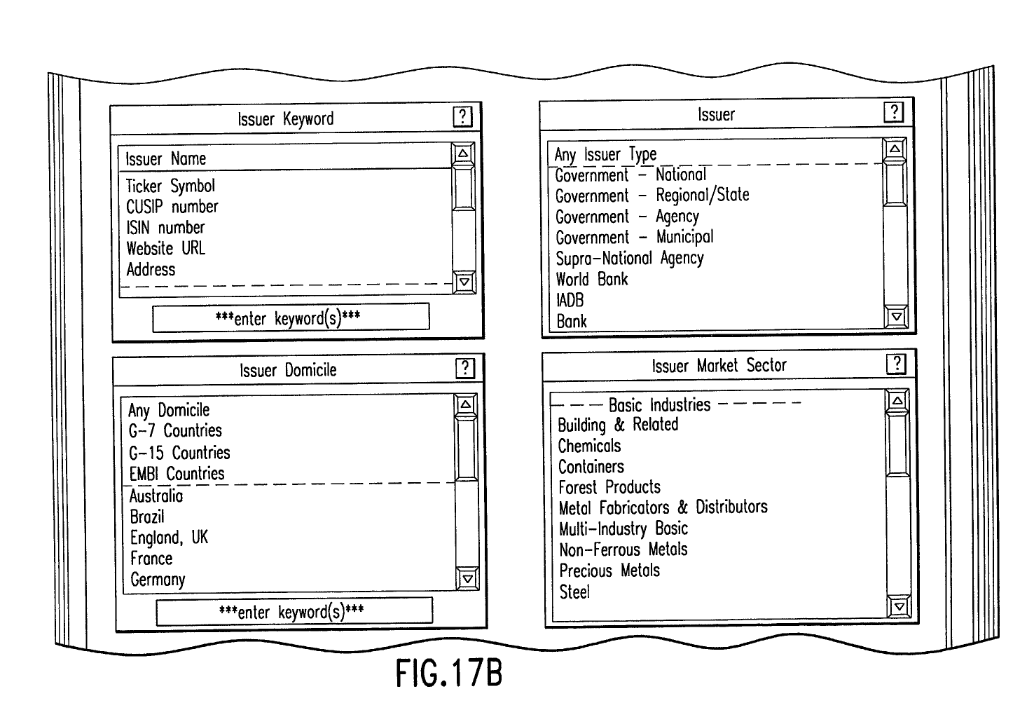

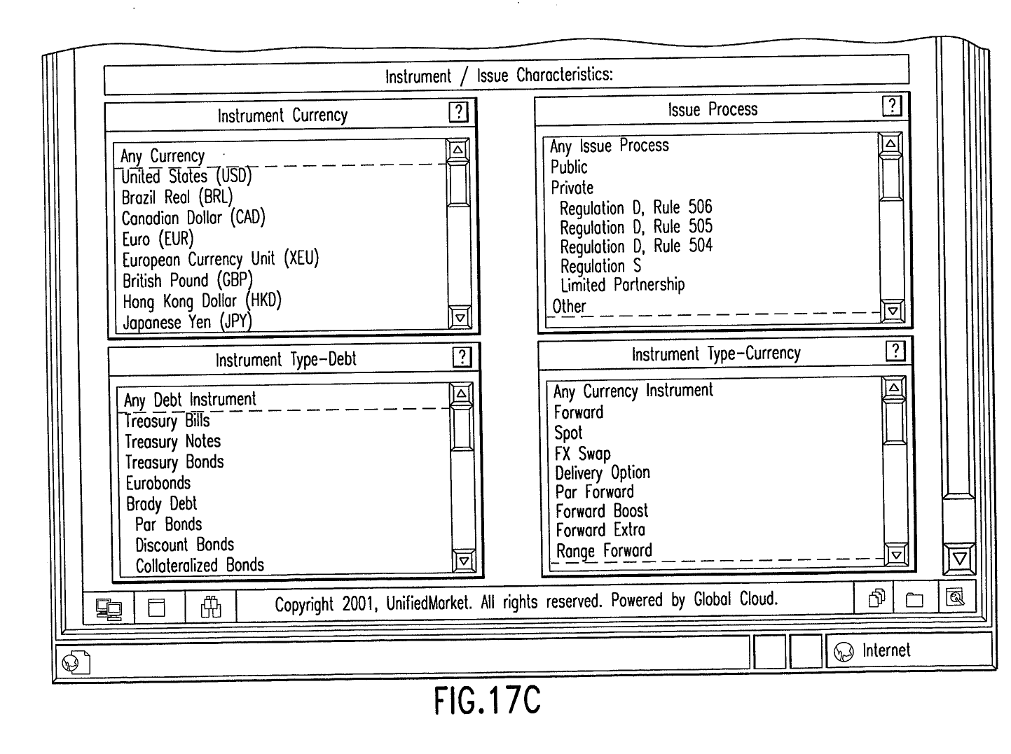

A Member accesses a Trading Floor that they have not previously visited through the System securities database search features. A simple search enables keyword matching to available data for Issuer name, CUSIP, ISIN, ticker symbol, Issuer address, and website URL. A more advanced Search Features display is depicted in FIG. 17. A Member may perform a keyword search and also may refine their search based on Issuer characteristics such as domicile, Issuer Type, and Market Sector. The Member may further specify the security (“instrument”) characteristics such as the type and subtype of instrument, currency denomination, how it was issued, and other characteristics specific to the instrument type.

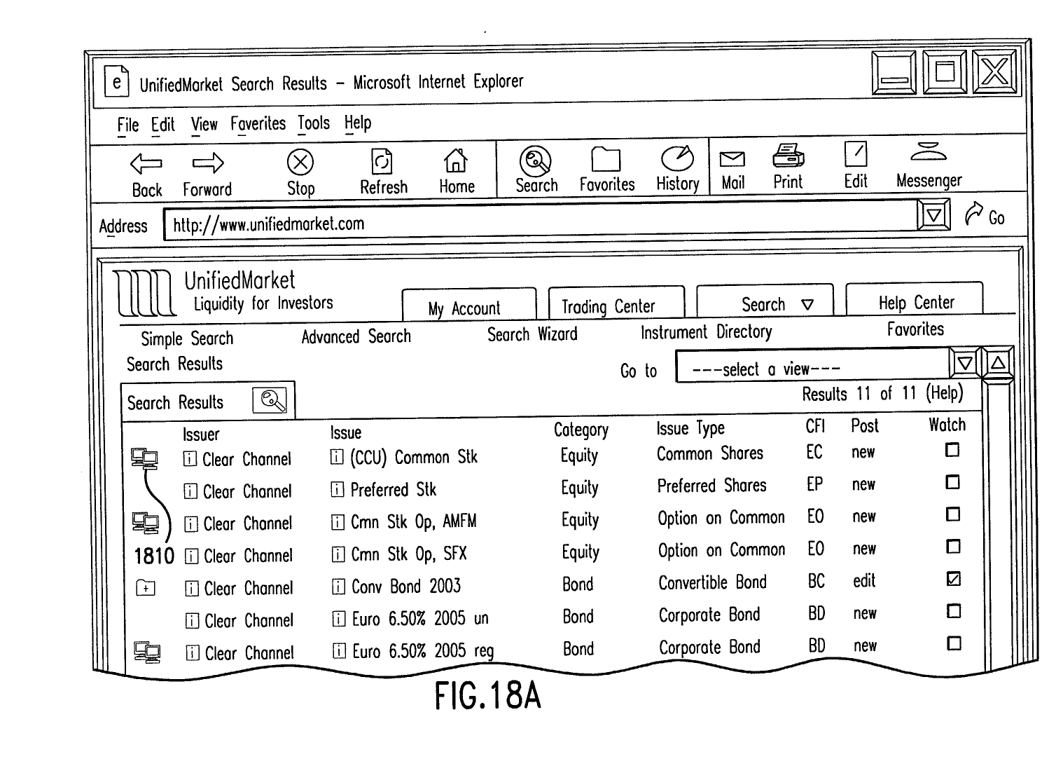

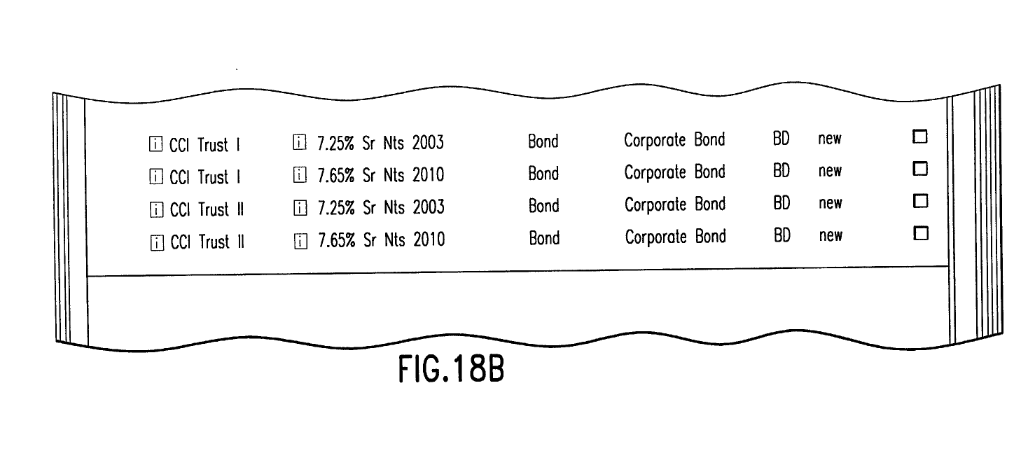

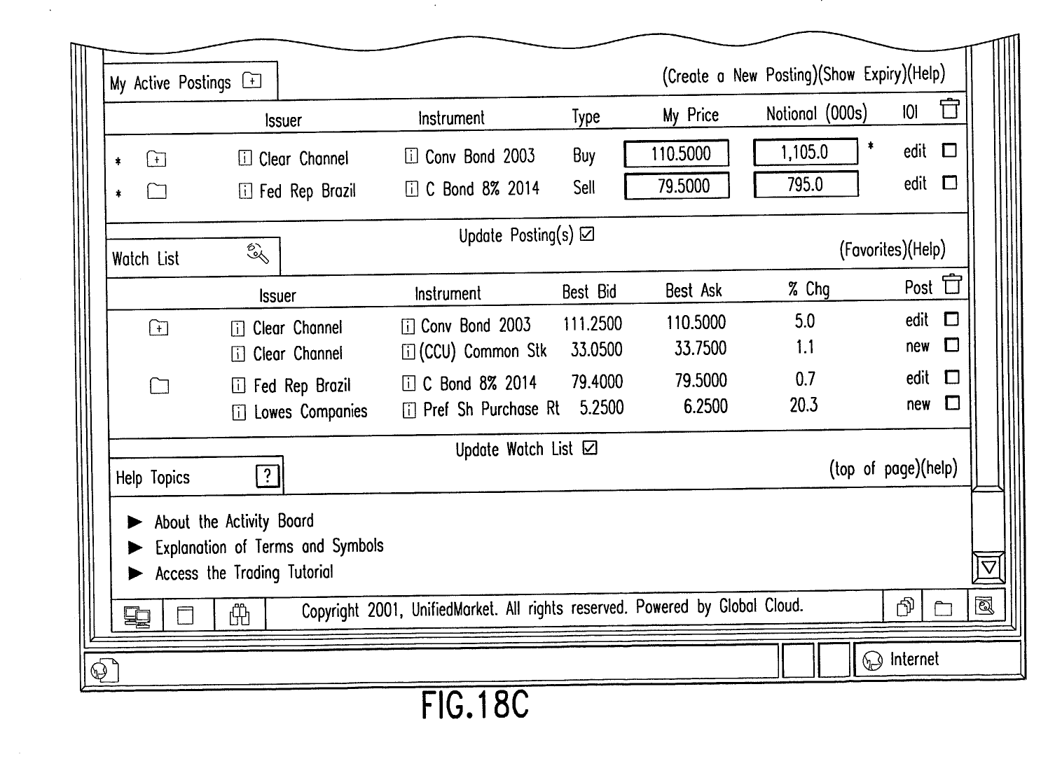

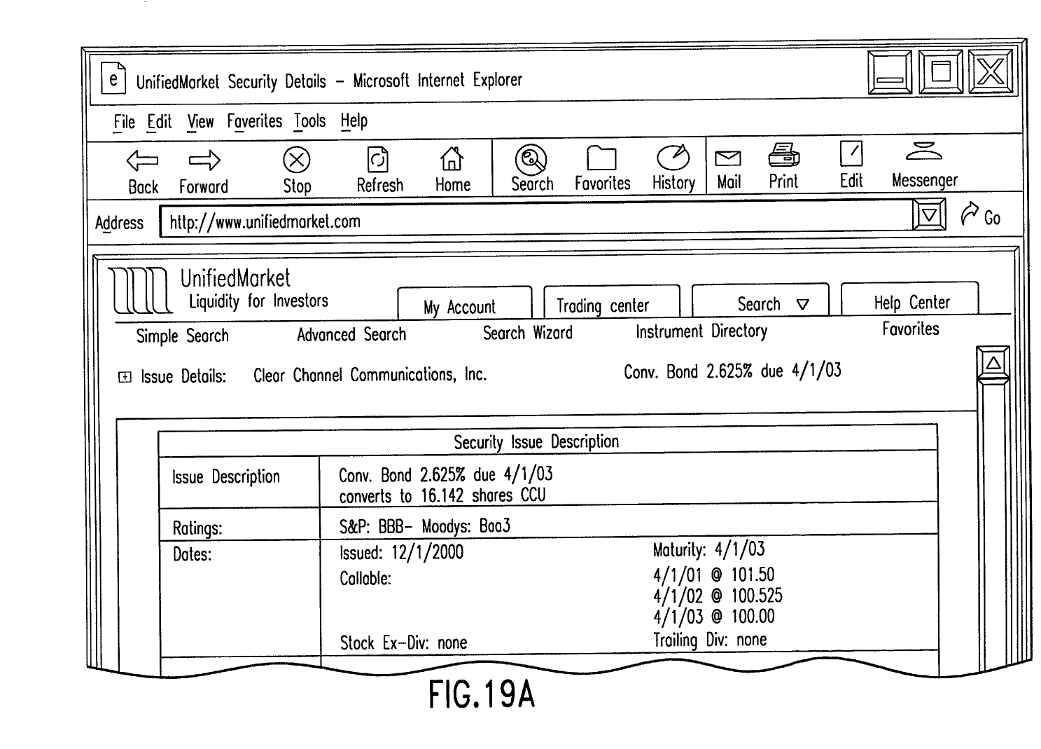

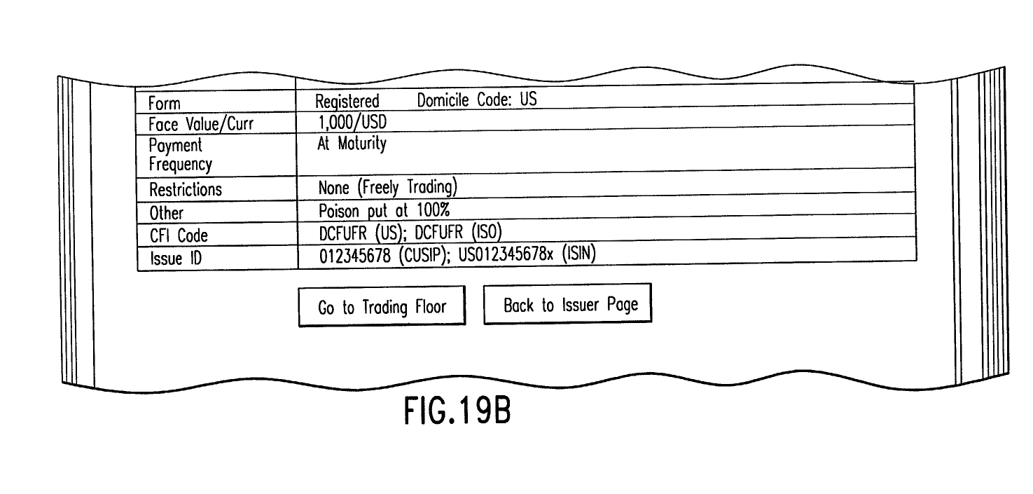

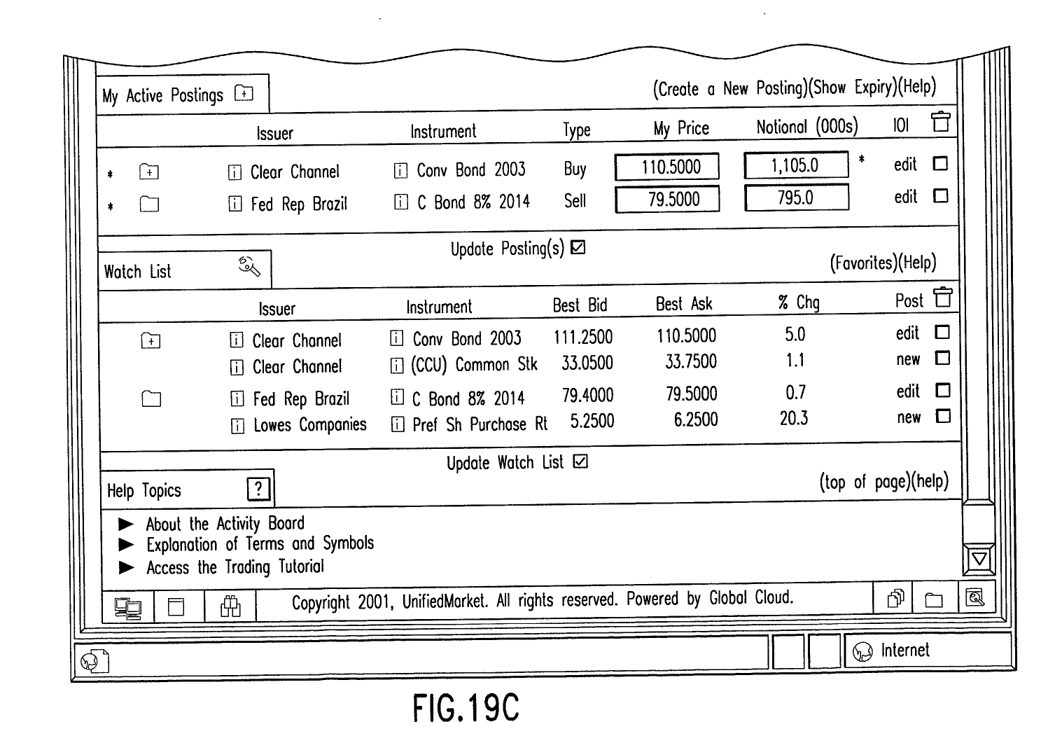

A Search Results format display is shown in FIG. 18. Each result is hyperlinked to the issuer and instrument details and the trading floor so a Member can easily navigate to Trading Floors of interest. An icon 1810 showing two computer terminals indicates an active Trading Floor, where has at least one active (i.e., not expired, canceled or suspended) public posting in that security. If the Member has an active posting in a security appearing in a search results list, this status is indicated by the appropriate folder icon. The instrument or security details are preferably displayed as shown in FIG. 19.

The Member may also immediately post a new public offer or edit an existing public offer from the Search Results display. The Member may also easily add one of more securities to their Watch List.

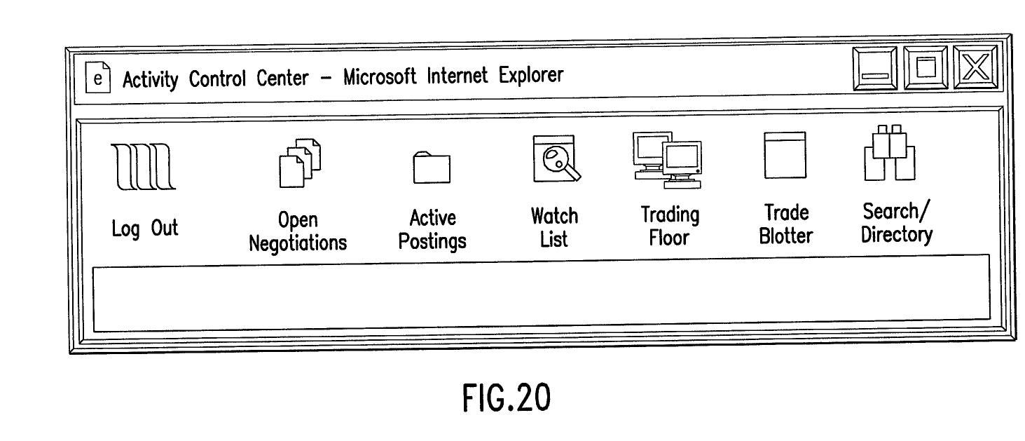

An Activity Control Center (ACC) display is depicted in FIG. 20. All investors grapple with the challenge of optimizing and choosing the information content on their valuable screen space. The ACC is a small, separate window that can be launched and stay resident on the Member's screen, alerting each Member to relevant activity in their account on the System. The screen location of the ACC can be adjusted at the Member's discretion, allowing him or her to place it where it best suits his or her viewing preferences. The ACC's unique design allows a Member to remain fully informed of transaction information and trade execution requirements, while at the same time freeing up the majority of the Member's limited screen space for other needs and preferences. When activity occurs, the Member is alerted by blinking icon and audible alerts in the same manner as described above for the icons at the bottom of the full screen. Clicking one of these icons launches the full System window and loads the corresponding page for the icon clicked.

The Trading Platform enables Members to custom design their own transactions and negotiation preferences, including cross-asset and tailor-made financial instruments, such as restricted stock with user-defined restrictions, asset swaps as integrated packages, and securities structured with embedded derivatives.

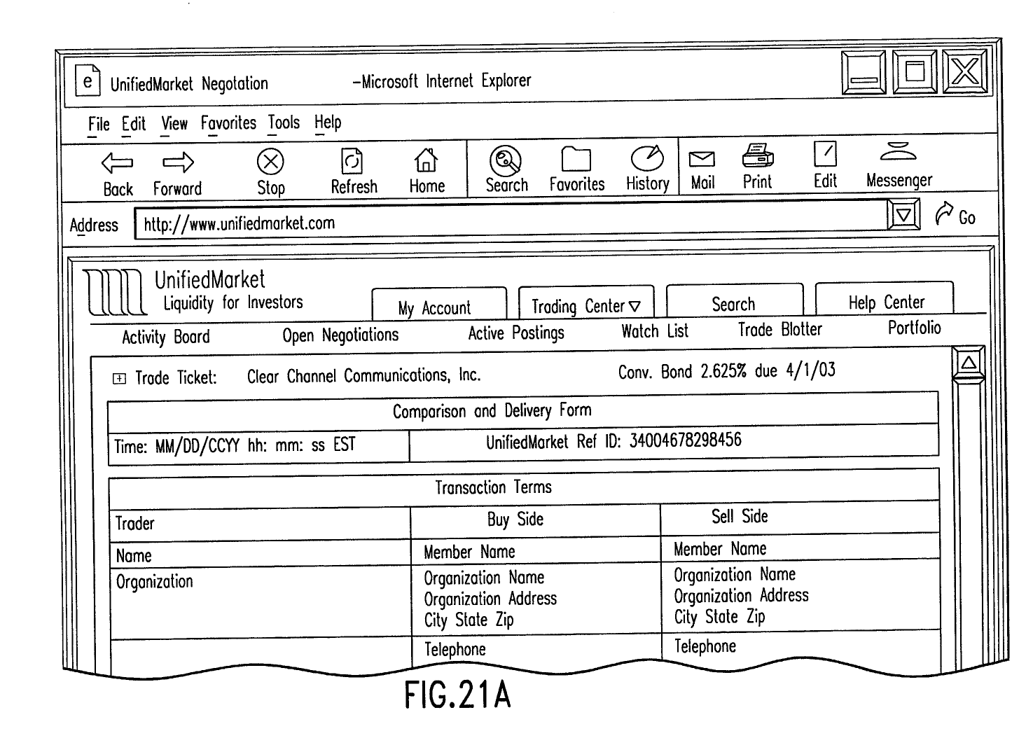

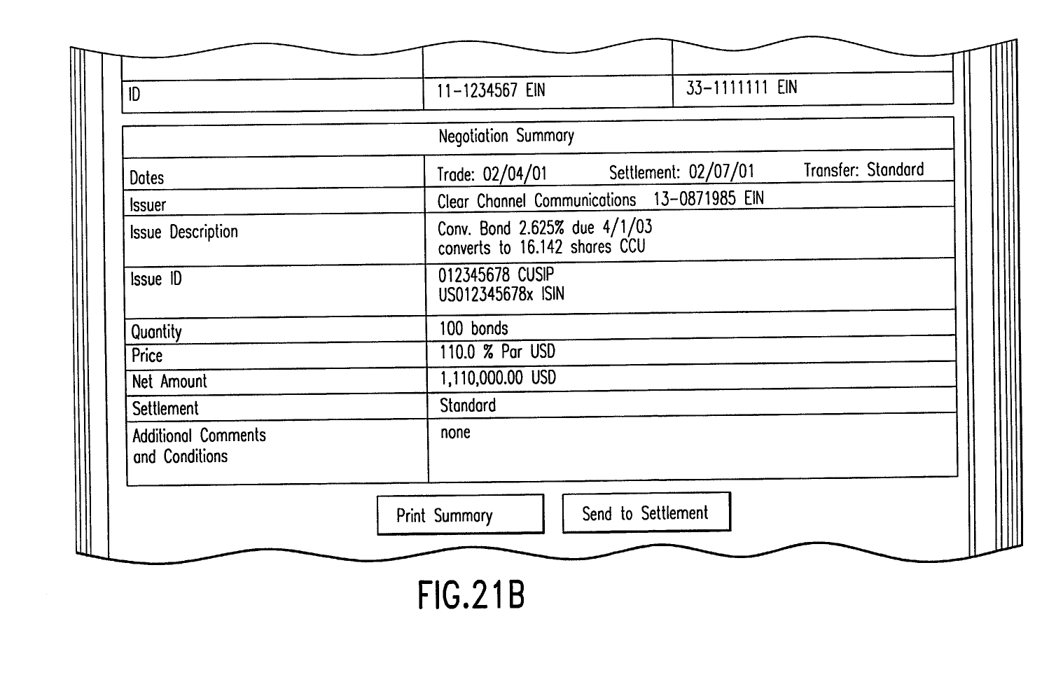

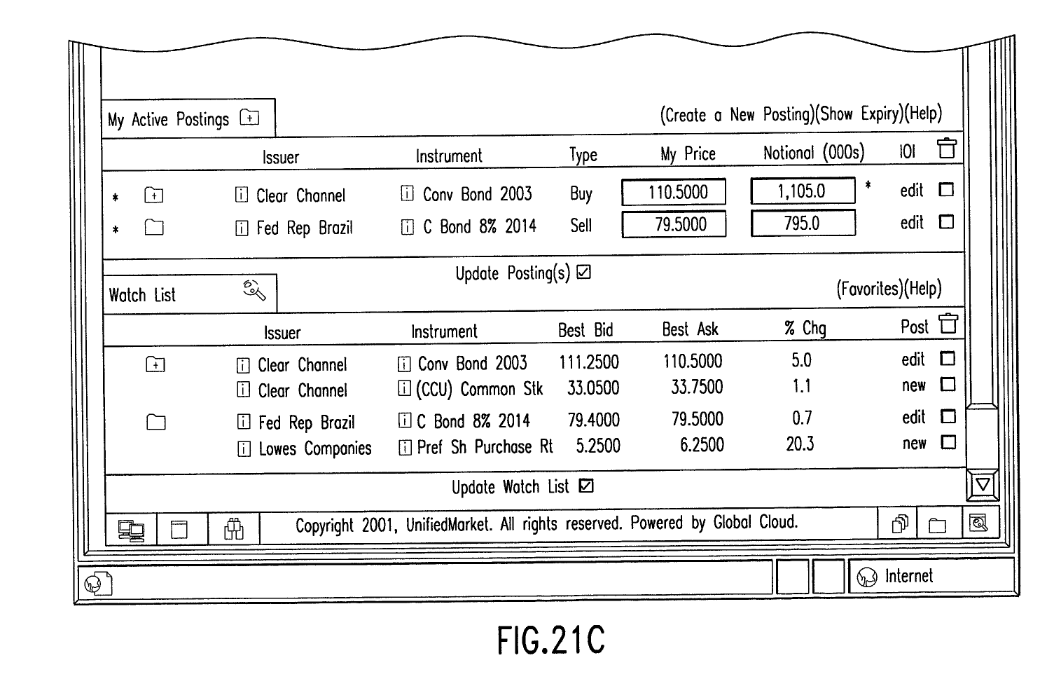

A Settlement display is depicted in FIG. 21. A preferred System provides a complete solution to Members' private transaction negotiation and settlement preferences. Once a Member's trade has been defined, searched, posted, and negotiated, the details of the transaction are captured in an easy-to-use trade ticket format, to facilitate in-house deal capture. The Member can specify their preferred format of trade ticket. The trade ticket information can be electronically delivered by a variety of standard and well-known methods to the Member's settlement services provider, according to the Member's discretion.

A fifth preferred embodiment of the present invention comprises a system essentially the same as that described above. However, in this fifth embodiment, the Members may publicly post firm or non-firm offers. A Member may accept another Member's firm public offer directly, without the requirement that the Member making the acceptance first make any public posting (this is “Direct Acceptance”). No System matching of the Member's offer occurs in this instance. Alternatively, a Member may post firm offers and elect to have the System act as an intermediary by matching one or more firm offers with a counter-party (this is “Offer Matching”).

Members who engage in transactions involving firm offers to transact in posted securities have the ability to choose any method of transaction settlement and any settlement services provider that they prefer. Once introduced to each other through the System website, they can elect to: (1) transact and settle directly without an intermediary; (2) utilize a linked intermediary bank for a simple holding escrow; (3) utilize a securities dealer for settlement, with or without an intermediary bank; or (4) utilize any other method available to the transacting members, such as NSCC, Euroclear, EMCC, and CEDEL. There are no mandatory rules that require utilization of pre-determined sources or methods of transaction settlement.

Members posting offers indicate that the offers are firm by checking a box on the html posting form. If a Member elects to allow System matching of his firm offer, he also specifies matching parameters. Those skilled in the art will recognize that these matching parameters are the same as those used in conventional trading systems, including without limitation (a) price specifications, such as “market” orders or “limit” orders; (b) quantity specifications, such as requiring that the entire quantity trade in a single transaction or not at all (“all or none”),or allowing the trade through one or more transactions as needed; (c) offer expiration, such as “good until canceled,” today only (“good until close”), or good until a Member-specified expiration and time; and (d) conditional or “triggered” offers, such as “stops” that post the offer only if certain market conditions such as last trade price are reached or exceeded.

The System preferably organizes and displays firm and non-firm offers in a single trading floor view by using different icons for firm offers and non-firm offers. The icons for the non-firm offers are preferably folders, and the icons for firm offers are preferably locks. As illustrated in FIG. 16, discussed above, a Member can send a counteroffer accepting the terms of one or more non-firm public offers by checking the appropriate boxes, submitting the information to the System and confirming the acceptance(s). Firm offers capable of binding acceptance can be accepted in much the same way. The difference is that acceptance of a non-firm offer is subject to further agreement of the other party, while acceptance of a firm offer completes the negotiation. Members can accept any combination of non-firm public offers and firm public offers in a single process, by checking the appropriate boxes, submitting the information to the System, and confirming the acceptance(s).

If Members choose to transact, they are provided with the ability, through a “mailto:” hyperlink on their Confirmation Page (not shown), to directly deliver their transaction and confirmation information to each other, their back office, or other settlement personnel, at their respective e-mail address, without using the servers of the System to route the message. The mailto: hyperlink is implemented using well-known CSS methods familiar to those skilled in the art, and can be configured to automatically include the recipient(s) email address(es), cc, subject, and body of the email message. The body preferably contains the transaction information and can be in any form that can be transmitted by email, including formatting such as plain text, HTML, RTF, XML and hyperlinks. The communications are processed like ordinary public server-type email originating at one Member's computer and transmitted by normal e-mail methods to the other Member's computer.

A sixth preferred embodiment of the present invention comprises a system essentially the same as that of the first preferred embodiment described above, but differs in that it allows Members to implement firm offers and their own matching rules to effectively simulate a system of firm offers. Members may use customized client software, of their own design or provided by the System operators, that functions as an automated trader on the client side to conduct the negotiation of non-firm public offers. The Member configures the client software with desired offer matching criteria. The client software receives the public non-firm offers and private counteroffers that are directed to the Member from the System, and based on the Member input matching parameters, accepts, counters, ignores, or rejects the offers.

This preferred embodiment is not an exchange or an ECN. Members retain complete control of their transactions at each step of the process, including specifying the conditions and method, if any, for accepting and/or matching offers. Unlike exchanges, the matching is performed on the client side, not the server-side.

Although illustrative embodiments of the subject invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

What is claimed is:

1. A method for enabling exchange of financial information and negotiation and settlement of securities transactions over an electronic network, comprising the steps of:
(a) electronically receiving membership data over the electronic network from potential members, said membership data comprising data sufficient to identify each of said potential members and to pre-qualify them for access to postings of securities by other members;
(b) storing said membership data in an electronic database;
(c) approving selected potential members for membership;
(d) electronically notifying said selected potential members that they have become members;
(e) electronically receiving from a first member posting data, said posting data comprising one or more indicated offers to acquire or transfer ownership interests in selected securities;
(f) storing said posting data in an electronic database;
(g) electronically transmitting said posting data over said network to other members;
(h) receiving a counteroffer to one or more of said first member's offers over said network from a second member;
(i) storing said counteroffer in an electronic database;
(j) electronically transmitting said counteroffer over the network to the first member;
(k) electronically transmitting to the first member and to the second member information sufficient to enable the two members to contact each other;
(l) electronically transmitting to said first and second members data sufficient to identify transaction settlement facilities that are available at the option of and upon the mutual agreement of said first and second members;
(m) electronically receiving from said first member and said second member their mutually agreed upon election to electronically transmit to each other a notification that an agreement has been reached between said first member and said second member for the transfer of said one or more securities, wherein said notification comprises material terms of said agreement and identifies said first and second members' mutually agreed upon selection of a transaction settlement facility;
(n) storing said notification in an electronic database;
(o) electronically transmitting said notification to said first and second members; and
(p) electronically transmitting said material terms to said selected transaction settlement facility.

2. A method for enabling exchange of financial information and negotiation and settlement of securities transactions over an electronic network, comprising the steps of:
(a) electronically receiving membership data over the electronic network from potential members, said membership data comprising data sufficient to identify each of said potential members and to pre-qualify them for access to postings of securities by other members;
(b) storing said membership data in an electronic database;
(c) approving selected potential members for membership;
(d) electronically notifying said selected potential members that they have become members;
(e) electronically receiving from a first member posting data, said posting data comprising one or more firm offers to acquire or transfer ownership interests in selected securities;
(f) storing said posting data in an electronic database;
(g) electronically transmitting said posting data over said network to other members;
(h) receiving an acceptance of one or more of said first member's offers over said network from a second member;
(i) storing said acceptance in an electronic database;
(j) electronically transmitting said acceptance over the network to the first member;
(k) electronically transmitting to the first member and to the second member information sufficient to enable the two members to contact each other;
(l) electronically transmitting to said first and second members data sufficient to identify transaction settlement facilities that are available at the option of and upon the mutual agreement of said first and second members;
(m) electronically receiving from said first member and said second member their mutually agreed upon election to electronically transmit to each other a notification that an agreement has been reached between said first member and said second member for the transfer of said one or more securities, wherein said notification comprises material terms of said agreement and identifies said first and second members' mutually agreed upon selection of a transaction settlement facility;
(n) storing said notification in an electronic database;
(o) electronically transmitting said notification to said first and second members; and
(p) electronically transmitting said material terms to said selected transaction settlement facility.

3. A method for enabling exchange of financial information and negotiation and settlement of securities transactions over an electronic network, comprising the steps of:
(a) electronically receiving membership data over the electronic network from potential members, said membership data comprising data sufficient to identify each of said potential members and to pre-qualify them for access to postings of securities by other members;
(b) storing said membership data in an electronic database;
(c) approving selected potential members for membership;
(d) electronically notifying said selected potential members that they have become members;
(e) electronically receiving from a first member posting data, said posting data comprising one or more indicated offers to acquire or transfer ownership interests in selected securities;
(f) storing said posting data in an electronic database;
(g) electronically transmitting said posting data over said network to other members;
(h) receiving a counteroffer to one or more of said first member's offers over said network from a second member;
(i) storing said counteroffer in an electronic database;
(j) electronically transmitting said counteroffer over the network to the first member;
(k) electronically transmitting to the first member and to the second member information sufficient to enable the two members to contact each other;
(l) electronically transmitting to said first and second members data sufficient to identify a mandated transaction settlement facility, that said first and second members must use;
(m) electronically receiving from said first member and said second member their mutually agreed upon election to electronically transmit to each other a notification that an agreement has been reached between said first member and said second member for the transfer of said one or more securities, wherein said notification comprises material terms of said agreement and identifies said first and second members' agreement to utilize said mandated transaction settlement facility;
(n) storing said notification in an electronic database;
(o) electronically transmitting said notification to said first and second members; and
(p) electronically transmitting said material terms to said mandated transaction settlement facility.

4. A method for enabling exchange of financial information and negotiation and settlement of securities transactions over an electronic network, comprising the steps of:
(a) electronically receiving membership data over the electronic network from potential members, said membership data comprising data sufficient to identify each of said potential members and to pre-qualify them for access to postings of securities by other members;
(b) storing said membership data in an electronic database;
(c) approving selected potential members for membership;
(d) electronically notifying said selected potential members that they have become members;
(e) electronically receiving from a first member posting data, said posting data comprising one or more firm offers to acquire or transfer ownership interests in selected securities;
(f) storing said posting data in an electronic database;
(g) electronically transmitting said posting data over said network to other members;
(h) receiving an acceptance of one or more of said first member's offers over said network from a second member;
(i) storing said acceptance in an electronic database;
(j) electronically transmitting said acceptance over the network to the first member;
(k) electronically transmitting to the first member and to the second member information sufficient to enable the two members to contact each other;
(l) electronically transmitting to said first and second members data sufficient to identify a mandated transaction settlement facility, that said first and second members must use;
(m) electronically receiving from said first member and said second member their mutually agreed upon election to electronically transmit to each other a notification that an agreement has been reached between said first member and said second member for the transfer of said one or more securities, wherein said notification comprises material terms of said agreement and identifies said first and second members' agreement to utilize said mandated transaction settlement facility;
(n) storing said notification in an electronic database;
(o) electronically transmitting said notification to said first and second members; and
(p) electronically transmitting said material terms to said mandated transaction settlement facility.

5. A method for securities trading that enables principal-to-principal exchange of financial information, including postings of offers to buy and sell any registered or unregistered securities that have been issued by any securities issuer, and the negotiation and settlement of all securities transactions without the use of an intermediary brokerage or conventional securities exchange, over an electronic network accessible to potential sellers and buyers, comprising the steps of:
(a) requiring each of said potential buyers and sellers to satisfy membership requirements imposed by the trading system manager as a condition for access to restricted and unrestricted areas within said system and for access to particular postings, further comprising the steps of:
(1) electronically receiving membership data over the electronic network from each of said potential buyers and sellers, said membership data comprising data sufficient to identify each of said potential buyers and potential sellers and to pre-qualify them for access to postings of securities on the system or to the posting members; and
(2) storing said membership data in an electronic database securities trading;
(b) electronically receiving, storing and displaying the members' posting data, said posting data comprising indicated offers to buy or otherwise acquire, or to sell or otherwise transfer, ownership interests in their securities, further comprising the steps of:
(1) receiving said posting data over said electronic network;
(2) organizing and storing said posting data in an electronic database;
(3) determining any restrictions to be imposed by said trading system on member access to said posting data or to the posting member;
(4) electronically transmitting said posting data over said network to all members who are not restricted from access to said posting data or to the posting member; and
(5) electronically transmitting information over said network that is sufficient to enable potential buyers and sellers to contact each other about their indicated offers securities trading;
(c) electronically receiving, storing and displaying information sufficient to describe and transmit offers and counteroffers between members and said posting members, including proposed transaction terms, and further comprising the steps of:
(1) receiving an offer or counteroffer over said network from a negotiating member;
(2) storing said offer or counteroffer in a database; and
(3) electronically transmitting said offer or counteroffer over the network to the other negotiating party, with information sufficient to enable the parties to contact each other securities trading; and
(d) providing potential buyers and sellers the option to select a transaction settlement facility and transmit material terms of an agreement to conduct a transaction in said security, further comprising the steps of:
(1) electronically transmitting to said potential buyers and sellers data sufficient to identify transaction settlement facilities that are available at the option of said potential buyers and sellers;
(2) electronically receiving from said potential seller and said potential buyer their optional election to electronically transmit to each other a notification that an agreement has been reached between said potential buyer and said potential seller for the transfer of said security, wherein said notification comprises data describing material terms of said agreement and identifying said potential buyer's and potential seller's selection of a settlement facility;
(3) storing said notification in an electronic database; and
(4) electronically transmitting said material terms to said settlement facility for the purpose of said settlement facility generating standardized transaction settlement documents.

6. A method for securities trading that enables principal-to-principal exchange of financial information, including postings of firm offers to buy and sell any registered or unregistered securities that have been issued by any securities issuer, and the negotiation and settlement of all securities transactions without the use of an intermediary brokerage or conventional securities exchange, over an electronic network accessible to potential sellers and buyers, comprising the steps of:
(a) requiring each of said potential buyers and sellers to satisfy membership requirements imposed by the trading system manager as a condition for access to restricted and unrestricted areas within said system and for access to particular postings, further comprising the steps of:
(1) electronically receiving membership data over the electronic network from each of said potential buyers and sellers, said membership data comprising data sufficient to identify each of said potential buyers and potential sellers and to pre-qualify them for access to postings of securities on the system or to the posting members; and
(2) storing said membership data in an electronic database;
(b) electronically receiving, storing and displaying the members' posting data, said posting data comprising firm offers to buy or otherwise acquire, or to sell or otherwise transfer, ownership interests in their securities, further comprising the steps of:
(1) receiving said posting data over said electronic network;
(2) organizing and storing said posting data in an electronic database;
(3) determining any restrictions to be imposed by said trading system on member access to said posting data or to the posting member;
(4) electronically transmitting said posting data over said network to all members who are not restricted from access to said posting data or to the posting member; and
(5) electronically transmitting information over said network that is sufficient to enable potential buyers and sellers to contact each other about their firm offers;
(c) electronically receiving, storing and displaying information sufficient to describe and transmit firm offers between members and said posting members, including proposed transaction terms, and further comprising the steps of:
(1) receiving an acceptance of said offer over said network from a responding member;
(2) storing said offer or acceptance of said offer in a database; and
(3) electronically transmitting said offer or acceptance of said offer over the network to the other responding party, with information sufficient to enable the parties to contact each other securities trading; and
(d) providing potential buyers and sellers the option to select a transaction settlement facility and transmit material terms of an agreement to conduct a transaction in said security, further comprising the steps of:
(1) electronically transmitting to said potential buyers and sellers data sufficient to identify transaction settlement facilities that are available at the option of said potential buyers and sellers;
(2) electronically receiving from said potential seller and said potential buyer their optional election to electronically transmit to each other a notification that an agreement has been reached between said potential buyer and said potential seller for the transfer of said security, wherein said notification comprises data describing material terms of said agreement and identifying said potential buyer's and potential seller's selection of a settlement facility;
(3) storing said notification in an electronic database; and
(4) electronically transmitting said material terms to said settlement facility for the purpose of said settlement facility generating standardized transaction settlement documents.

7. A method for securities trading that enables principal-to-principal exchange of financial information, including postings of offers to buy and sell any registered or unregistered securities that have been issued by any securities issuer, and the negotiation and mandated settlement of all securities transactions without the use of an intermediary brokerage or conventional securities exchange, over an electronic network accessible to potential sellers and buyers, comprising the steps of:
(a) requiring each of said potential buyers and sellers to satisfy membership requirements imposed by the trading system manager as a condition for access to restricted and unrestricted areas within said system and for access to particular postings, further comprising the steps of:
(1) electronically receiving membership data over the electronic network from each of said potential buyers and sellers, said membership data comprising data sufficient to identify each of said potential buyers and potential sellers and to pre-qualify them for access to postings of securities on the system or to the posting members;
(2) storing said membership data in an electronic database securities trading;
(b) electronically receiving, storing and displaying the members' posting data, said posting data comprising indicated offers to buy or otherwise acquire, or to sell or otherwise transfer, ownership interests in their securities, further comprising the steps of:
(1) receiving said posting data over said electronic network;
(2) organizing and storing said posting data in an electronic database;
(3) determining any restrictions to be imposed by said trading system on member access to said posting data or to the posting member;
(4) electronically transmitting said posting data over said network to all members who are not restricted from access to said posting data or to the posting member; and
(5) electronically transmitting information over said network that is sufficient to enable potential buyers and sellers to contact each other about their indicated offers securities trading;
(c) electronically receiving, storing and displaying information sufficient to describe and transmit offers and counteroffers between members and said posting members, including proposed transaction terms, and further comprising the steps of:
(1) receiving an offer or counteroffer over said network from a negotiating member;
(2) storing said offer or counteroffer in a database; and
(3) electronically transmitting said offer or counteroffer over the network to the other negotiating party, with information sufficient to enable the parties to contact each other securities trading; and
(d) requiring potential buyers and sellers to utilize a mandated transaction settlement facility and transmit standardized material terms of an agreement to efficiently conduct a transaction in said security, further comprising the steps of:
(1) electronically transmitting to said potential buyers and sellers data sufficient to communicate with a transaction settlement facility mandated to said potential buyers and sellers;
(2) electronically receiving from said potential seller and said potential buyer their responses to each other effecting notification that an agreement has been reached between said potential buyer and said potential seller for the transfer of said security, wherein said notification comprises data describing standardized material terms of said agreement and identifying said potential buyer's and potential seller's agreement to said mandated settlement facility;
(3) storing said notification in an electronic database; and
(4) electronically transmitting said material terms to said mandated settlement facility for the purpose of said mandated settlement facility generating standardized transaction settlement documents.

8. A method for securities trading that enables principal-to-principal exchange of financial information, including postings of firm offers to buy and sell any registered or unregistered securities that have been issued by any securities issuer, and the negotiation and mandated settlement of all securities transactions without the use of an intermediary brokerage or conventional securities exchange, over an electronic network accessible to potential sellers and buyers, comprising the steps of:
(a) requiring each of said potential buyers and sellers to satisfy membership requirements imposed by the trading system manager as a condition for access to restricted and unrestricted areas within said system and for access to particular postings, further comprising the steps of:
(1) electronically receiving membership data over the electronic network from each of said potential buyers and sellers, said membership data comprising data sufficient to identify each of said potential buyers and potential sellers and to pre-qualify them for access to postings of securities on the system or to the posting members;
(2) storing said membership data in an electronic database securities trading;
(b) electronically receiving, storing and displaying the members' posting data, said posting data comprising firm offers to buy or otherwise acquire, or to sell or otherwise transfer, ownership interests in their securities, further comprising the steps of:
(1) receiving said posting data over said electronic network;
(2) organizing and storing said posting data in an electronic database;
(3) determining any restrictions to be imposed by said trading system on member access to said posting data or to the posting member;
(4) electronically transmitting said posting data over said network to all members who are not restricted from access to said posting data or to the posting member; and
(5) electronically transmitting information over said network that is sufficient to enable potential buyers and sellers to contact each other about their firm offers securities trading;
(c) electronically receiving, storing and displaying information sufficient to describe and transmit firm offers between members and said posting members, including proposed transaction terms, and further comprising the steps of:
(1) receiving an acceptance of said offer over said network from a responding member;
(2) storing said offer or acceptance of said offer in a database;
(3) electronically transmitting said offer or acceptance of said offer over the network to the responding party, with information sufficient to enable the parties to contact each other securities trading; and
(d) requiring potential buyers and sellers to use a mandated transaction settlement facility and transmit standardized material terms of an agreement to efficiently conduct a transaction in said security, further comprising the steps of:
(1) electronically transmitting to said potential buyers and sellers data sufficient to communicate with a transaction settlement facility mandated to said potential buyers and sellers;
(2) electronically receiving from said potential seller and said potential buyer their responses to each other effecting notification that an agreement has been reached between said potential buyer and said potential seller for the transfer of said security, wherein said notification comprises data describing standardized material terms of said agreement and identifying said potential buyer's and potential seller's agreement to said mandated settlement facility;
(3) storing said notification in an electronic database; and
(4) electronically transmitting said material terms to said mandated settlement facility for the purpose of said mandated settlement facility generating standardized transaction settlement documents.

9. The method of claim 5, 6, 7, or 8, further comprising the step of requiring a member who has an active buy posting for a security can only be contacted over the trading system's electronic network by a member who has an active sell posting for that security, and further requiring that a member who has an active sell posting for a security can only be contacted over said network by a member who has an active buy posting for that security.

10. The method of claim 5, 6, 7, or 8, wherein some or all of the data transmitted over the trading system's electronic network are encrypted and the originator of a data transmission is digitally authenticated.

11. The method of claim 5, 6, 7, or 8,s wherein said offers displayed to said potential buyers and sellers do not disclose the identities of said potential buyers and sellers to other said potential buyers and sellers.

12. The method of claim 5, 6, 7, or 8, further comprising the step of electronically receiving and electronically storing notification of completion of a securities transaction from a settlement facility, including material transaction facts such as quantity and price, which are posted on the trading system for the benefit of all its members.

13. The method of claim 5, 6, 7, or 8, further comprising the step of permitting buyers and sellers who have reached agreement to unilaterally permanently delete from the trading system's electronic database all data related to the identity of the member that posted said indicated offer and data related the to subsequent exchange of financial information related to said posting.

14. The method of claim 5, 6, 7, or 8, whereby a member may revocably elect to be represented by an agent authorized by said member, said agent acting in a fiduciary capacity on behalf of said member.

15. The method of claim 5, 6, 7, or 8, whereby a posting member may revocably elect to arbitrarily exclude any other member from access to one or more of said posting member's postings.

16. The method of claim 5, 6, 7, or 8, whereby a posting member may revocably elect to permit only those other members who are pre-designated by said posting member, and who otherwise satisfy any member access conditions that may be imposed by said trading system manager, to access said member's postings.

17. A system for enabling exchange of financial information and negotiation and settlement of securities transactions over an electronic network, comprising:
(a) a holding company;
(b) a first subsidiary of said holding company, wherein said first subsidiary is an independently-operated NASD member firm; and
(c) a second subsidiary of said holding company, wherein said second subsidiary operates an electronic network-based computer trading system;
wherein said holding company receives flat-rate, time-based fees from members of the system of said second subsidiary;
wherein said holding company receives transaction referral fees from independent securities dealers linked by a computer network to said first subsidiary; and
wherein said first subsidiary is linked by a computer network to the system of said second subsidiary.

18. The system of claim 17, wherein said securities dealers are exclusively responsible for determining that their registered clients meet all relevant system membership of the system of said second subsidiary.

19. The system of claim 17, wherein each of said securities dealers has a contract with said first subsidiary that includes an agreement by the contracting securities dealer to pay referral fees to said first subsidiary for all transactions on the system of said second subsidiary that result from postings on said system by said contracting securities dealer.

20. The system of claim 17, further comprising a third subsidiary of said holding company, wherein said third subsidiary is a government licensed exchange.

21. The system of claim 17, further comprising a third subsidiary of said holding company, wherein said third subsidiary is a securities dealer licensed to operate a trading system.

22. The system of claim 21, wherein said trading system that said third subsidiary is licensed to operate is an Alternative Trading System.

23. Computer software for enabling exchange of financial information and negotiation and settlement of securities transactions over an electronic network, comprising:
(a) software for electronically receiving membership data over the electronic network from potential members, said membership data comprising data sufficient to identify each of said potential members and to pre-qualify them for access to postings of securities by other members;
(b) software for storing said membership data in an electronic database;
(c) software for approving selected potential members for membership;
(d) software for electronically notifying said selected potential members that they have become members;
(e) software for electronically receiving from a first member posting data, said posting data comprising one or more indicated offers to acquire or transfer ownership interests in selected securities;
(f) software for storing said posting data in an electronic database;
(g) software for electronically transmitting said posting data over said network to other members;
(h) software for receiving a counteroffer to one or more of said first member's offers over said network from a second member;
(i) software for storing said counteroffer in an electronic database;
(j) software for electronically transmitting said counteroffer over the network to the first member;
(k) software for electronically transmitting to the first member and to the second member information sufficient to enable the two members to contact each other;
(l) software for electronically transmitting to said first and second members data sufficient to identify transaction settlement facilities that are available at the option of and upon the mutual agreement of said first and second members;
(m) software for electronically receiving from said first member and said second member their mutually agreed upon election to electronically transmit to each other a notification that an agreement has been reached between said first member and said second member for the transfer of said one or more securities, wherein said notification comprises material terms of said agreement and identifies said first and second members' mutually agreed upon selection of a transaction settlement facility;
(n) software for storing said notification in an electronic database;
(o) software for electronically transmitting said notification to said first and second members; and
(p) software for electronically transmitting said material terms to said selected transaction settlement facility.

24. Computer software for enabling exchange of financial information and negotiation and settlement of securities transactions over an electronic network, comprising:
(a) software for electronically receiving membership data over the electronic network from potential members, said membership data comprising data sufficient to identify each of said potential members and to pre-qualify them for access to postings of securities by other members;
(b) software for storing said membership data in an electronic database;
(c) software for approving selected potential members for membership;
(d) software for electronically notifying said selected potential members that they have become members;
(e) software for electronically receiving from a first member posting data, said posting data comprising one or more firm offers to acquire or transfer ownership interests in selected securities;
(f) software for storing said posting data in an electronic database;
(g) software for electronically transmitting said posting data over said network to other members;
(h) software for receiving an acceptance of one or more of said first member's offers over said network from a second member;
(i) software for storing said acceptance in an electronic database;
(j) software for electronically transmitting said acceptance over the network to the first member;
(k) software for electronically transmitting to the first member and to the second member information sufficient to enable the two members to contact each other;
(l) software for electronically transmitting to said first and second members data sufficient to identify transaction settlement facilities that are available at the option of and upon the mutual agreement of said first and second members;
(m) software for electronically receiving from said first member and said second member their mutually agreed upon election to electronically transmit to each other a notification that an agreement has been reached between said first member and said second member for the transfer of said one or more securities, wherein said notification comprises material terms of said agreement and identifies said first and second members' mutually agreed upon selection of a transaction settlement facility;
(n) software for storing said notification in an electronic database;
(o) software for electronically transmitting said notification to said first and second members;
(p) software for electronically transmitting said material terms to said selected transaction settlement facility.

25. Computer software for enabling exchange of financial information and negotiation and settlement of securities transactions over an electronic network, comprising:
(a) software for electronically receiving membership data over the electronic network from potential members, said membership data comprising data sufficient to identify each of said potential members and to pre-qualify them for access to postings of securities by other members;
(b) software for storing said membership data in an electronic database;
(c) software for approving selected potential members for membership;
(d) software for electronically notifying said selected potential members that they have become members;
(e) software for electronically receiving from a first member posting data, said posting data comprising one or more indicated offers to acquire or transfer ownership interests in selected securities;
(f) software for storing said posting data in an electronic database;
(g) software for electronically transmitting said posting data over said network to other members;
(h) software for receiving a counteroffer to one or more of said first member's offers over said network from a second member;
(i) software for storing said counteroffer in an electronic database;
(j) software for electronically transmitting said counteroffer over the network to the first member;
(k) software for electronically transmitting to the first member and to the second member information sufficient to enable the two members to contact each other;
(l) software for electronically transmitting to said first and second members data sufficient to identify a mandated transaction settlement facility, that said first and second members must use;
(m) software for electronically receiving from said first member and said second member their mutually agreed upon election to electronically transmit to each other a notification that an agreement has been reached between said first member and said second member for the transfer of said one or more securities, wherein said notification comprises material terms of said agreement and identifies said first and second members' agreement to utilize said mandated transaction settlement facility;
(n) software for storing said notification in an electronic database;
(o) software for electronically transmitting said notification to said first and second members;
(p) software for electronically transmitting said material terms to said mandated transaction settlement facility.

26. Computer software for enabling exchange of financial information and negotiation and settlement of securities transactions over an electronic network using a server/database computer system, comprising:
(a) software for electronically receiving membership data over the electronic network from potential members, said membership data comprising data sufficient to identify each of said potential members and to pre-qualify them for access to postings of securities by other members;
(b) software for storing said membership data in an electronic database;
(c) software for approving selected potential members for membership;
(d) software for electronically notifying said selected potential members that they have become members;
(e) software for electronically receiving from a first member posting data, said posting data comprising one or more firm offers to acquire or transfer ownership interests in selected securities;
(f) software for storing said posting data in an electronic database;
(g) software for electronically transmitting said posting data over said network to other members;
(h) software for receiving an acceptance of one or more of said first member's offers over said network from a second member;
(i) software for storing said acceptance in an electronic database;
(j) software for electronically transmitting said acceptance over the network to the first member;
(k) software for electronically transmitting to the first member and to the second member information sufficient to enable the two members to contact each other;
(l) software for electronically transmitting to said first and second members data sufficient to identify a mandated transaction settlement facility, that said first and second members must use;
(m) software for electronically receiving from said first member and said second member their mutually agreed upon election to electronically transmit to each other a notification that an agreement has been reached between said first member and said second member for the transfer of said one or more securities, wherein said notification comprises material terms of said agreement and identifies said first and second members' agreement to utilize said mandated transaction settlement facility;
(n) software for storing said notification in an electronic database;
(o) software for electronically transmitting said notification to said first and second members;
(p) software for electronically transmitting said material terms to said mandated transaction settlement facility.

27. Computer software for securities trading that enables principal-to-principal exchange of financial information, including postings of offers to buy and sell any registered or unregistered securities that have been issued by any securities issuer, and the negotiation and settlement of all securities transactions without the use of an intermediary brokerage or conventional securities exchange, over an electronic network accessible to potential sellers and buyers, using a server/database computer system, comprising:
(a) software for requiring each of said potential buyers and sellers to satisfy membership requirements imposed by the trading system manager as a condition for access to restricted and unrestricted areas within said system and for access to particular postings, further comprising:
(1) software for electronically receiving membership data over the electronic network from each of said potential buyers and sellers, said membership data comprising data sufficient to identify each of said potential buyers and potential sellers and to pre-qualify them for access to postings of securities on the system or to the posting members; and
(2) software for storing said membership data in an electronic database securities trading;
(b) software for electronically receiving, storing and displaying the members' posting data, said posting data comprising indicated offers to buy or otherwise acquire, or to sell or otherwise transfer, ownership interests in their securities, further comprising:
(1) software for receiving said posting data over said electronic network;
(2) software for organizing and storing said posting data in an electronic database;
(3) software for determining any restrictions to be imposed by said trading system on member access to said posting data or to the posting member;
(4) software for electronically transmitting said posting data over said network to all members who are not restricted from access to said posting data or to the posting member; and
(5) software for electronically transmitting information over said network that is sufficient to enable potential buyers and sellers to contact each other about their indicated offers securities trading;
(c) software for electronically receiving, storing and displaying information sufficient to describe and transmit offers and counteroffers between members and said posting members, including proposed transaction terms, and further comprising:
(1) software for receiving an offer or counteroffer over said network from a negotiating member;
(2) software for storing said offer or counteroffer in a database; and
(3) software for electronically transmitting said offer or counteroffer over the network to the other negotiating party, with information sufficient to enable the parties to contact each other securities trading; and
(d) software for providing potential buyers and sellers the option to select a transaction settlement facility and transmit material terms of an agreement to conduct a transaction in said security, further comprising:
(1) software for electronically transmitting to said potential buyers and sellers data sufficient to identify transaction settlement facilities that are available at the option of said potential buyers and sellers;
(2) software for electronically receiving from said potential seller and said potential buyer their optional election to electronically transmit to each other a notification that an agreement has been reached between said potential buyer and said potential seller for the transfer of said security, wherein said notification comprises data describing material terms of said agreement and identifying said potential buyer's and potential seller's selection of a settlement facility;
(3) software for storing said notification in an electronic database; and
(4) software for electronically transmitting said material terms to said settlement facility for the purpose of said settlement facility generating standardized transaction settlement documents.

28. Computer software for securities trading that enables principal-to-principal exchange of financial information, including postings of firm offers to buy and sell any registered or unregistered securities that have been issued by any securities issuer, and the negotiation and settlement of all securities transactions without the use of an intermediary brokerage or conventional securities exchange, over an electronic network accessible to potential sellers and buyers, using a server/database computer system, comprising:
(a) software for requiring each of said potential buyers and sellers to satisfy membership requirements imposed by the trading system manager as a condition for access to restricted and unrestricted areas within said system and for access to particular postings, further comprising:
(1) software for electronically receiving membership data over the electronic network from each of said potential buyers and sellers, said membership data comprising data sufficient to identify each of said potential buyers and potential sellers and to pre-qualify them for access to postings of securities on the system or to the posting members; and
(2) software for storing said membership data in an electronic database;
(b) software for electronically receiving, storing and displaying the members' posting data, said posting data comprising firm offers to buy or otherwise acquire, or to sell or otherwise transfer, ownership interests in their securities, further comprising:
(1) software for receiving said posting data over said electronic network;
(2) software for organizing and storing said posting data in an electronic database;
(3) software for determining any restrictions to be imposed by said trading system on member access to said posting data or to the posting member;
(4) software for electronically transmitting said posting data over said network to all members who are not restricted from access to said posting data or to the posting member; and
(5) software for electronically transmitting information over said network that is sufficient to enable potential buyers and sellers to contact each other about their firm offers;
(c) software for electronically receiving, storing and displaying information sufficient to describe and transmit firm offers between members and said posting members, including proposed transaction terms, and further comprising:
(1) software for receiving an acceptance of said offer over said network from a responding member;
(2) software for storing said offer or acceptance of said offer in a database; and
(3) software for electronically transmitting said offer or acceptance of said offer over the network to the other responding party, with information sufficient to enable the parties to contact each other securities trading; and
(d) software for providing potential buyers and sellers the option to select a transaction settlement facility and transmit material terms of an agreement to conduct a transaction in said security, further comprising:
(1) software for electronically transmitting to said potential buyers and sellers data sufficient to identify transaction settlement facilities that are available at the option of said potential buyers and sellers;
(2) software for electronically receiving from said potential seller and said potential buyer their optional election to electronically transmit to each other a notification that an agreement has been reached between said potential buyer and said potential seller for the transfer of said security, wherein said notification comprises data describing material terms of said agreement and identifying said potential buyer's and potential seller's selection of a settlement facility;
(3) software for storing said notification in an electronic database; and
(4) software for electronically transmitting said material terms to said settlement facility for the purpose of said settlement facility generating standardized transaction settlement documents.

29. Computer software for securities trading that enables principal-to-principal exchange of financial information, including postings of offers to buy and sell any registered or unregistered securities that have been issued by any securities issuer, and the negotiation and mandated settlement of all securities transactions without the use of an intermediary brokerage or conventional securities exchange, over an electronic network accessible to potential sellers and buyers, using a server/database computer system, comprising:
(a) software for requiring each of said potential buyers and sellers to satisfy membership requirements imposed by the trading system manager as a condition for access to restricted and unrestricted areas within said system and for access to particular postings, further comprising:
(1) software for electronically receiving membership data over the electronic network from each of said potential buyers and sellers, said membership data comprising data sufficient to identify each of said potential buyers and potential sellers and to pre-qualify them for access to postings of securities on the system or to the posting members;
(2) software for storing said membership data in an electronic database securities trading;
(b) software for electronically receiving, storing and displaying the members' posting data, said posting data comprising indicated offers to buy or otherwise acquire, or to sell or otherwise transfer, ownership interests in their securities, further comprising:
(1) software for receiving said posting data over said electronic network;
(2) software for organizing and storing said posting data in an electronic database;
(3) software for determining any restrictions to be imposed by said trading system on member access to said posting data or to the posting member;
(4) software for electronically transmitting said posting data over said network to all members who are not restricted from access to said posting data or to the posting member; and
(5) software for electronically transmitting information over said network that is sufficient to enable potential buyers and sellers to contact each other about their indicated offers securities trading;
(c) software for electronically receiving, storing and displaying information sufficient to describe and transmit offers and counteroffers between members and said posting members, including proposed transaction terms, and further comprising:
(1) software for receiving an offer or counteroffer over said network from a negotiating member;
(2) software for storing said offer or counteroffer in a database; and
(3) software for electronically transmitting said offer or counteroffer over the network to the other negotiating party, with information sufficient to enable the parties to contact each other securities trading; and
(d) software for requiring potential buyers and sellers to utilize a mandated transaction settlement facility and transmit standardized material terms of an agreement to efficiently conduct a transaction in said security, further comprising:
(1) software for electronically transmitting to said potential buyers and sellers data sufficient to communicate with a transaction settlement facility mandated to said potential buyers and sellers;
(2) software for electronically receiving from said potential seller and said potential buyer their responses to each other effecting notification that an agreement has been reached between said potential buyer and said potential seller for the transfer of said security, wherein said notification comprises data describing standardized material terms of said agreement and identifying said potential buyer's and potential seller's agreement to said mandated settlement facility;
(3) software for storing said notification in an electronic database; and
(4) software for electronically transmitting said material terms to said mandated settlement facility for the purpose of said mandated settlement facility generating standardized transaction settlement documents.

30. Computer software for securities trading that enables principal-to-principal exchange of financial information, including postings of firm offers to buy and sell any registered or unregistered securities that have been issued by any securities issuer, and the negotiation and mandated settlement of all securities transactions without the use of an intermediary brokerage or conventional securities exchange, over an electronic network accessible to potential sellers and buyers, comprising:
(a) software for requiring each of said potential buyers and sellers to satisfy membership requirements imposed by the trading system manager as a condition for access to restricted and unrestricted areas within said system and for access to particular postings, further comprising:
(1) software for electronically receiving membership data over the electronic network from each of said potential buyers and sellers, said membership data comprising data sufficient to identify each of said potential buyers and potential sellers and to pre-qualify them for access to postings of securities on the system or to the posting members; and
(2) software for storing said membership data in an electronic database securities trading;
(b) software for electronically receiving, storing and displaying the members' posting data, said posting data comprising firm offers to buy or otherwise acquire, or to sell or otherwise transfer, ownership interests in their securities, further comprising:
(1) software for receiving said posting data over said electronic network;
(2) software for organizing and storing said posting data in an electronic database;
(3) software for determining any restrictions to be imposed by said trading system on member access to said posting data or to the posting member;
(4) software for electronically transmitting said posting data over said network to all members who are not restricted from access to said posting data or to the posting member; and
(5) software for electronically transmitting information over said network that is sufficient to enable potential buyers and sellers to contact each other about their firm offers securities trading;
(c) software for electronically receiving, storing and displaying information sufficient to describe and transmit firm offers between members and said posting members, including proposed transaction terms, and further comprising:
(1) software for receiving an acceptance of said offer over said network from a responding member;
(2) software for storing said offer or acceptance of said offer in a database;
(3) software for electronically transmitting said offer or acceptance of said offer over the network to the responding party, with information sufficient to enable the parties to contact each other securities trading; and
(d) software for requiring potential buyers and sellers to use a mandated transaction settlement facility and transmit standardized material terms of an agreement to efficiently conduct a transaction in said security, further comprising:
(1) software for electronically transmitting to said potential buyers and sellers data sufficient to communicate with a transaction settlement facility mandated to said potential buyers and sellers;
(2) software for electronically receiving from said potential seller and said potential buyer their responses to each other effecting notification that an agreement has been reached between said potential buyer and said potential seller for the transfer of said security, wherein said notification comprises data describing standardized material terms of said agreement and identifying said potential buyer's and potential seller's agreement to said mandated settlement facility;
(3) software for storing said notification in an electronic database; and
(4) software for electronically transmitting said material terms to said mandated settlement facility for the purpose of said mandated settlement facility generating standardized transaction settlement documents.

31. The software of claim 27, 28, 29, or 30, further comprising software for requiring a member who has an active buy posting for a security can only be contacted over the trading system's electronic network by a member who has an active sell posting for that security, and further comprising software for requiring that a member who has an active sell posting for a security can only be contacted over said network by a member who has an active buy posting for that security.

32. The software of claim 27, 28, 29, or 30, wherein some or all of the data transmitted over the trading system's electronic network are encrypted and the originator of a data transmission is digitally authenticated.

33. The software of claim 27, 28, 29, or 30, wherein said offers displayed to said potential buyers and sellers do not disclose the identities of said potential buyers and sellers to other said potential buyers and sellers.

34. The software of claim 27, 28, 29, or 30, further comprising software for electronically receiving and electronically storing notification of completion of a securities transaction from a settlement facility, including material transaction facts such as quantity and price, which are posted on the trading system for the benefit of all its members.

35. The software of claim 27, 28, 29, or 30, further comprising software for permitting buyers and sellers who have reached agreement to unilaterally permanently delete from the trading system's electronic database all data related to the identity of the member that posted said indicated offer and data related the to subsequent exchange of financial information related to said posting.

36. The software of claim 27, 28, 29, or 30, whereby a member may revocably elect to be represented by an agent authorized by said member, said agent acting in a fiduciary capacity on behalf of said member.

37. The software of claim 27, 28, 29, or 30, whereby a posting member may revocably elect to arbitrarily exclude any other member from access to one or more of said posting member's postings.

38. The software of claim 27, 28, 29, or 30, whereby a posting member may revocably elect to permit only those other members who are pre-designated by said posting member, and who otherwise satisfy any member access conditions that may be imposed by said trading system manager, to access said member's postings.

39. The software of claim 23, 24, 25, or 26, wherein, if said first and second members choose to transact, said members are provided with a “mailto: ” hyperlink, to enable said members to directly deliver transaction and confirmation information to each other, their back office, or other settlement personnel, if any, at their respective e-mail address, without using servers of said system to route the message.

40. The software of claim 39, wherein said “mailto: ” hyperlink is implemented using client-side script methods.

41. The software of claim 23, 24, 25, or 26, further comprising software for displaying a graphical user interface, wherein said interface comprises one or more of the following displays:
(a) an activity board display;
(b) a trading floor display; and
(c) a deal window display.

42. The software of claim 41, wherein said interface comprises an activity control center display.
